(19) United States
(12) Patent Application Publication
(10) Pub. No.: US 2007/0271711 A1
(43) Pub. Date: Nov. 29, 2007

(54) Dye Mixtures of Fibre-Reactive Azo Dyes Production and Use Thereof

(75) Inventors: Werner Hubert Russ, Flörsheim-Wicker (DE); Joachim Eichhorn, Frankfurt (DE); Stefan Meier, Frankfurt (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co., Deutschland KG, Frankfurt am Main (DE)

(21) Appl. No.: 11/574,644

(22) PCT Filed: Aug. 30, 2005
(86) PCT No.: PCT/EP05/54264

§ 371 Date: Jun. 27, 2007

(30) Foreign Application Priority Data
Sep. 2, 2004 (DE) 10 2004 042 521.3

(51) Int. Cl. C09B 62/44; C09B 67/44

(52) U.S. Cl. 8/543; 534/617; 8/605

(57) ABSTRACT

The invention relates to dye mixtures, comprising one or more dyes of the following general formula (I), one or more dyes of the following general formula (II), one more dyes of the following general formula (III) and, optionally, one or more dyes of the following general formula (IV) in which D, D¹, D², D³, D⁴, D⁵, R⁰, R²⁰⁰, R²⁰¹, R*, R**, T, b, f, v and M have the meanings given in claim 1, whereby the dyes of general formulae (I)-(IV) contain at least one fibre-reactive group of formula —SO₂-Z or Z², the production and use thereof for the dyeing and printing of fibre materials containing hydroxyl and/or carboxamide groups.

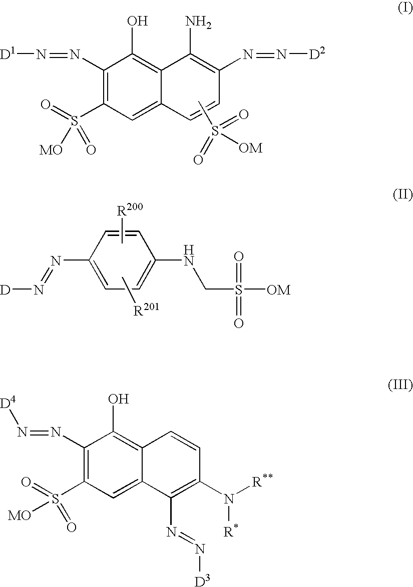

The invention is situated in the technical field of fiber-reactive azo dyes.

Mixed fiber-reactive azo dyes and their use for dyeing hydroxyl- and carboxamido-containing material in black shades are known for example from documents U.S. Pat. No. 5,445,654, U.S. Pat. No. 5,611,821, KR 94-2560, Sho 58-160362 and EP-A-0 870 807. These dye mixtures, however, possess certain performance defects, such as an overly great dependence of the color yield on varying dyeing parameters in the dyeing operation, for example, or an inadequate or unlevel buildup of color on cotton (effective color buildup results from the ability of a dye to produce a proportionally stronger dyeing from a higher concentration in the dyebath). Consequences of these deficiencies may include, for example, poor reproducibility of the dyeings obtainable, which ultimately affects the economics of the dyeing operation.

As a result of this there continues to be a need for new reactive dyes and reactive-dye mixtures having improved properties, such as high substantivity in tandem with the ability for unfixed fractions to be easily washed off. The dyes and dye mixtures must, furthermore, exhibit good dyeing yields and possess a high reactivity, a particular intention being to yield dyeings having high degrees of fixation.

With the present invention, dye mixtures have now been found which possess these above-described properties to a high extent The new dye mixtures are notable in particular for high fixing yields and color strengths in combination with fractions not fixed on the fiber that are easy to wash off. In addition the dyeings exhibit good all round fastness properties, such as high lightfastness and very good wetfastness properties, for examples

The invention accordingly provides dye mixtures which comprise one or more, such as two or three, preferably 1 or 2, dyes of the hereinbelow indicated and defined formula (I), 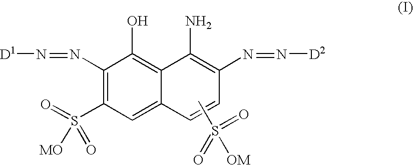
and one or more, such as two or three, preferably 1 or 2, dyes of the hereinbelow indicated and defined formula (II) 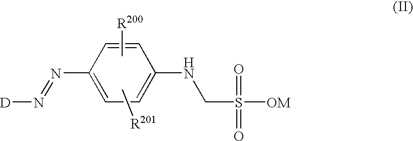
and optionally one or more, such as two or three, preferably 1 or 2, dyes of the hereinbelow indicated and defined formula (III) 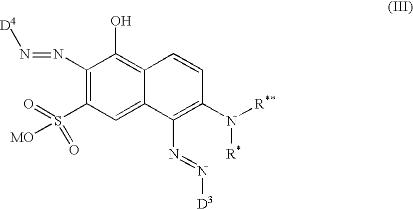
and optionally one or more, such as two or three, preferably one or two dyes of the hereinbelow indicated and defined formula (IV) 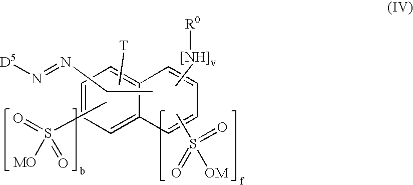
in which:

D, D¹, D², D³, D⁴ and D⁵ are independently of one another a group of the formula (1) 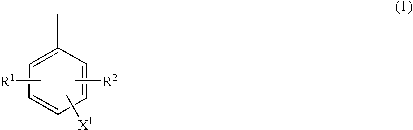
in which

R¹ and R² independently of one another are hydrogen, (C₁-C₄)-alkyl, (C₁-C₄)-alkoxy, hydroxyl, sulfo, carboxyl, cyano, nitro, amido, ureido or halogen, and
X¹ is hydrogen or a group of the formula —SO₂-Z,
   where
   Z is —CH═CH₂, —CH₂CH₂Z¹ or hydroxyl,
      in which
      Z¹ is hydroxyl or a group which can be eliminated under the action of alkali, or

D, D¹, D², D³, D⁴ and D⁵ are independently of one another a naphthyl group of the formula (2) 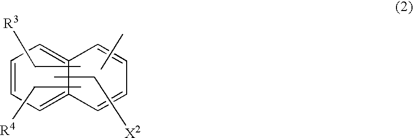
in which
R³ and R independently of one another are hydrogen, (C₁-C₄)-alkyl, (C₁-C₄)-alkoxy, hydroxyl, sulfo, carboxyl, cyano, nitro, amido, ureido or halogen; and
X² has one of the definitions of X¹; or

D, D¹, D², D³, D⁴ and D⁵ are independently of one another a group of the formula (3) 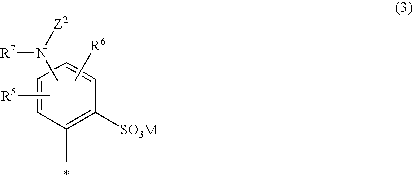
in which
R⁵ and R⁶ independently of one another have one of the definitions of R¹ and R²,
R⁷ is hydrogen, (C₁-C₄)-alkyl, or phenyl which is unsubstituted or substituted by (C₁-C₄)-alkyl, (C₁-C₄)-alkoxy, sulfo, halogen or carboxyl, and
Z² is a group of the formula (4) or (5) or (6) 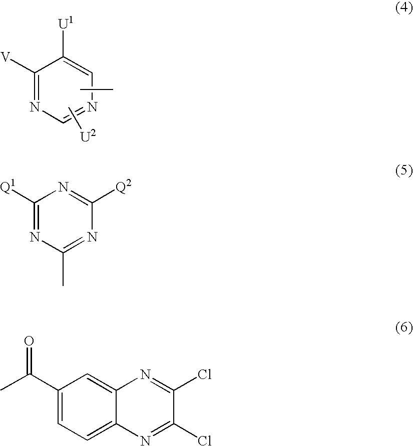
   in which
V is fluorine or chlorine,
U¹ and U² independently of one another are fluorine, chlorine or hydrogen, and
Q¹ and Q² independently of one another are chlorine, fluorine, cyanamide, hydroxyl, (C₁-C₆)-alkoxy, phenoxy, sulfophenoxy, mercapto, (C₁-C₆)-alkylmercapto, pyridino, carboxypyridino, carbamoylpyridino or a group of the formula (7) or (8) 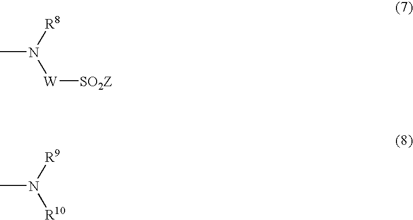
in which
R⁸ is hydrogen or (C₁-C₆)-alkyl, sulfo-(C₁-C₆)-alkyl or phenyl which is unsubstituted or substituted by (C₁-C₄)-alkyl, (C₁-C₄)-alkoxy, sulfo, halogen, carboxyl, acetamido or ureido;
R⁹ and R¹⁰ have independently of one another one of the definitions of R, or form a cyclic ring system of the formula —(CH₂)ⱼ— where j is 4 or 5, or alternatively —(CH₂)₂-E-(CH₂)₂—, where E is oxygen, sulfur, sulfonyl or —NR¹¹ with R¹¹═(C₁-C₆)-alkyl;
W is phenylene which is unsubstituted or substituted by 1 or 2 substituents, such as (C₁-C₄)-alkyl, (C₁-C₄)-alkoxy, carboxyl, sulfo, chlorine or bromine, or is (C₁-C₄)-alkylene-arylene or (C₂-C₆)-alkylene which may be interrupted by oxygen, sulfur, sulfonyl, amino, carbonyl or carboxamido, or is phenylene-CONH-phenylene which is unsubstituted or substituted by (C₁-C₄)-alkyl, (C₁-C₄)-alkoxy, hydroxyl, sulfo, carboxyl, amido, ureido or halogen, or is naphthylene which is unsubstituted or substituted by one or two sulfo groups; and
Z is as defined above; or

D, D¹, D², D³, D⁴ and D⁵ are independently of one another a group of the formula (9) 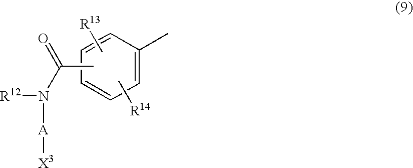
in which
R¹² is hydrogen, (C₁-C₄)-alkyl, aryl or a substituted aryl radical;
R¹³ and R¹⁴ independently of one another are hydrogen, (C₁-C₄)-alkyl, (C₁-C₄)-alkoxy, hydroxyl, sulfo, carboxyl, cyano, nitro, amido, ureido or halogen; and
A is a phenylene group of the formula (10) 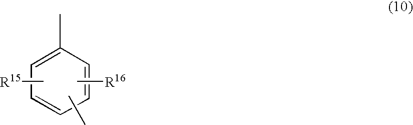
in which
R¹⁵ and R¹⁶ independently of one another are hydrogen, (C₁-C₄)-alkyl, (C₁-C₄)-alkoxy, hydroxyl, sulfo, carboxyl, cyano, nitro, amido, ureido or halogen; or
A is a naphthylene group of the formula (11) 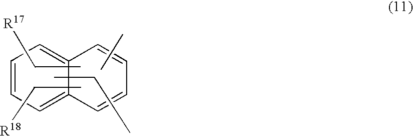
in which
R¹⁷ and R¹⁸ independently of one another are hydrogen, (C₁-C₄)-alkyl, (C₁-C₄)-alkoxy, hydroxyl, sulfo, carboxyl, cyano, nitro, amido, ureido or halogen; or
A is a polymethylene group of the formula (12)
   —(CR¹⁹R²⁰)k- (12)
in which
k is an integer greater than 1 and
R¹⁹ and R²⁰ independently of one another are hydrogen, (C₁-C₄)-alkyl, (C₁-C₄)-alkoxy, hydroxyl, cyano, amido, halogen or aryl; and
X³ has one of the definitions of X¹; and

R⁰ is a group of the formula (4) or (5) or is a group of the formula (13) 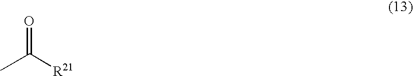
in which
R²¹ is (C₁-C₆)-alkyl, sulfo-(C₁-C₆)-alkyl, carboxy-(C₁-C₆)-alkyl or phenyl which is unsubstituted or substituted by (C₁-C₄)-alkyl, (C₁-C₄)-alkoxy, sulfo, halogen, carboxyl, acetamido or ureido; and

R²⁰⁰ and R²⁰¹ independently of one another are hydrogen, (C₁-C₄)-alkyl, (C₁-C₄)-alkoxy, —NH—COR^{a}, —NH—CONH₂, —SO₃H, —COOH, —COOR^{b}, where R^{a} and R^{b} bare (C₁-C₄)-alkyl or unsubstituted or substituted aryl; and

R* and R** independently of one another are hydrogen, (C₁-C₄)-alkyl or a group of the formula (14)
—CH₂—SO₃M (14),

b, f and v independently of one another are 0 or 1; and

T is hydroxyl or NH₂, and if T is NH₂ V is 0; and

M is hydrogen, an alkali metal or one equivalent of an alkaline earth metal.

The dyes of the formulae (I)-(IV) contain at least one fiber-reactive group of the formula —SO₂-Z or -Z².

In the general formulae above and below, the individual formula members, both of different and of identical designation, may have definitions which are the same as or different than one another within the bounds of their definition.

(C₁-C₄)-alkyl group substituents R may be straight-chain or branched and are in particular methyl, ethyl, n-propyl, isopropyl, n-butyl, isobutyl, sec-butyl and tert-butyl. Methyl and ethyl are preferred. Similar comments apply to (C₁-C₄)-alkoxy groups.

Aryl group substituents R are in particular the phenyl group. A substituted aryl group R⁸ to R¹⁰, R¹², R²¹ R^{a} or R^{b} is in particular a phenyl group substituted by one, two or three independent groups from the series (C₁-C₄)-alkyl, (C₁-C₄)-alkoxy, hydroxyl, sulfo, carboxyl, amido or halogen.

Halogen substituents R are in particular fluorine, chlorine and bromine, preference being given to fluorine and chlorine.

Alkali-eliminable substituents Z¹ in the β position of the ethyl group of Z are, for example, halogen atoms, such as chlorine and bromine, ester groups of organic carboxylic and sulfonic acids, such as alkylcarboxylic acids, unsubstituted or substituted benzenecarboxylic acids and unsubstituted or substituted benzene-sulfonic acids, such as the alkanoyloxy groups of 2 to 5 carbon atoms, more particularly acetyloxy, benzoyloxy, sulfobenzoyloxy, phenylsulfonyloxy and tolyl-sulfonyloxy, and additionally acidic ester groups of inorganic acids, such as of phosphoric acid, sulfuric acid and thiosulfuric acid (phosphate, sulfato and thiosulfato groups), and also dialkylamino groups having alkyl groups each of 1 to 4 carbon atoms, such as dimethylamino and diethylamino.

Z is preferably vinyl or β-chloroethyl and with particular preference is β-sulfatoethyl.

The groups “sulfo”, “carboxyl”, “thiosulfato”, “phosphato”, and “sulfato” include not only their acid form but also their salt form. Accordingly, sulfo groups are groups of the formula —SO₃M, thiosulfato groups are groups of the formula —S—SO₃M, carboxyl groups are groups of the formula —COOM, phosphate groups are groups of the formula —OPO₃M₂, and sulfato groups are groups of the formula —OSO₃M, each with M in the abovementioned definition.

Within the definition of Z, the dyes of the formula (I) to (IV) may possess different fiber-reactive groups —SO₂Z. In particular the fiber-reactive groups —SO₂Z may be on the one hand vinylsulfonyl groups and on the other groups —CH₂CH₂Z¹, preferably β-sulfatoethylsulfonyl groups. Where the dyes of the formula (I) to (IV) contain some vinylsulfonyl groups, the fraction of the respective dye with the vinylsulfonyl group is up to about 30 mol %, based on the respective amount of total dye.

Alkali metal M is, in particular, lithium, sodium and potassium. Preferably M is hydrogen or sodium.

The radicals R²⁰⁰ and R²⁰¹ in the formula (II) are, independently of one another, preferably hydrogen, methyl, methoxy, hydroxyl, acetylamino, ureido, sulfo, carboxyl, amido or halogen, particular preference being given to hydrogen, methyl, methoxy, acetylamino and ureido.

The radicals R* and R** in the formula (III) are, independently of one another, preferably hydrogen, methyl or a group of the formula (14), particular preference being given to hydrogen or a group of the formula (14).

The radicals R¹ and R² are preferably hydrogen, (C₁-C₄)-alkyl groups, (C₁-C₄)-alkoxy groups, sulfo or carboxyl and more preferably hydrogen, methyl, methoxy or sulfo.

The radicals R³ to R⁶ and R¹² to R²⁰ are preferably hydrogen, and R³ to R⁶, R¹⁷ and R¹⁸ are furthermore preferably sulfo.

The radicals R⁷ to R¹⁰ are preferably hydrogen or methyl, R⁷ and R⁸ are preferably also phenyl, and R⁹ and R¹⁰ are preferably 2-sulfoethyl or 2-, 3- or 4-sulfophenyl, or R⁹ and R¹⁰ form a cyclic ring system corresponding preferably to the formula —CH₂)₂—O—(CH₂)₂—.

Examples of groups D to D⁵ of the formula (1) and (2) are 2-(β-sulfatoethylsulfonyl)-phenyl, 3-(β-sulfatoethylsulfonyl)phenyl, 4-(β-sulfatoethylsulfonyl)phenyl, 2-carboxy-5-(β-sulfatoethylsulfonyl)phenyl, 2-chloro-4-(β-sulfatoethylsulfonyl)phenyl, 2-chloro-5-(β-sulfatoethylsulfonyl)phenyl, 2-bromo-4-(β-sulfatoethylsulfonyl)phenyl, 2-sulfo-4-(β-sulfatoethylsulfonyl)phenyl, 2-sulfo-5-(β-sulfatoethylsulfonyl)phenyl, 2-methoxy-5-(β-sulfatoethylsulfonyl)phenyl, 2-ethoxy-5-(β-sulfatoethylsulfonyl)phenyl, 2,5-dimethoxy-4-(β-sulfatoethylsulfonyl)phenyl, 2-methoxy-5-methyl-4-(β-sulfatoethylsulfonyl)phenyl, 2-methyl-4-(β-sulfatoethylsulfonyl)phenyl, 2- or 3- or 4-(β-thiosulfatoethylsulfonyl)-phenyl, 2-methoxy-5-(β-thiosulfatoethylsulfonyl)phenyl, 2-sulfo-4-(β-phosphatdethyl-sulfonyl)phenyl, 2- or 3- or 4-vinylsulfonylphenyl, 2-sulfo-4-vinylsulfonylphenyl, 2-chloro-4-(β-chloroethylsulfonyl)phenyl, 2-chloro-5-(β-chloroethylsulfonyl)phenyl, 3- or 4-(β-acetoxyethylsulfonyl)phenyl, 6- or 8-(β-sulfatoethylsulfonyl)naphth-2-yl, 6-(β-sulfatoethylsulfonyl)-1-sulfonaphth-2-yl and 8-(β-sulfatoethylsulfonyl)-6-sulfonaphth-2-yl, among which preference is given to 3-(β-sulfatoethylsulfonyl)phenyl, 4-(β-sulfatoethylsulfonyl)phenyl, 2-sulfo-4-(β-sulfatoethylsulfonyl)phenyl, 2-methoxy-5-(β-sulfatoethylsulfonyl)phenyl, 2,5-dimethoxy-4-(β-sulfatoethylsulfonyl)phenyl 2-methoxy-5-methyl-4-(β-sulfatoethylsulfonyl)phenyl and 3- or 4-vinylsulfonylphenyl, or D¹ to D 5 correspond to a group of the formulae (3) or (9), where R⁵ to R⁷ and R¹² to R¹⁴ possess the preferred definitions described above.

Where D to D⁵ are a group of the formula (1) and X¹ is -SO₂Z, the —SO₂Z group is preferably positioned meta or para to the diazo group, and where D to D⁵ are each a group of the formula (2), the bond leading to the diazo group is preferably attached in β-position on the naphthalene ring system.

Where A is phenylene and X³ is —SO₂Z, the SO₂Z group is preferably positioned meta or para to the nitrogen atom. In the group of the formula (9) the carboxamide group is preferably positioned para or meta to the diazo group. Where A is naphthylene the bond leading to the nitrogen atom is preferably attached in β position on the naphthalene ring system.

Examples of substituents A are, in particular, 1,2-phenylene, 1,3-phenylene, 1,4-phenylene, 2-chloro-1,4-phenylene, 2-chloro-1,5-phenylene, 2-bromo-1,4-phenylene, 2-sulfo-1,4-phenylene, 2-sulfo-1,5-phenylene, 2-methoxy-1,5-phenylene, 2-ethoxy-1,5-phenylene, 2,5-dimethoxy-1,4-phenylene, 2-methoxy-5-methyl-1,4-phenylene, 2-methyl-1,4-phenylene, 2,6-naphthylene, 2,8-naphthylene, 1-sulfo-2,6-naphthylene, 6-sulfo-2,8-naphthylene or 1,2-ethylene and 1,3-propylene.

More preferably A is 1,3-phenylene, 1,4-phenylene, 2-sulfo-1,4-phenylene, 2-methoxy-1,5-phenylene, 2,5-dimethoxy-1,4-phenylene, 2-methoxy-5-methyl-1,4-phenylene or 1,2-ethylene and 1,3-propylene, and in the case of the two last-mentioned alkylene groups the radical R¹² is preferably phenyl and 2-sulfophenyl.

k is preferably 2 or 3.

W is preferably 1,3-phenylene, 1,4-phenylene, 2-sulfo-1,4-phenylene, 2-methoxy-1,5-phenylene, 2,5-dimethoxy-1,4-phenylene, 2-methoxy-5-methyl-1,4-phenylene, 1,2-ethylene or 1,3-propylene.

Examples of the groups Q¹ and Q² in the formula (5) are, independently of one another, fluorine, chlorine, hydroxyl, methoxy, ethoxy, phenoxy, 3-sulfophenoxy, 4-sulfophenoxy, methylmercapto, cyanamido, amino, methylamino, ethylamino, morpholino, piperidino, phenylamino, methylphenylamino, 2-sulfophenylamino, 3-sulfophenylamino, 4-sulfophenylamino, 2,4-disulfophenylamino, 2,5-disulfo-phenylamino, 2-sulfoethylamino, N-methyl-2-sulfoethylamino, pyridino, 3-carboxy-pyridino, 4-carboxypyridino, 3-carbamoylpyridino, 4-carbamoylpyridino, 2-(2-sulfato-ethylsulfonyl)phenylamino, 3-(2-sulfatoethylsulfonyl)phenylamino, 4-(2-sulfatoethyl-sulfonyl)phenylamino, N-ethyl-3-(2-sulfatoethylsulfonyl)phenylamino, N-ethyl-4-(2-sulfatoethylsulfonyl)phenylamino, 2-carboxy-5-(2-sulfatoethylsulfonyl)phenylamino), 2-chloro-4-(2-sulfatoethylsulfonyl)phenylamino, 2-chloro-5-(2-sulfatoethylsulfonyl)-phenylamino, 2-bromo-4-(2-sulfatoethylsulfonyl)phenylamino, 2-sulfo-4-(2-sulfato-ethylsulfonyl)phenylamino, 2-sulfo-5-(2-sulfatoethylsulfonyl)phenylamino, 2-methoxy-5-(2-sulfatoethylsulfonyl)phenylamino, 2,5-dimethoxy-4-(2-sulfatoethylsulfonyl)-phenylamino, 2-methoxy-5-methyl-4-(2-sulfatoethylsulfonyl)phenylamino, 2-methyl-4-(2-sulfatoethylsulfonyl)phenylamino, 2-(vinylsulfonyl)phenylamino, 3-(vinylsulfonyl)-phenylamino, 4-(vinylsulfonyl)phenylamino, N-ethyl-3-(vinylsulfonyl)phenylamino, N-ethyl-4-(vinylsulfonyl)phenylamino, 6-(2-sulfatoethylsulfonyl)naphth-2-ylamino, 8-(2-sulfatoethylsulfonyl)naphth-2-ylamino, 8-(2-sulfatoethylsulfonyl)-6-sulfonaphth-2-ylamino, 3-(2-(2-sulfatoethylsulfonyl)ethylcarbamoyl)phenylamino, 4-(2-(2-sulfato-ethylsulfonyl)ethylcarbamoyl)phenylamino, 3-(2-(vinylsulfonyl)ethylcarbamoyl)phenyl-amino, 4-(2-(2-vinylsulfonyl)ethylcarbamoyl)phenylamino, 4-(N-methyl-2-(2-sulfato-ethylsulfonyl)ethylcarbamoyl)phenylamino, 4-(N-phenyl-2-(2-sulfatoethylsulfonyl)-ethylcarbamoyl)phenylamino, 4-(3-(2-sulfatoethylsulfonyl)phenylcarbamoyl)phenyl-amino, 4-(4-(2-sulfatoethylsulfonyl)phenylcarbamoyl)phenylamino, 3-(3-(2-sulfato-ethylsulfonyl)phenylcarbamoyl)phenylamino, 3-(4-(2-sulfatoethylsulfonyl)phenyl-carbamoyl)phenylamino, 3-(2-sulfatoethylsulfonyl)propylamino, N-methyl-N-(2-(2-sulfatoethylsulfonyl)ethyl)amino, N-phenyl-N-(2-(2-sulfatoethylsulfonyl)ethyl)amino or N-phenyl-N-(2-(2-sulfatoethylsulfonyl)propyl)amino.

Preferably the groups Q¹ and Q² in the formula (5) are independently of one another fluorine, chlorine, cyanamido, morpholino, 2-sulfophenylamino, 3-sulfophenylamino, 4-sulfophenylamino, N-methyl-2-sulfoethylamino, 3-carboxypyridino, 4-carboxy-pyridino, 3-carbamoylpyridino, 4-carbamoylpyridino, 3-(2-sulfatoethylsulfonyl)-phenylamino, 4-(2-sulfatoethylsulfonyl)phenylamino, 3-(vinylsulfonyl)phenylamino, 4-(vinylsulfonyl)phenylamino), 4-(3-(2-sulfatoethylsulfonyl)phenylcarbamoyl)phenyl-amino, 4-(4-(2-sulfatoethylsulfonyl phenylcarbamoyl)phenylamino, 3-(3-(2-sulfato-ethylsulfonyl)phenylcarbamoyl)phenylamino, 3-(4-(2-sulfatoethylsulfonyl)phenyl-carbamoyl)phenylamino, N-methyl-N-(2-(2-sulfatoethylsulfonyl)ethyl)amino or N-phenyl-N-(2-(2-sulfatoethylsulfonyl)ethyl)amino.

More preferably the groups Q¹ and Q² in the formula (5) independently of one another are fluorine, chlorine, cyanamido, morpholino, 2-sulfophenylamino, 3-sulfo-phenylamino, 4-sulfophenylamino, 3-(2-sulfatoethylsulfonyl)phenylamino, 4-(2-sulfatoethylsulfonyl)phenylamino, 3-(vinylsulfonyl)phenylamino, 4-(vinylsulfonyl)-phenylamino), N-methyl-N-(2-(2-sulfatoethylsulfonyl)ethyl)amino or N-phenyl-N-(2-(2-sulfatoethylsulfonyl)ethyl)amino.

Examples of the group Z² are 2,4-difluoropyrimidin-6-yl, 4,6-difluoropyrimidin-2-yl, 5-chloro-2,4-difluoropyrimidin-6-yl, 5-chloro-4,6-difluoropyrimidin-2-yl, 4,5-difluoro-pyrimidin-6-yl, 5-chloro-4-fluoropyrimidin-6-yl, 2,4,5-trichloropyrimidin-6-yl, 4,5-di-chloropyrimidin-6-yl, 2,4-dichloropyrimidin-6-yl, 4-fluoropyrimidin-6-yl, 4-chloro-pyrimidin-6-yl, or a group of the formula (5) having the above-indicated examples of Q¹ and Q², or a group of the formula (6).

Preferably Z² is 2,4-difluoropyrimidin-6-yl, 4,6-difluoropyrimidin-2-yl, 5-chloro-2,4-difluoropyrimidin-6-yl, 5-chloro-4,6-difluoropyrimidin-2-yl or a group of the formula (5) having the above-indicated preferred groups Q¹ and Q².

More preferably Z² is 2,4-difluoropyrimidin-6-yl, 5-chloro-2,4-difluoropyrimidin-6-yl or a group of the formula (5) having the above-indicated particularly preferred groups Q¹ and Q².

In formula (IV) T is preferably hydroxyl or amino, attached in C-position on the methylene ring system, with particular preference being given to hydroxyl.

b and v are preferably 1 and f is 0.

R⁰ is more preferably acetyl, 2,4-dichloro-1,3,5-triazin-6-yl or 2,4-difluoropyrimidin-6-yl.

The dye mixtures of the invention contain disazo dyes of the formula (I) in an amount of 30% to 95% by weight, preferably 50% to 90% by weight, and dyes of the formula (II) and, where appropriate, (III) and/ or (IV) independently of one another each in an amount of 1 % to 70% by weight, preferably 5% to 50% by weight.

The dye mixtures of the invention may optionally further comprise one or more monoazo dyes of the formulae (15) to (18) in an amount of up to 10% by weight, preferably up to 5% by weight, 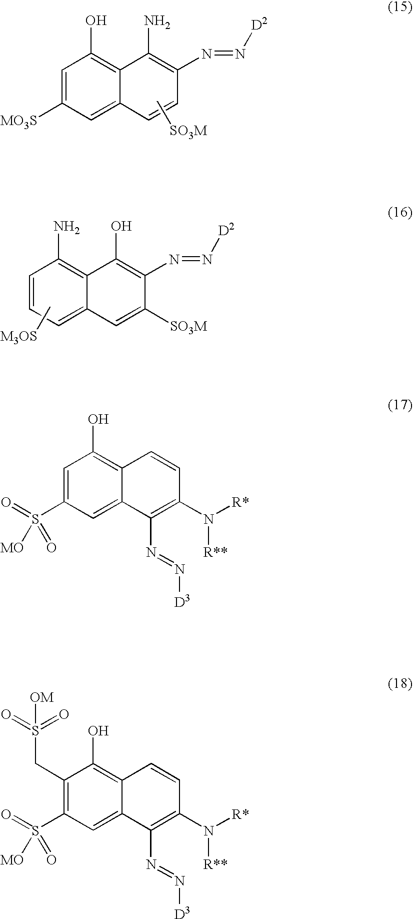
where D², D³, M, R* and R** are as defined above.

Preferably D² and D³ independently of one another are 3-(β-sulfatoethylsulfonyl)-phenyl, 4-(β-sulfatoethylsulfonyl)phenyl, 2-sulfo-4-(β-sulfatoethylsulfonyl)phenyl, 2-methoxy-5-(β-sulfatoethylsulfonyl)phenyl, 2,5-dimethoxy-4-(β-sulfatoethylsulfonyl)-phenyl, 2-methoxy-5-methyl-4-(β-sulfatoethylsulfonyl)phenyl, 3- or 4-vinylsulfonyl-phenyl, 2-sulfo-4-(vinylsulfonyl)phenyl, 2-methoxy-5-(vinylsulfonyl)phenyl, 2,5-dimethoxy-4-(vinyisulfonyl)phenyl or 2-methoxy-5-methyl-4-(vinylsulfonyl)phenyl.

Preferred dye mixtures contain one or more, such as two or three, preferably 1 or 2 dyes of the indicated and defined formula (I), 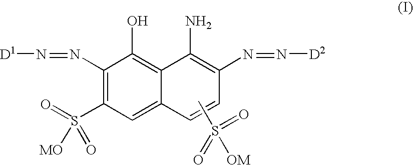
and one or more, such as two or three, preferably 1 or 2, dyes of the hereinbelow indicated and defined formula (II) 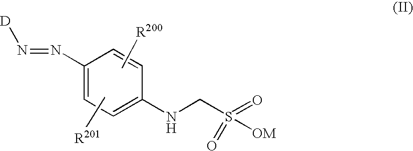
in which D₁, D², D, R²⁰⁰, R²⁰¹ and M are as defined above.

Preferred dye mixtures are additionally those comprising one or more, such as two or three, preferably 1 or 2, dyes of the hereinbelow indicated and defined formula (I) 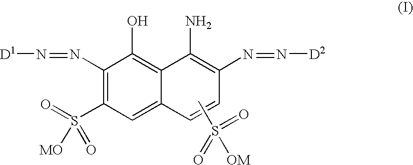
one or more, such as two or three, preferably 1 or 2, dyes of the hereinbelow indicated and defined formula (II) 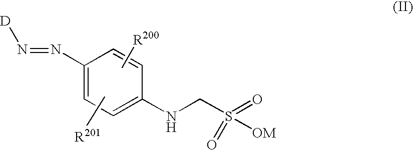
and one or more dyes of the hereinbelow indicated and defined formula (III) 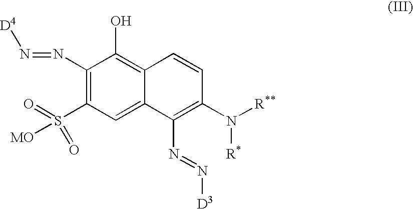
in which D¹, D², D³, D⁴, D, R²⁰⁰, R²⁰¹, R*, R** and M are as defined above.

Preferred mixtures further comprise one or more dyes of the formula (I) 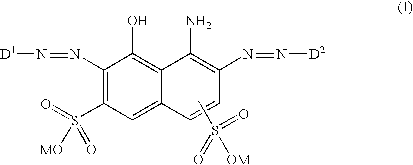
one or more, such as two or three, preferably 1 or 2, dyes of the hereinbelow indicated and defined formula (II) 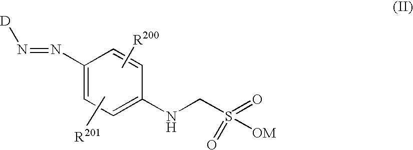
and one or more dyes of the hereinbelow indicated and defined formula (IV), 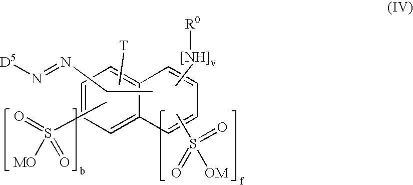
in which D¹, D², D⁵, D, R²⁰⁰, R²⁰¹, R⁰, T, b, f, v and M are as defined above.

Preferred mixtures further comprise one or more dyes of the formula (I), 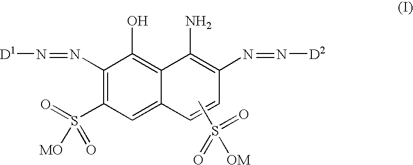
in which D¹, D² and M are as defined above,

one or more, such as two or three, preferably 1 or 2, dyes of the hereinbelow indicated and defined formula (II) 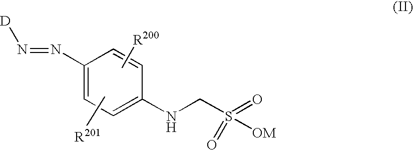
in which D, R²⁰⁰, R²⁰¹ and M are as defined above,

and one or more dyes of the formula (III) 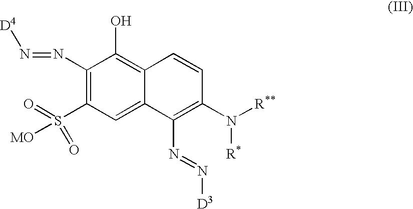
in which D³, D⁴, R*, R** and M are as defined above,

and also one or more dyes of the formula (IV) 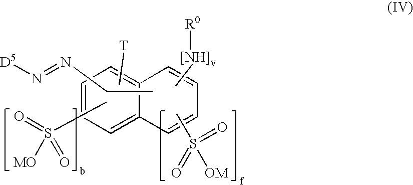
in which D⁵, R⁰, T, M, b, f, and v are as defined above.

Further preferred dye mixtures comprise one or more, such as two or three, preferably 1 or 2, dyes of the hereinbelow indicated and defined formula (I), 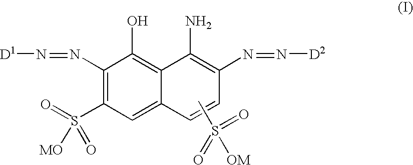
one or more, such as two or three, preferably 1 or 2, dyes of the hereinbelow indicated and defined formula (II) 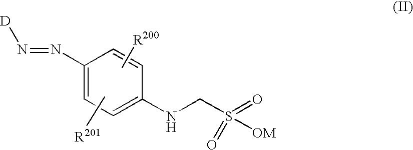
one or more, such as two or three, preferably 1 or 2, dyes of the hereinbelow indicated and defined formula (III-a) 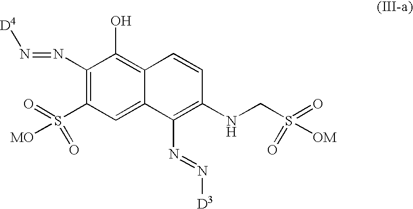
in which

D¹, D², D³, D⁴, D, R²⁰⁰, R²⁰¹ and M are as defined above.

More preferably, D¹, D², D³, D⁴ and D are independently of one another 3-(β-sulfato-ethylsulfonyl)phenyl, 4-(β-sulfatoethylsulfonyl)phenyl, 2-sulfo-4-(β-sulfatoethyl-sulfonyl)phenyl, 2-methoxy-5-(β-sulfatoethylsulfonyl)phenyl, 2,5-dimethoxy-4-(β-sulfatoethylsulfonyl)phenyl, 2-methoxy-5-methyl-4-(β-sulfatoethylsulfonyl)phenyl, 3- or 4-vinylsulfonylphenyl, 2-sulfo-4-(vinylsulfonyl)phenyl, 2-methoxy-5-(vinylsulfonyl)-phenyl, 2,5-dimethoxy-4-(vinyisulfonyl)phenyl or 2-methoxy-5-methyl-4-(vinyl-sulfonyl)phenyl.

Preferred mixtures further comprise one or more dyes of the formula (I) 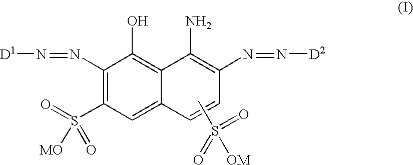
one or more, such as two or three, preferably 1 or 2, dyes of the hereinbelow indicated and defined formula (II) 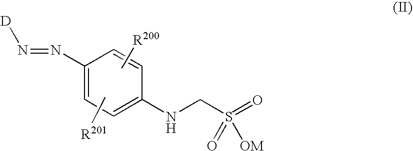
and one or more dyes of the hereinbelow indicated and defined formula (IV-a), 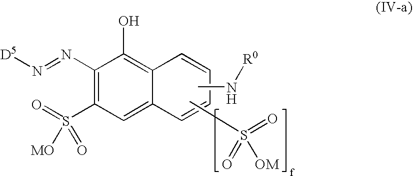
in which D¹, D², D⁵, D, R²⁰⁰, R²⁰¹, R⁰, f and M are as defined above.

Particularly preferred reactive dye mixtures of the invention comprise at least one dye of the formula (I-b) 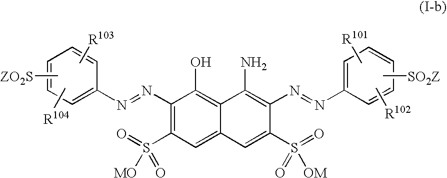
and at least one dye of the formula (II-a) 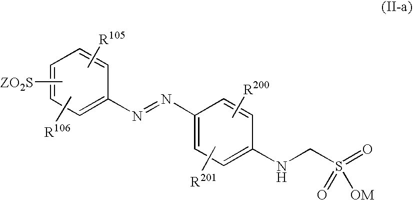
where in the formulae (I-b) and (II-a) R¹⁰¹ to R¹⁰⁶ preferably are, independently of one another, hydrogen, C₁-C₄ alkyl, C₁-C₄ alkoxy, sulfo, carboxyl or halogen. In formula (II-a) R²⁰⁰ and R²⁰¹ independently of one another have one of the definitions indicated above, and Z in formula (I-b) and (II-a) is vinyl or β-sulfatoethyl.

Further preferred dye mixtures, additionally, are those comprising at least one dye of the formula (I-b), 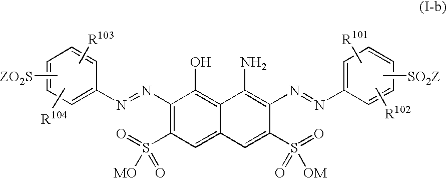
at least one dye of the formula (II-a) 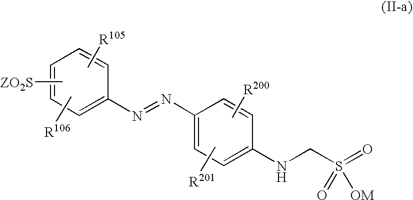
and at least one dye of the formula (III-b) 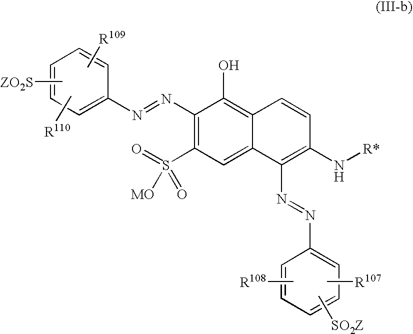
in which M, Z, R²⁰⁰, R²⁰¹ and R* are defined as indicated above and R¹⁰¹ to R¹¹⁰ are, independently of one another, hydrogen, methyl, methoxy or sulfo.

Further particularly preferred mixtures according to the invention comprise one or more dyes of the formula (I-b), 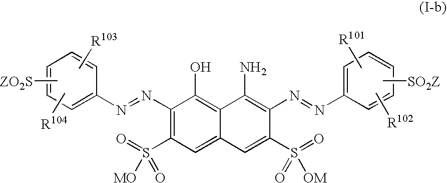
at least one dye of the formula (II-a) 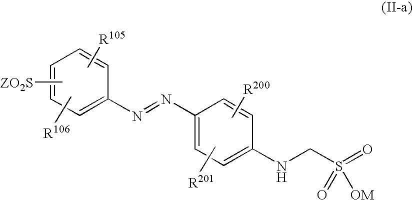
and one or more dyes of the formula (III-c)

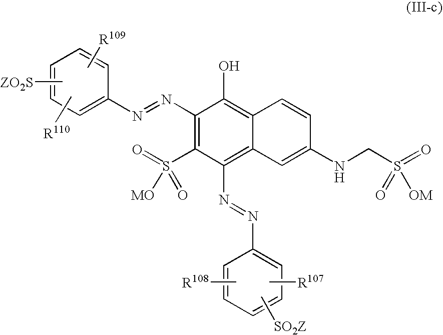

In the formulae (I-b), (II-a) and (III-c), M and Z are as defined above.

In the formulae (I-b), (II-a) and (III-c), R¹⁰¹ to R¹¹⁰ independently of one another are preferably hydrogen, C₁-C₄ alkyl, C₁-C₄ alkoxy, sulfo, carboxyl or halogen and Z is vinyl or β-sulfatoethyl; with very particular preference, R¹⁰¹ to R¹¹⁰, independently of one another in the formulae (I-b), (II-a) and (III-c), are hydrogen, methyl, methoxy or sulfo and Z is vinyl or β-sulfatoethyl.

In the formula (II-a) R²⁰⁰ and R²⁰¹ have one of the abovementioned definitions.

Additionally, preferred dye mixtures are those comprising at least one dye of the formula (I-b), 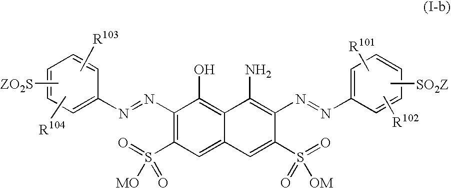
at least one dye of the formula (II-a) 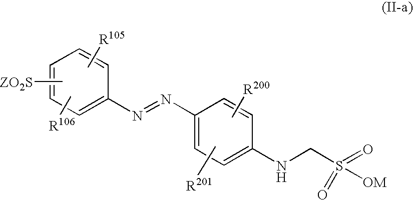
and at least one dye of the formula (IV-b) 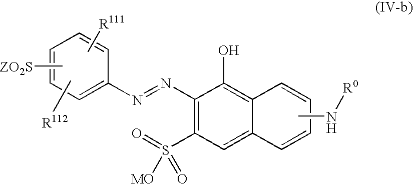
in which M, Z, R²⁰⁰, R²⁰¹ and R⁰ are defined as indicated above and R¹⁰¹ to R¹⁰⁶ and R¹¹¹ and R¹¹² independently of one another are hydrogen, methyl, methoxy or sulfo.

Further preferred dye mixtures comprise at least one dye of the formula (I-b), 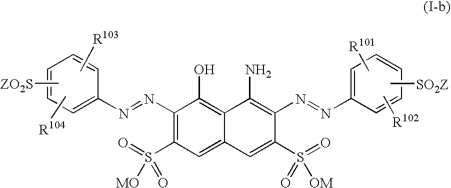
at least one dye of the formula (II-a) 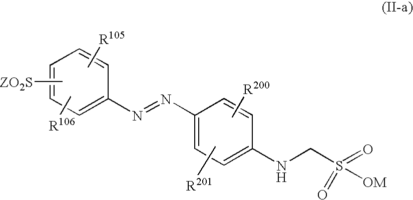
and at least one dye of the formula (IV-c), 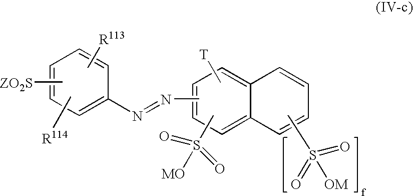
in which M, Z, R²⁰⁰, R²⁰¹, T and f are defined as indicated above and R¹⁰¹ to R¹⁰⁶ and R¹¹³ and R¹¹⁴ independently of one another are hydrogen, methyl, methoxy or sulfo.

The dye mixtures of the invention may be present as a preparation in solid or in liquid (dissolved) form. In solid form they include, where necessary, the electrolyte salts which are customary in the case of water-soluble and, in particular, fiber-reactive dyes, such as sodium chloride, potassium chloride and sodium sulfate, and may further include the auxiliaries that are customary in commercial dyes, such as buffer substances capable of setting a pH in aqueous solution of between 3 and 7, such as sodium acetate, sodium citrate, sodium borate, sodium hydrogen carbonate, sodium dihydrogen phosphate and disodium hydrogen phosphate, and also dyeing assistants, dedusting agents and small amounts of siccatives; if they are present in liquid aqueous solution (including the presence of thickeners of the type customary in printing pastes) they may also include substances which ensure the keeping properties of these preparations, such as mold preventatives, for example.

In solid form the dye mixtures of the invention are generally in the form of powders or granules (referred to in general below as preparations) containing electrolyte salt and where appropriate with one or more of the abovementioned auxiliaries. The preparations contain the dye mixture at 20% to 90% by weight, based on the preparation comprising it. The buffer substances are generally present in a total amount of up to 5% by weight, based on the preparation.

Where the dye mixtures of the invention are in aqueous solution, the total dye content of these aqueous solutions is up to about 50% by weight, such as between 5% and 50% by weight, for example, with the electrolyte salt content of these aqueous solutions being preferably below 10% by weight, based on the aqueous solution; the aqueous solutions (liquid preparations) may contain the aforementioned buffer substances generally in an amount of up to 5% by weight, preferably up to 2% by weight.

Dyes of the formula (I) are described in large number in the literature and are known, for example, from U.S. Pat. No. 2,657,205 and from the Japanese published patent application Sho-58-160 362, and also from U.S. Pat. No. 4,257,770 and the literature cited therein; dyes of the formula (II) are known from DE 3614045 and dyes of the formula (III) are described in DE 196 00 765 A1. Dyes of the formula (IV) are likewise described in large number and are obtainable via standard synthesis methods. Dyes of the formulae (15) to (18) are in some cases formed during the synthesis of dyes of the formulae (I) and (III) and are likewise obtainable by standard synthesis methods. Dyes of the formulae (15) and (16) are usually used as shading components.

The dye mixtures of the invention can be prepared in a procedure which is conventional per se, such as by mechanical mixing of the individual dyes, in the form either of their dye powders or dye granules or their synthesis solutions or of aqueous solutions of the individual dyes in general, which may further include customary auxiliaries, or by diazotizing and coupling appropriate mixtures of diazo components and coupling components in the desired proportions, these operations being familiar to the skilled worker. By way of example, if the diazo components containing the groups D¹, D⁴, D⁵ and D according to the formulae (I) and (II) and also, where appropriate, (III) and/or (IV) possess the same definition (D¹=D⁴=D⁵=D), an amine of the formula (19)
D¹-NH₂ (19),
in which D¹ is defined as indicated above, is conventionally diazotized and the resultant diazonium compound is then reacted with an aqueous solution or suspension of a mixture in defined proportion of a monoazo dye of the formula (15) and a coupling component of the formula (24), 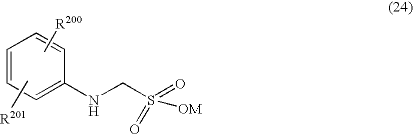
in which R²⁰⁰, R²⁰¹ and M are defined as indicated above, and also, where appropriate, with a monoazo dye of the formula (17) and/or a coupling component of the formula (20) 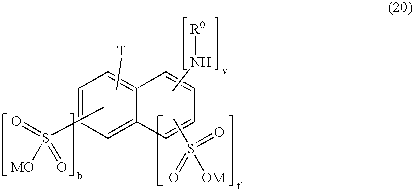
in which T, R⁰, M, b, f and v are defined as indicated above.

Where the D² and D³ and also D¹, D⁴, D⁵ and D of the formula (I) and (II) and also, where appropriate, (III) and/or (IV) possess the same definition (D²=D³ and D¹=D⁴ D⁵=D), the dye mixture of the invention can be prepared by diazotizing an amine of the formula (21)
D²-NH₂ (21)
in which D is defined as indicated above, in conventional manner and coupling it with a coupling component of the formula (22) and, where appropriate, (23) 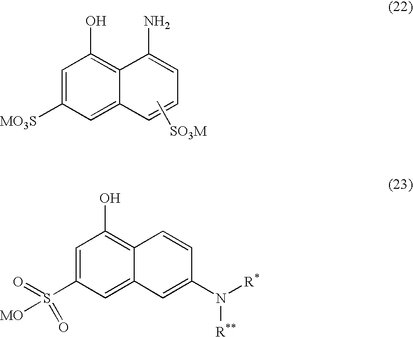
in which M, R* and R** are defined as indicated above at a pH below 3 in the first stage, then adding to the resultant reaction mixture a further coupling component of the formula (24) and, where appropriate, (20), and subsequently diazotizing an amine of the formula (19) and coupling it to the resultant mixture of the monoazo dyes of the formulae (15) and, where appropriate, (17) and also the coupling component of the formula (24) and, where appropriate, (20).

Alternatively the dye mixture of the invention, where the groups D to D⁵ of the formulae (I) and (II) and also, where appropriate, (III) and/or (IV) possess the same definition (D¹=D²=D³=D⁴=D⁵=D), can be prepared by conventionally diazatizing an amine of the formula (19) and coupling the product to a mixture in fixed proportion of the coupling components of the formulae (22) and (24) and also, where appropriate, (23) and/or (20), first at a pH below 3 in the first stage, to form a mixture of the monoazo dyes of the formulae (15) and, where appropriate, (17) and also the coupling component of the formula (24) and, where appropriate, (20), and subsequently, by raising the pH, carrying out the secondary coupling to form a mixture of the dyes of the formulae (I) and (II) and also, where appropriate, (III) and/or (IV).

The dye mixture of the invention is isolated in conventional manner by being salted out, using sodium chloride or potassium chloride, for example, or by spray drying and/or evaporative concentration.

Dye mixtures which have not only β-chloroethylsulfonyl or β-thiosulfatoethylsulfonyl or β-sulfatoethylsulfonyl groups but also vinylsulfonyl groups as reactive radicals can be synthesized not only starting from correspondingly substituted vinylsulfonylanilines or naphthylamines but also by reacting a dye mixture in which Z is β-chloroethyl, β-thiosulfatoethyl, or β-sulfatoethyl with an amount of alkali required for the desired fraction and converting the aforementioned β-substituted ethylsulfonyl groups into vinylsulfonyl groups. This conversion takes place in a manner which is familiar to the skilled worker.

The dye mixtures of the invention possess valuable performance properties. They are used for dyeing or printing hydroxyl- and/or carboxamido-containing materials, in the form for example of sheetlike structures, such as paper and leather, or of films, such as of polyamide, for example, or in the mass, such as of polyamide and polyurethane, for example, but in particular for dyeing or printing these materials in fiber form. The solutions of the dye mixtures of the invention that are obtained in the course of the synthesis can also be used directly as a liquid preparation for dyeing, where appropriate following addition of a buffer substance and, where appropriate, after concentration or dilution.

The present invention hence also provides for the use of the dye mixtures of the invention for dyeing or printing these materials, and provides methods of dyeing or printing such materials in conventional ways, wherein a dye mixture of the invention or its individual components (dyes) individually is or are used together as colorants. The materials are preferably employed in the form of fiber materials, particularly in the form of textile fibers, such as woven fabrics or yarns, as in the form of hanks or wound packages.

Hydroxyl-containing materials are those of natural or synthetic origin, such as cellulose fiber materials or their regenerated products and polyvinyl alcohols, for example. Cellulose fiber materials are preferably cotton, but also other plant fibers, such as linen, hemp, jute and ramie fibers; regenerated cellulose fibers are, for example, staple viscose and filament viscose, and also chemically modified cellulose fibers, such as aminated cellulose fibers or fibers as described, for example, in WO 96/37641 and WO 96/37642 and also in EP-A-0 538 785 and EP-A-0 692 559. Carboxamido-containing materials are, for example, synthetic and natural polyamides and polyurethanes, particular in the form of fibers, examples being wool and other animal hairs, silk, leather, nylon-6,6, nylon-6, nylon-11 and nylon-4.

The dye mixtures of the invention can be applied to and fixed on the stated substrates, in particular the stated fiber materials, by the application techniques that are known for water-soluble dyes and especially for fiber-reactive dyes. For instance, on cellulose fibers by the exhaust methods from a long liquor and also from a short liquor, in a liquor-to-goods ratio of 5:1 to 100:1, for example, preferably 6:1 to 30:1, using any of a wide variety of acid-binding agents and, where appropriate, neutral salts as far as is necessary, such as sodium chloride or sodium sulfate, they produce dyeings having very good color yields. Dyeing takes place preferably in an aqueous bath at temperatures between 40 and 105° C., where appropriate at a temperature up to 130° C. under superatmospheric pressure, but preferably at 30 to 95° C., especially 45 to 65° C., and in the presence where appropriate of customary dyeing assistants. One possible procedure here is to introduce the material into the warm bath and gradually to heat the bath to the desired dyeing temperature, and to complete the dyeing operation at that temperature. The neutral salts which accelerate the exhaustion of the dyes may also, if desired, be added to the bath only after the actual dyeing temperature has been reached.

Padding processes likewise provide excellent color yields and very good color buildup on cellulose fibers, the dyes being fixable in conventional manner by batching at room temperature or elevated temperature, at up to about 60° C. for example, or in a continuous dyeing procedure, by means for example of a Pad-Dry-Pad steam process, by steaming or using dry heat.

Similarly, the customary printing processes for cellulose fibers, which can be carried out in one step, by means of printing, for example, with a print paste containing sodium bicarbonate or another acid-binding agent, and by subsequent steaming at 100 to 103° C., or in two steps, by printing, for example, with a neutral to weakly acidic printing ink and then fixing either by passing the printed material through a hot alkaline bath containing electrolyte, or by overpadding it with an alkaline, electrolyte-containing padding liquor and subsequently batching or steaming or dry-heat-treating the alkali-overpadded material, produce strongly colored prints with well-defined contours and a clear white ground. The extent to which the outcome of the prints is dependent on fluctuations in fixing conditions is low.

When fixing by means of dry heat in accordance with the customary thermofix processes, hot air at 120 to 200° C. is used. In addition to the customary steam at 101 to 103° C. it is also possible to use superheated steam and pressurized steam with temperatures of up to 160° C.

The acid-binding agents which effect the fixation of the dyes in the dye mixtures of the invention on the cellulose fibers are, for example, water-soluble basic salts of alkali metals and likewise alkaline earth metals of organic or inorganic acids or compounds which liberate alkali when heated, and also alkali metal silicates. Mention may be made in particular of the alkali metal hydroxides and alkali metal salts of weak to moderately strong organic or inorganic acids, the alkali metal compounds referred to being preferably the sodium and potassium compounds. Examples of such acid-binding agents are sodium hydroxide, potassium hydroxide, sodium carbonate, sodium bicarbonate, potassium carbonate, sodium formate, sodium dihydrogen phosphate, disodium hydrogen phosphate, sodium trichloroacetate, trisodium phosphate or waterglass or mixtures thereof such as mixtures of sodium hydroxide solution and waterglass, for example.

The present invention further provides for the use of the dye mixtures of the invention in printing inks for digital textile printing by the inkjet process.

The printing inks of the present invention comprise one or more of the reactive dyes stated, for example in amounts from 0.1% by weight to 50% by weight, preferably in amounts from 1% by weight to 30% by weight and more preferably in amounts from 1% by weight to 15% by weight based on the total weight of the ink. They may also include combinations of the aforementioned reactive dyes with other reactive dyes used in textile printing. For the inks to be used in the continuous flow process, a conductivity of 0.5 to 25 mS/m can be set by adding an electrolyte. Useful electrolytes include for example lithium nitrate and potassium nitrate. The dye inks of the present invention may include organic solvents at a total level of 1-50% and preferably 5-30% by weight.

Suitable organic solvents are for example alcohols, for example methanol, ethanol, 1-propanol, isopropanol, 1-butanol, tert-butanol, pentyl alcohol, polyhydric alcohols for example: 1,2-ethanediol, 1,2,3-propanetriol, butanediol, 1,3-butanediol, 1,4-butanediol, 1,2-propanediol, 1,3-propanediol, pentanediol, 1,4-pentanediol, 1,5-pentanediol, hexanediol, D,L-1,2-hexanediol, 1,6-hexanediol, 1,2,6-hexanetriol, 1,2-octanedioli polyalkylene glycols, for example: polyethylene glycol, polypropylene glycol, alkylene glycols having 2 to 8 alkylene groups, for example monoethylene glycol, diethylene glycol, triethylene glycol, tetraethylene glycol, thioglycol, thiodiglycol, butyltriglycol, hexylene glycol, propylene glycol, dipropylene glycol, tripropylene glycol, low alkyl ethers of polyhydric alcohols, for example: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, polyalkylene glycol ethers, such as for example: polyethylene glycol monomethyl ether, polypropylene glycol glycerol ether, polyethylene glycol tridecyl ether, polyethylene glycol nonylphenyl ether, amines, such as, for example: methylamine, ethylamine, diethylamine, triethylamine, dimethylamine, trimethylamine, dibutylamine, diethanolamine, triethanolamine, N-acetylethanolamine, N-formylethanolamine, ethylenediamine, urea derivatives, such as for example: urea, thiourea, N-methylurea, N,N′-dimethyl-urea, ethyleneurea, 1,1,3,3-tetramethylurea, amides, such as for example: dimethylformamide, dimethylacetamide, acetamide, ketones or keto alcohols, such as for example: acetone, diacetone alcohol, cyclic ethers, such as for example; tetrahydrofuran, dioxane, trimethylolethane, trimethylolpropane, 2-butoxyethanol, benzyl alcohol, gamma butyrolactone, epsilon-caprolactam, further sulfolane, dimethylsulfolane, methylsulfolane, dimethyl sulfone, butadiene sulfone, dimethyl sulfoxide, dibutyl sulfoxide, N-cyclohexylpyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, 2-(2-methoxyethoxy)ethanol, 2-(2-ethoxyethoxy)ethanol, 2-(2-butoxyethoxy)ethanol, 2-(2-propoxyethoxy)ethanol, pyridine, piperidine, trimethoxypropane, 1,2-dimethoxypropane, ethyl acetate, ethylenediaminetetraacetate, ethyl pentyl ether.

The printing inks of the invention may further include customary additives, for example viscosity moderators to set viscosities in the range from 1.5 to 40.0 mPas in a temperature range from 20 to 50° C. Preferred inks have a viscosity of 1.5 to 20 mPas and particularly preferred inks have a viscosity of 1.5 to 15 mPas. Useful viscosity moderators include rheological additives, for example: polyvinylcaprolactam, polyvinylpyrrolidone and their copolymers polyetherpolyol, associative thickeners, polyurea, polyurethane, sodium alginates, modified galactomannans, polyetherurea, polyurethane, nonionic cellulose ethers. As further additives the inks of the invention may include surface-active substances to set surface tensions of 20 to 65 mN/m, which are adapted if necessary as a function of the process used (thermal or piezo technology).

Useful surface-active substances include for example: all surfactants, preferably nonionic surfactants, butyldiglycol, 1,2-hexanediol.

The inks may further include customary additives, for example substances to inhibit fungal and bacterial growth in amounts from 0.01% to 1% by weight based on the total weight of the ink.

The inks may be prepared in a conventional manner by mixing the components in water.

The dye inks of the invention are useful in inkjet printing processes for printing a wide variety of pretreated materials, such as silk, leather, wool, polyamide fibers and polyurethanes, and especially cellulosic fiber materials of any kind. Such fiber materials are for example the natural cellulose fibers, such as cotton, linen and hemp, and also pulp and regenerated cellulose. The printing inks of the invention are also useful for printing pretreated hydroxyl- or amino-containing fibers present in blend fabrics, for example blends of cotton, silk, wool with polyester fibers or polyamide fibers.

In contrast to conventional textile printing, where the printing ink already contains all the fixing chemicals and thickeners for a reactive dye, in inkjet printing the auxiliaries have to be applied to the textile substrate in a separate pretreatment step. The pretreatment of the textile substrate, for example cellulose and regenerated cellulose fibers and also silk and wool, is effected with an aqueous alkaline liquor prior to printing. To fix reactive dyes there is a need for alkali, for example sodium carbonate, sodium bicarbonate, sodium acetate, trisodium phosphate, sodium silicate, sodium hydroxide, alkali donors such as, for example, sodium chloroacetate, sodium formate, hydrotropic substances such as, for example, urea, reduction inhibitors, for example sodium nitrobenzenesulfonates, and also thickeners to prevent flowing of the motifs when the printing ink is applied, for example sodium alginates, modified polyacrylates or highly etherified galactomannans.

These pretreatment reagents are uniformly applied to the textile substrate in a defined amount using suitable applicators, for example using a 2- or 3-roll pad, using contactless spraying technologies, by means of foam application or using appropriately adapted inkjet technologies, and subsequently dried, After printing, the textile fiber material is dried at 120 to 150° C. and subsequently fixed.

The fixing of the inkjet prints prepared with reactive dyes may be effected at room temperature or with saturated steam, with superheated steam, with hot air, with microwaves, with infrared radiation, with laser or electron beams or with other suitable energy transfer techniques.

A distinction is made between one- and two-phase fixing processes: In one-phase fixing, the necessary fixing chemicals are already on the textile substrate.

In two-phase fixing, this pretreatment is unnecessary. Fixing only requires alkali, which, following inkjet printing, is applied prior to the fixing process, without intermediate drying. There is no need for further additives such as urea or thickener Fixing is followed by the print aftertreatment, which is the prerequisite for good fastness properties, high brilliance and an impeccable white ground.

The dye mixtures according to the invention are notable for outstanding color strength when applied to the cellulose fiber materials by dyeing or printing in the presence of no or very small amounts of alkali or alkaline earth metal compounds. In these special cases, for instance, no electrolyte salt is required for a shallow depth of shade, not more than 5 g/l of electrolyte salt is required for a medium depth of shade and not more than 10 g/l of electrolyte salt is required for deep shades. In this context a shallow depth of shade refers to the use of 2% by weight of dye based on the substrate to be dyed, a medium depth of shade refers to the use of 2% to 4% by weight of dye based on the substrate to be dyed, and a deep shade refers to the use of 4% to 10% by weight of dye based on the substrate to be dyed.

The dyeings and prints obtainable with the dye mixtures according to the invention possess bright shades; more particularly, the dyeings and prints on cellulose fiber materials possess good lightfastness and especially good wetfastness properties, such as fastness to washing, milling, water, seawater, crossdyeing and acidic and alkaline perspiration, and also good fastness to pleating, hot pressing, and rubbing. Furthermore, the cellulose dyeings obtained following the customary aftertreatment of rinsing to remove unfixed dye portions exhibit excellent wetfastness properties, in particular since unfixed dye portions are easily washed off because of their good solubility in cold water.

The dye mixtures of the invention can also be used, furthermore, for the fiber-reactive dyeing of wool. This includes wool which has been given a nonfelting or low-felting finish (cf., for example, H. Rath, Lehrbuch der Textilchemie, Springer-Verlag, 3rd edition (1972), pp. 295-9, particularly wool finished by the Hercosett process (p. 298); J. Soc. Dyers and Colourists 1972, 93-9, and 1975, 33-44) with very good fastness properties. Dyeing on wool takes place in conventional manner from an acidic medium. For instance, acetic acid and/or ammonium sulfate or acetic acid and ammonium acetate or sodium acetate can be added to the dyebath in order to obtain the desired pH. To achieve a practicable levelness in the dyeing it is advisable to add customary leveling assistants, such as those based, for example, on a reaction product of cyanuric chloride with three times the molar amount of an aminobenzenesulfonic acid and/or an aminonaphthalenesulfonic acid or based on a reaction product of, for example, stearylamine with ethylene oxide. Thus, for example, the dye mixture of the invention is preferably subjected first to the exhaust operation from an acidic dye bath having a pH of about 3.5 to 5.5, under pH control, and then, toward the end of the dyeing time, the pH is shifted into the neutral and, where appropriate, weakly alkaline range up to a pH of 8.5, in order to bring about, especially for very deep dyeings, the full reactive bond between the dyes of the dye mixtures of the invention and the fiber. At the same time the fraction of dye not reactively bound is detached.

The procedure described here also applies to the production of dyeings on fiber materials composed of other natural polyamides or of synthetic polyamides and polyurethanes. In general the material to be dyed is introduced into the bath at a temperature of about 40° C., agitated therein for a certain time, and then the dyebath is adjusted to the desired weakly acidic, preferably weakly acetic acid, pH and the actual dyeing is carried out at a temperature between 60 and 98° C. Alternatively the dyeings can be performed at boiling temperature or, in closed dyeing apparatus, at temperatures of up to 106° C. Since the water solubility of the dye mixtures of the invention is very good they can also be used with advantage in customary continuous dyeing processes. The color strength of the dye mixtures of the invention is very high.

On the stated materials, preferably fiber materials, the dye mixtures of the invention produce navy to deep-black dyeings having very good fastness properties.

The examples which follow serve to illustrate the invention, Parts and percentages are by weight unless noted otherwise. The relationship of parts by weight to parts by volume is that of the kilogram to the liter. The compounds described by formula in the examples are written in the form of the sodium salts, since they are generally prepared and isolated in the form of their salts, preferably sodium or potassium salts, and are used in the form of their salts for coloring. The starting compounds specified in the examples below, especially tabular examples, can be used in the synthesis in the form of the free acid or likewise in the form of their salts, preferably alkali metal salts, such as sodium or potassium salts,

### EXAMPLE 1

70 parts of an electrolyte-containing dye powder comprising the navy disazo dye of the formula (I-1) 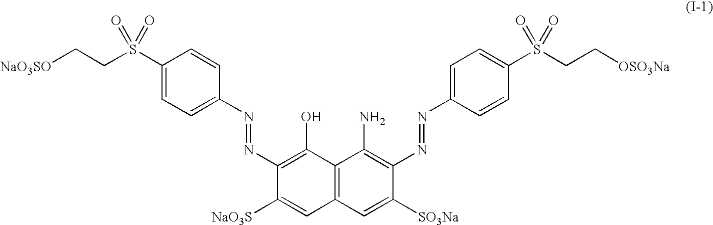
in 75% fraction, 15 parts of an electrolyte-containing dye powder comprising the yellow azo dye of the formula (II-1) 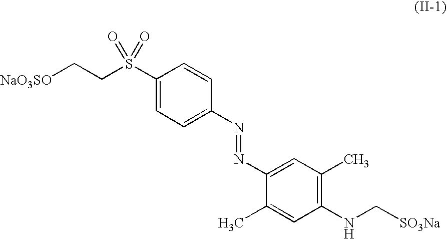
in 75% fraction, and 15 parts of an electrolyte-containing dye powder comprising the orange-yellow azo dye of the formula (II-7) 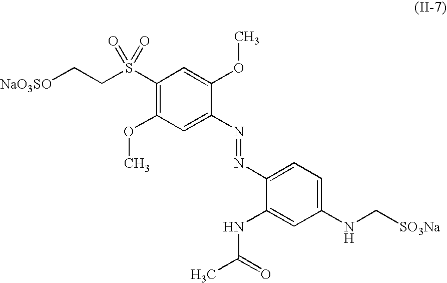
in 70% fraction are mixed mechanically with one another.

Under the dyeing conditions customary for reactive dyes, the resultant dye mixture of the invention, on cotton for example, produces greenish black dyeings and prints.

### EXAMPLE 2

70 parts of an electrolyte-containing dye powder comprising the navy disazo dye of the formula (I-1) in 75% fraction and 30 parts of an electrolyte-containing dye powder comprising the orange-yellow disazo dye of the formula (II-10) 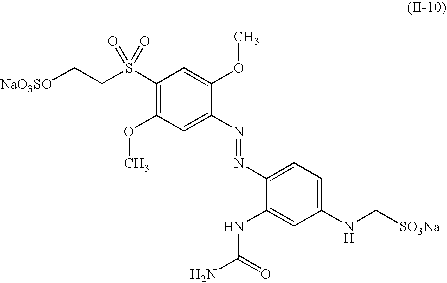
in 75% fraction are dissolved in 500 parts of water and the resulting dye solution is adjusted to a pH of 5.5-6.5. Evaporative concentration of this dye solution gives a dye mixture which, under the dyeing conditions customary for reactive dyes, produces greenish black dyeings and prints on cotton.

### EXAMPLE 3

70 parts of an electrolyte-containing dye powder comprising the navy disazo dye of the formula (I-1) in 75% fraction, 13 parts of an electrolyte-containing dye powder comprising the yellow azo dye of the formula (II-6) 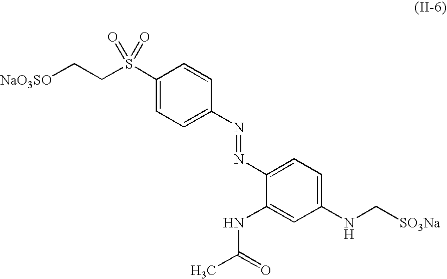
in 70% fraction and 17 parts of an electrolyte-containing dye powder comprising the scarlet disazo dye of the formula (III-1) 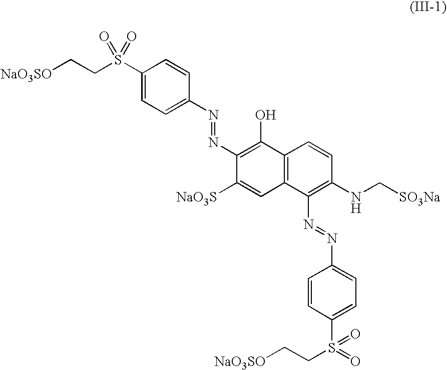
in 70% fraction are mixed mechanically with one another.

Under the dyeing conditions customary for reactive dyes, the resulting dye mixture of the invention, on cotton for example, produces deep-black dyeings and prints.

### EXAMPLE 4

70 parts of an electrolyte-containing dye powder comprising the navy disazo dye of the formula (I-1) in 75% fraction, 10 parts of an electrolyte-containing dye powder comprising the yellow azo dye of the formula (II-4) 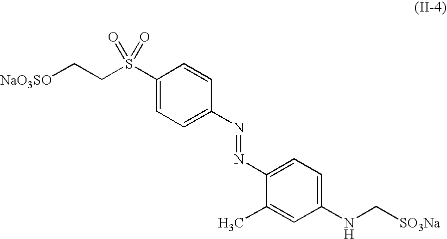
in 70% fraction and 20 parts of an electrolyte-containing dye powder comprising the orange azo dye of the formula (IV-1) 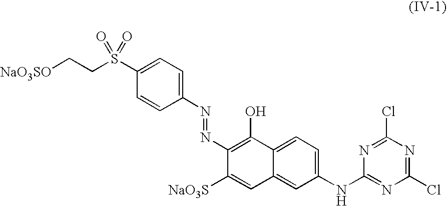
in 75% fraction are dissolved in 500 parts of water and the resulting dye solution is adjusted to a pH of 5.5-6.5. Evaporative concentration of this dye solution gives a dye mixture which, under the dyeing conditions customary for reactive dyes, produces deep-black dyeings and prints on cotton.

### EXAMPLE 5

67 parts of an electrolyte-containing dye powder comprising the navy disazo dye of the formula (I-1 ) in 75% fraction, 10 parts of an electrolyte-containing dye powder comprising the yellow azo dye of the formula (II-9) 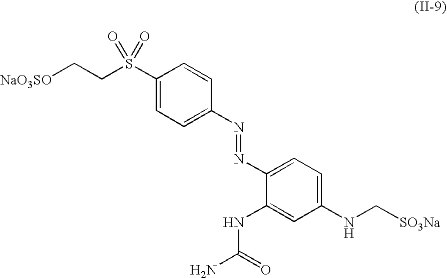
in 70% fraction, 10 parts of an electrolyte-containing dye powder comprising the scarlet disazo dye of the formula (III-2) 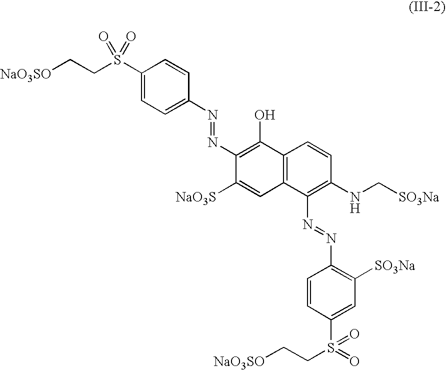
in 70% fraction and 13 parts of an electrolyte-containing dye powder comprising the orange azo dye of the formula (IV-1) in 75% fraction are mixed mechanically with one another.

Under the dyeing conditions customary for reactive dyes, the resulting dye mixture of the invention, on cotton for example, produces deep-black dyeings and prints.

### EXAMPLE 6

580 parts of 4-(β-sulfatoethylsulfonyl)aniline are suspended in 1400 parts of ice-water and 371 parts of 30% strength hydrochloric acid and diazotized by dropwise addition of 358 parts of 40% strength sodium nitrite solution. Following removal of the excess nitrite with amidosulfonic acid, 210 parts of 1-amino-8-hydroxynaphthalene-3,6-disulfonic acid and a mixture of 67 parts of 4-hydroxy-7-(sulfomethylamino)-naphthalene-2-sulfonic acid and 66 parts of (3-acetylaminophenylamino)methane-sulfonic acid, prepared by reacting 48 parts of 7-amino-4-hydroxynaphthalene-2-sulfonic acid and 40.5 parts of N-(3-aminophenyl)acetamide with 69 parts of formaldehyde-sodium bisulfite in aqueous medium at a pH of 5.5-6 and 40° C. are added, and initially, in a first stage, the components are coupled at a pH of 1 to 1.5 at below 20° C. to give a mixture of two monoazo dyes of formulae (15-1) and (17-1). The indicated pH range is set by adding solid sodium hydrogen carbonate and maintained during the coupling reaction.

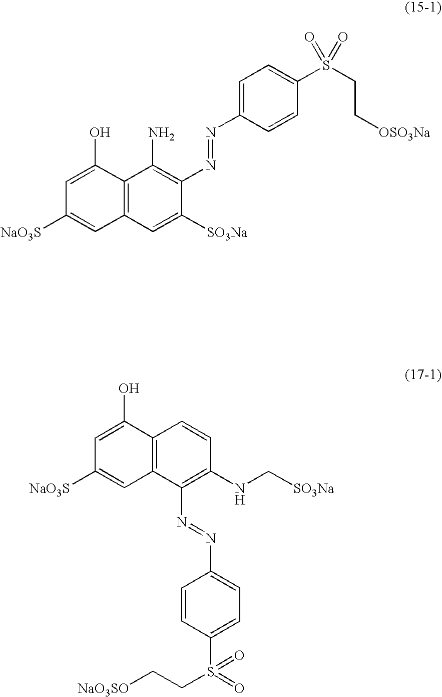

When the first coupling is at an end the pH is adjusted to 5.5-6.5 at below 25° C. using sodium carbonate. The 64.5:15.5:20 mixture of the three azo dyes (I-1), (II-6) and (III-1), obtained after the end of the second coupling reaction, is isolated by spray drying.

Alternatively the resultant dye solution can also be buffered by addition of a phosphate buffer at a pH of 5.5-6 and adjusted to a liquid product of defined strength by further dilution or concentration.

The resulting dye mixture of the invention dyes cotton in black shades.

### EXAMPLE 7

515 parts of 4-(β-sulfatoethylsulfonyl)aniline are suspended in 1200 parts of ice-water and 330 parts of 30% strength hydrochloric acid and diazotized by dropwise addition of 318 parts of 40% strength sodium nitrite solution. Following removal of the excess nitrite with amidosulfonic acid, 210 parts of 1-amino-8-hydroxynaphthalene-3,6-disulfonic acid are added and the components are coupled in a first stage at a pH of 1 to 1.5 at below 20° C. to give a red monoazo dye of the formula (15-1). The indicated pH range is set by adding solid sodium hydrogen carbonate and is maintained during the coupling reaction.

When the first coupling is at an end, 58.5 parts of (2,5-dimethylphenylamino)-methanesulfonic acid, prepared by reacting 33 parts of 2,5-dimethylaniline with 40 parts of formaldehyde-sodium bisulfite in an aqueous medium at a pH of 5.5-6 and 40° C., and also an aqueous solution of 143 parts of the scarlet monoazo dye of the formula (17-2), 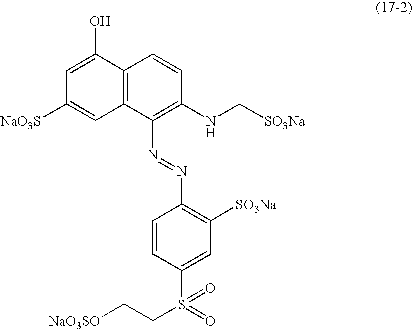
obtained by diazotizing 65 parts of 2-amino-5-(β-sulfatoethylsulfonyl)benzenesulfonic acid with 31.5 pads of 40% strength sodium nitrite solution in an acidic medium and then coupling the diazonium salt with 60 parts of 4-hydroxy-7-(sulfomethylamino)-naphthalene-2-sulfonic acid at a pH of 1-2, are added to the reaction mixture. Subsequently, at below 25° C., the pH is adjusted to 5.5-6.5 using sodium carbonate and the mixture thus obtained after the end of the coupling reaction, a 65:15:20 mixture of the three dyes (I-1), (II-1) and (III-2), is isolated by concentration under reduced pressure or by spray drying.

The resulting dye mixture of the invention dyes cotton in black shades.

### EXAMPLE 8

515 parts of 4-(β-sulfatoethylsulfonyl)aniline are suspended in 1200 parts of ice-water and 330 parts of 30% strength hydrochloric acid and diazotized by dropwise addition of 318 parts of 40% strength sodium nitrite solution. Following removal of the excess nitrite with amidosulfonic acid, 210 parts of 1-amino-8-hydroxynaphthalene-3,6-disulfonic acid are added and the components are coupled in a first stage at a pH of 1 to 1.5 at below 20° C. to give a red monoazo dye of the formula (15-1). The indicated pH range is set by adding solid sodium hydrogen carbonate and is maintained during the coupling reaction.

When the first coupling is at an end, 44.5 parts of (3-ureidophenylamino)methane-sulfonic acid prepared by reacting 27.5 parts of (3-aminophenyl)urea with 27 parts of formaldehyde-sodium bisulfite in an aqueous medium at a pH of 5.5-6 and 40° C. and also 76 parts of the 7-acetylamino-4-hydroxynaphthalene-2-sulfonic acid are added to the reaction mixture.

Subsequently, at below 25° C., the pH is adjusted to 5.5-6.5 using sodium carbonate and the mixture thus obtained after the end of the coupling reaction, a 70.5:11.5:18 mixture of the three dyes (I-1), (II-9) and (IV-2), is isolated by concentration under reduced pressure or by spray drying.

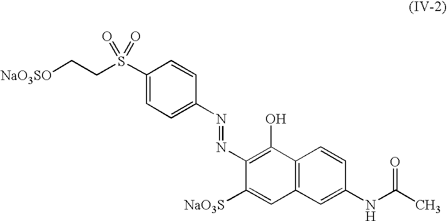

The resulting dye mixture of the invention dyes cotton in black shades.

### EXAMPLE 9

515 parts of 4-(β-sulfatoethylsulfonyl)aniline are suspended in 1200 parts of ice-water and 330 parts of 30% strength hydrochloric acid and diazotized by dropwise addition of 318 parts of 40% strength sodium nitrite solution. Following removal of the excess nitrite with amidosulfonic acid, 210 parts of 1-amino-8-hydroxynaphthalene-3,6-disulfonic acid are added and the components are coupled in a first stage at a pH of 1 to 1.5 at below 20° C. to give a red monoazo dye of the formula (15-1). The indicated pH range is set by adding solid sodium hydrogen carbonate and is maintained during the coupling reaction.

When the first coupling is at an end, the pH is adjusted to 5.5-6.5 at below 25° C. using sodium carbonate and 99.5 parts of m-tolylaminomethanesulfonic acid, prepared by reacting 53 parts of m-toluidine with 73 parts of formaldehyde-sodium bisulfite in an aqueous medium at a pH of 5.5-6 and 40° C., are added to the reaction mixture.

Subsequently the mixture formed after the end of the coupling reaction, a 71:29 mixture of the two dyes (I-1) and (II-4), is isolated by concentration under reduced pressure or by spray drying.

The resulting dye mixture of the invention dyes cotton in greenish black shades.

### EXAMPLE 10

395 parts of 4-(β-sulfatoethylsulfonyl)aniline are suspended in 900 parts of ice-water and 254 parts of 30% strength hydrochloric acid and diazotized by dropwise addition of 245 parts of 40% strength sodium nitrite solution. Following removal of the excess nitrite with amidosulfonic acid, 160 parts of I -amino-8-hydroxynaphthalene-3,6-disulfonic acid are added and the components are coupled in a first stage at a pH of 1 to 1.5 at below 20° C. to give a red monoazo dye of the formula (15-1). The indicated pH range is set by adding solid sodium hydrogen carbonate and is maintained during the coupling reaction.

When the first coupling is at an end, the pH is adjusted to 5.5-6.5 at below 25° C. using sodium carbonate and an aqueous solution containing 42.5 parts of (2,5-dimethylphenylamino)methanesulfonic acid and 48.5 parts of (3-ureidophenylamino)-methanesulfonic acid, prepared by reacting a mixture of 24 parts of 2,5-dimethylphenylamine and 30 parts of 3-aminophenylurea with 59 parts of formaldehyde-sodium bisulfite in an aqueous medium at a pH of 5.5-6 and 40° C., are added to the reaction mixture.

Subsequently the mixture formed after the end of the coupling reaction, a 69:15:16 mixture of the three dyes (I-1), (II-1) and (II-9), is isolated by concentration under reduced pressure or by spray drying.

The resulting dye mixture of the invention dyes cotton in black shades.

### EXAMPLE 11

55.5 parts of 2-methoxy-5-(β-sulfatoethylsulfonyl)aniline are suspended in 170 parts of ice-water and 32 parts of 30% strength hydrochloric acid and diazotized by dropwise addition of 31.5 parts of 40% strength sodium nitrite solution. Subsequently the excess nitrite is removed with amidosulfonic acid solution and the diazo suspension obtained is pumped into an aqueous solution containing a mixture of 67.5 parts of the red monoazo dye of the formula (15-1) and 15 parts of (2,5-dimethyl-phenylamino)methanesulfonic acid, prepared by reacting 8.5 parts of 2,5-dimethyl-phenylamine with 10.5 parts of formaldehyde-sodium bisulphite in an aqueous medium at a pH of 5.5-6 and at 40° C. Here, at the same time and at below 25° C., the pH is adjusted to 5.5-6.5 using sodium carbonate and is maintained until coupling is at an end. The mixture obtained after the end of the coupling reaction, a 71.5:28.5 mixture of the two dyes (I-2) and (II-3), is isolated by concentration under reduced pressure or by spray drying.

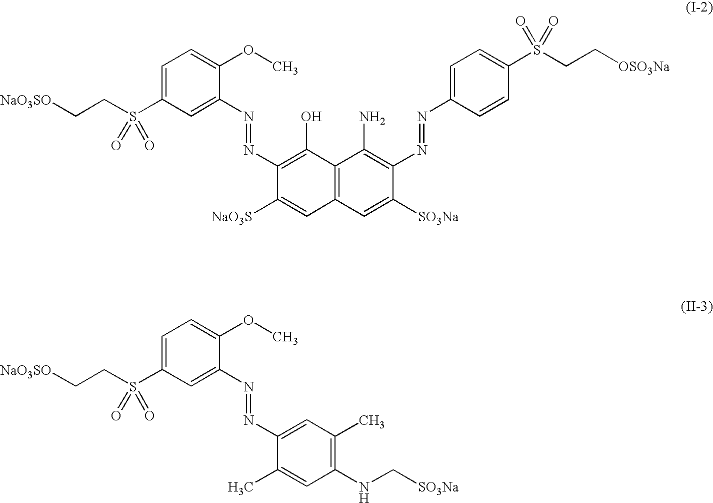

The resulting dye mixture of the invention dyes cotton in greenish black shades.

### EXAMPLE 12

A mixture of 39.5 parts of 4-(β-sulfatoethylsulfonyl)aniline and 31.5 parts of 2-methoxy-5-(β-sulfatoethylsulfonyl)aniline is suspended in 190 parts of ice-water and 44 parts of 30% strength hydrochloric acid and diazotized by dropwise addition of 42.5 parts of 40% strength sodium nitrite solution. Following removal of the excess nitrite with amidosulfonic acid, 52 parts of (2,5-dimethylphenylamino)methanesulfonic acid, prepared by reacting 29.3 parts of 2,5-dimethylphenylamine with 35.7 parts of formaldehyde sodium bisulfite in an aqueous medium at a pH of 5.5-6 and at 40° C., are added to the reaction mixture and the pH is adjusted to 5.5-6.5 using sodium carbonate, at below 25° C. The mixture of the two monoazo dyes (II-1) and (II-3) formed after the end of coupling is subsequently admixed with 300 parts of the disazo dye of the formula (I-1), and the resultant 69:18:13 mixture of the three dyes (I-1), (II-1) and (II-3) is isolated by concentration under reduced pressure or by spray drying. The resulting dye mixture of the invention dyes cotton in greenish black shades.

### EXAMPLE 13

a) 230 parts of 4-(β-sulfatoethylsulfonyl)aniline are suspended in 550 parts of ice-water and 148 parts of 30% strength hydrochloric acid and diazotized by dropwise addition of 142 parts of 40% strength sodium nitrite solution. Following removal of the excess nitrite with amidosulfonic acid, 187 parts of 1-amino-8-hydroxynaphthalene-3,6-disulfonic acid and 46 parts of 7-amino-4-hydroxynaphthalene-2-sulfonic acid are added and in a first stage the components are coupled at a pH of 1 and at below 20° C. to give a mixture of the two monoazo dyes of formulae (15-1) and (17-3). The indicated pH range is set by adding solid sodium hydrogen carbonate and is maintained during the coupling reaction.

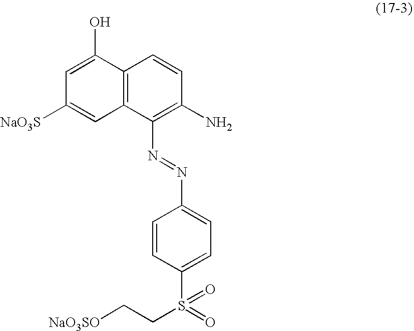

After the end of the first coupling reaction, 60 parts of m-tolylaminomethanesulfonic acid, prepared by reacting 32 parts of m-toluidine with 44 parts of formaldehyde-sodium bisulfite in an aqueous medium at a pH of 5.5-6 and at 40° C., are added to this mixture.

b) In a second, separate reaction vessel 375 parts of 2,5-dimethoxy-4-(β-sulfatoethyl-sulfonyl)aniline are suspended in 1100 parts of ice-water and 200 parts of 30% strength hydrochloric acid and diazotized by dropwise addition of 192 parts of 40% strength sodium nitrite solution. Subsequently the excess nitrite is removed using amidosulfonic acid solution and the resulting diazo suspension after the end of the first coupling is pumped into the reaction mixture from a).

Then the pH is adjusted to 5.5-6.5 using sodium carbonate, at below 25° C., and the 63:18:19 mixture of the three dyes (I-3), (II-5) and (III-43), obtained after the end of the second coupling reaction, is isolated by concentration under reduced pressure or by spray drying.

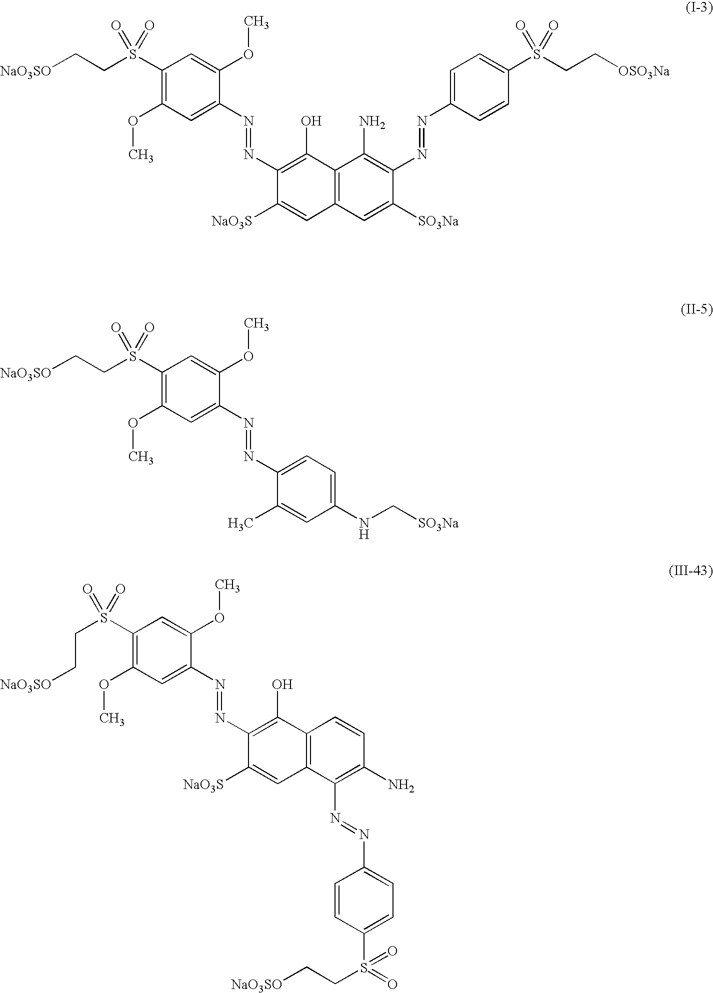

The dye mixture of the invention thus obtained dyes cotton in black shades.

### EXAMPLE 14

50 parts of an electrolyte-containing dye powder comprising the greenish navy disazo dye of the formula (I-4) 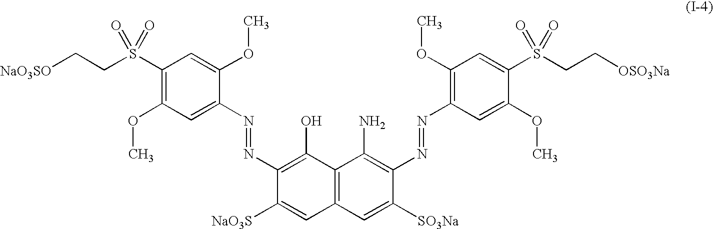
in 70% fraction, 25 parts of an electrolyte-containing dye powder comprising the navy disazo dye of the formula (I-1) in 75% fraction, 10 parts of an electrolyte-containing dye powder comprising the yellow azo dye of the formula (II-9) in likewise 75% fraction and 15 parts of an electrolyte-containing dye powder comprising the scarlet disazo dye of the formula (III-2) in 80% fraction are dissolved in 500 parts of water and the resulting dye solution is adjusted to a pH of 5.5-6.5 and buffered using phosphate buffer. Evaporative concentration of this solution gives a dye mixture which, under the dyeing conditions customary for reactive dyes, produces deep-black dyeings and prints on cotton.

Alternatively the dye solution obtained can be adjusted to a liquid product of defined strength by further dilution or concentration.

### EXAMPLE 15

281 parts of 4-(β-sulfatoethylsulfonyl)aniline are suspended in 650 parts of ice-water and 181 parts of 30% strength hydrochloric acid and diazotized by dropwise addition of 175 parts of 40% strength sodium nitrite solution. Following removal of the excess nitrite with amidosulfonic acid, 79 parts of 7-amino-4-hydroxynaphthalene-2-sulfonic acid are added and in a first stage the components are coupled at a pH of 1 to 1.5 and at below 20° C. to give a scarlet monoazo dye of the formula (17-3). The indicated pH range is set by adding solid sodium hydrogen carbonate and is maintained during the coupling reaction.

After the end of the first coupling, at below 25° C., the pH is adjusted to 5.5-6.5 with sodium carbonate, and is maintained, and an aqueous solution containing 71 parts of (2,5-dimethylphenylamino)methanesulfonic acid, prepared by reacting 40 parts of 2,5-dimethylphenylamine with 49 parts of formaldehyde-sodium bisulfite in an aqueous medium at a pH of 5.5-6 and at 40° C., is added to the reaction mixture. In the aqueous mixture, formed after the end of the coupling reaction, of the two dyes (II-1) and (III-7)

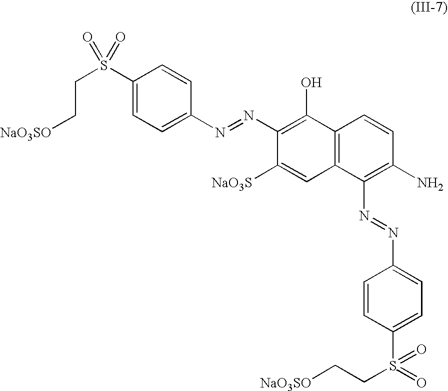

970 parts of the navy disazo dye of the formula (I-6) 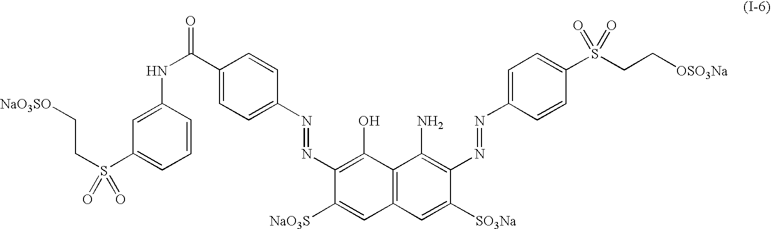
are additionally dissolved or suspended and the resultant 67:12.5:20.5 mixture of the three dyes (I-6), (II-1) and (III-7) is isolated by concentration under reduced pressure or by spray drying.

Under the dyeing conditions customary for reactive dyes, and with an amount of salt reduced as compared with the standard method, the resultant dye mixture of the invention, on cotton for example, produces deep-black dyeings.

### EXAMPLE 16

28 parts of 4-(β-sulfatoethylsulfonyl)aniline are suspended in 65 parts of ice-water and 18 parts of 30% strength hydrochloric acid and diazotized by dropwise addition of 17.5 parts of 40% strength sodium nitrite solution. Following removal of the excess nitrite with amidosulfonic acid, this diazo suspension is added dropwise at a pH of 5-6 and at below 20° C. to an aqueous solution containing 11 parts of 1 -aminonaphthalene-4-sulfonic acid and 12 parts of (2,5-diethylphenylamino)methane-sulfonic acid, prepared by reacting 7.5 parts of 2,5-diethylphenylamine with 7.5 parts of formaldehyde-sodium bisulfite in an aqueous medium at a pH of 5.5-6 and 40° C., and the components are coupled to give a mixture of two yellow to orange monoazo dyes of the formulae (II-22) and (IV-15). The indicated pH range is set by adding sodium carbonate and is maintained during the coupling reaction. 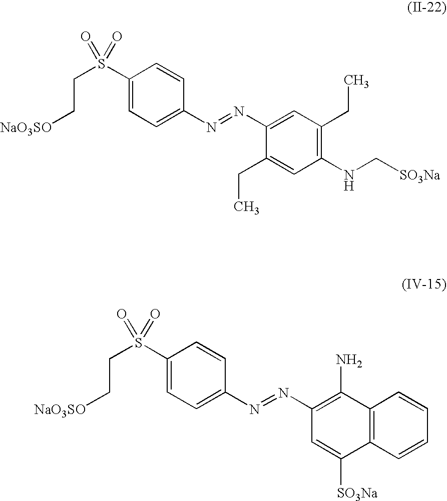
After the end of coupling, an aqueous solution containing 115 parts of the navy disazo dye of the formula (I-9) 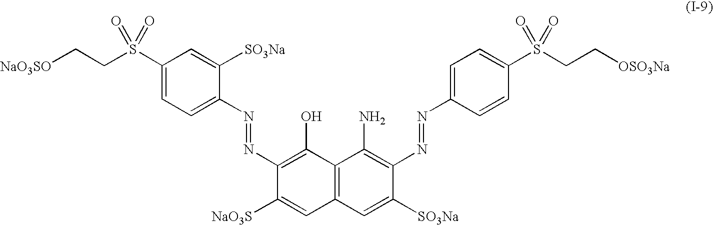
is added to the reaction mixture and the resulting 67:17:16 mixture of the three dyes (I-9), (II-22) and (IV-15) is isolated by concentration under reduced pressure or by spray drying.

Under the dyeing conditions customary for reactive dyes, the resulting dye mixture of the invention, on cotton for example, produces black dyeings.

### EXAMPLES 17 TO 768

The tabular examples below describe further inventive mixtures of the dyes of formulae (I)-(IV), each given in the form of the sodium salts. The proportions are expressed in percent by weight. In accordance with the dyeing methods customary for reactive dyes, on cotton for example, the dye mixtures produce blue-gray to deep-black dyeings.

Dye mixtures according to example 1 or 2

| Example | Dye of formula (I) |
|---|---|
| 17 | (I-1) |
| 18 | (I-1) |
| 19 | (I-1) |
| 20 | (I-1) |
| 21 | (I-1) |
| 22 | (I-1) |
| 23 | (I-1) |
| 24 | (I-1) |
| 25 | (I-1) |
| 26 | (I-1) |
| 27 | (I-1) |
| 28 | (I-1) |
| 29 | (I-1) |
| 30 | (I-1) |
| 31 | (I-1) |
| 32 | (I-1) |
| 33 | (I-1) |
| 34 | (I-1) |
| 35 | (I-1) |
| 36 | (I-1) |
| 37 | (I-1) |
| 38 | (I-1) |
| 39 | (I-1) |
| 40 | (I-1) |
| 41 | (I-1) |
| 42 | (I-1) |
| 43 | (I-1) |
| 44 | (I-1) |
| 45 | (I-1) |
| 46 | (I-1) |
| 47 | (I-1) |
| 48 | (I-1) |
| 49 | 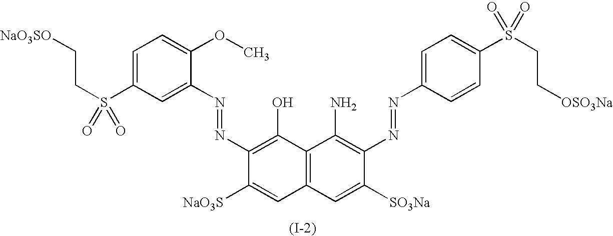 |
| 50 | (I-2) |
| 51 | (I-2) |
| 52 | (I-2) |
| 53 | (I-2) |
| 54 | (I-2) |
| 55 | 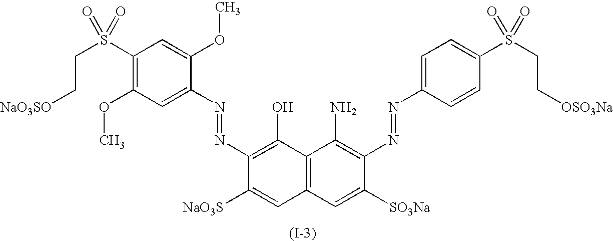 |
| 56 | (I-3) |
| 57 | (I-3) |
| 58 | (I-3) |
| 59 | (I-3) |
| 60 | (I-3) |
| 61 | 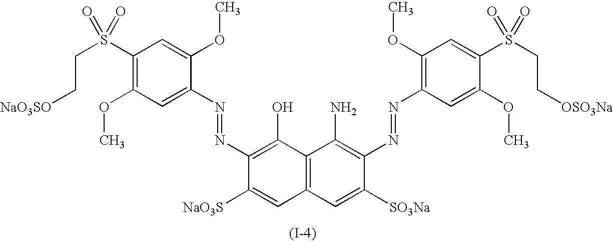 |
| 62 | (I-4) |
| 63 | (I-4) |
| 64 | (I-4) |
| 65 | (I-4) |
| 66 | (I-4) |
| 67 | 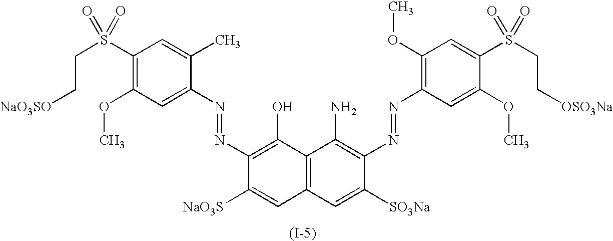 |
| 68 | (I-5) |
| 69 | (I-5) |
| 70 | (I-5) |
| 71 | (I-5) |
| 72 | 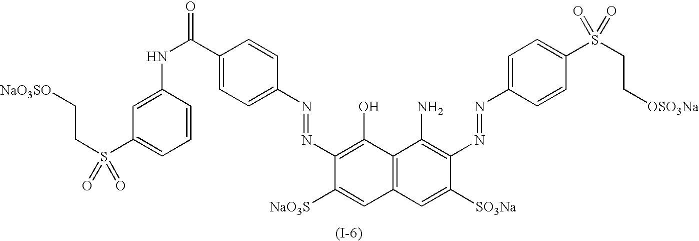 |
| 73 | (I-6) |
| 74 | (I-6) |
| 75 | (I-6) |
| 76 | (I-6) |
| 77 | (I-6) |
| 78 | 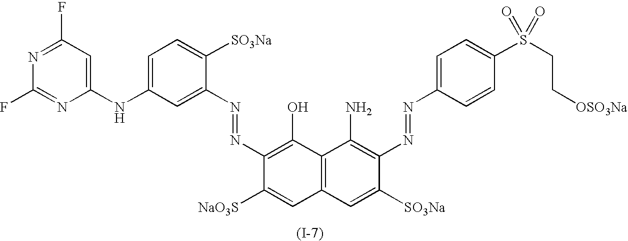 |
| 79 | (I-7) |
| 80 | (I-7) |
| 81 | (I-7) |
| 82 | (I-7) |
| 83 | (I-7) |
| 84 | (I-7) |
| 85 | (I-7) |
| 86 | 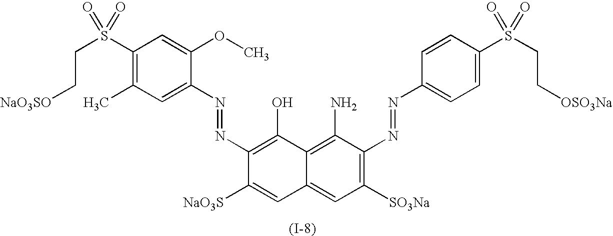 |
| 87 | (I-8) |
| 88 | (I-8) |
| 89 | (I-8) |
| 90 | (I-8) |
| 91 | (I-8) |
| 92 | 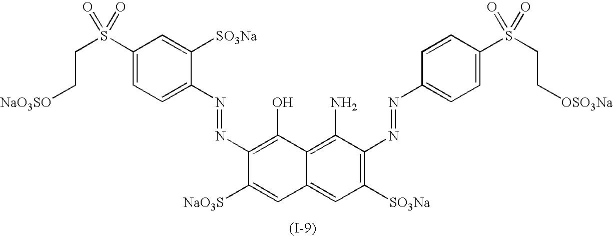 |
| 93 | (I-9) |
| 94 | (I-9) |
| 95 | (I-9) |
| 96 | (I-9) |
| 97 | (I-9) |
| 98 | 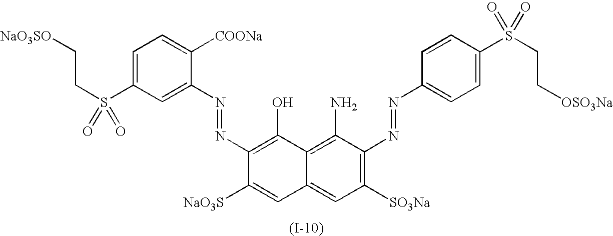 |
| 99 | (I-10) |
| 100 | (I-10) |
| 101 | (I-10) |
| 102 | (I-10) |
| 103 | (I-10) |
| 104 | 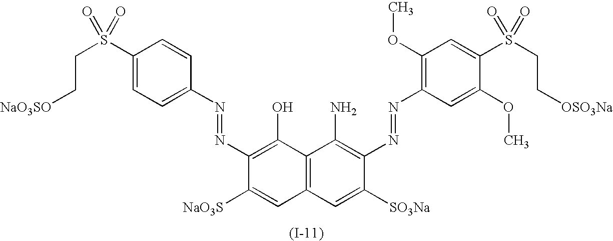 |
| 105 | (I-11) |
| 106 | (I-11) |
| 107 | (I-11) |
| 108 | (I-11) |
| 109 | (I-11) |
| 110 | 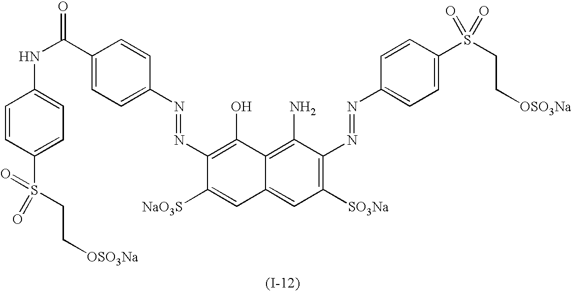 |
| 111 | (I-12) |
| 112 | (I-12) |
| 113 | (I-12) |
| 114 | (I-12) |
| 115 | (I-12) |
| 116 | (I-12) |
| 117 | 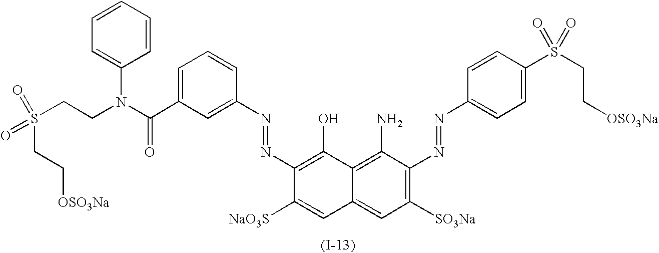 |
| 118 | (I-13) |
| 119 | (I-13) |
| 120 | (I-13) |
| 121 | (I-13) |
| 122 | (I-13) |
| 123 | 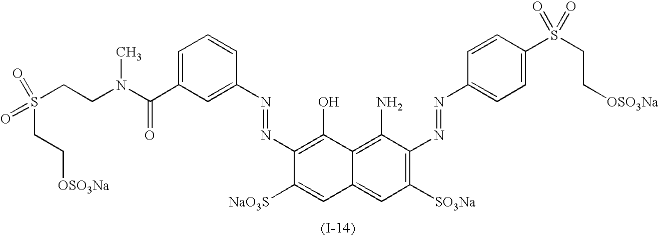 |
| 124 | (I-14) |
| 125 | (I-14) |
| 126 | (I-14) |
| 127 | (I-14) |
| 128 | (I-14) |
| 129 | 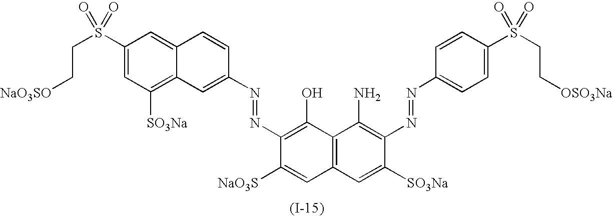 |
| 130 | (I-15) |
| 131 | (I-15) |
| 132 | (I-15) |
| 133 | (I-15) |
| 134 | (I-15) |
| 135 | (I-15) |
| 136 | 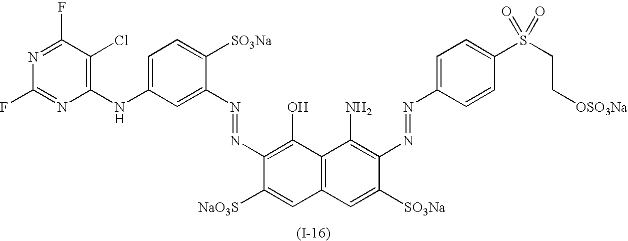 |
| 137 | (I-16) |
| 138 | (I-16) |
| 139 | (I-16) |
| 140 | (I-16) |
| 141 | (I-16) |
| 142 | (I-16) |
| 143 | (I-16) |
| 144 | 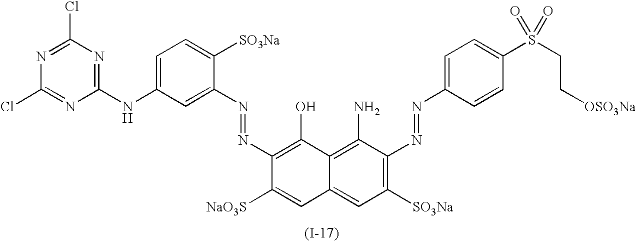 |
| 145 | (I-17) |
| 146 | (I-17) |
| 147 | (I-17) |
| 148 | (I-17) |
| 149 | (I-17) |
| 150 | (I-17) |
| 151 | 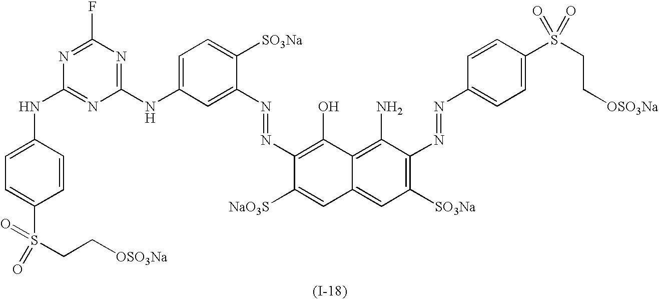 |
| 152 | (I-18) |
| 153 | (I-18) |
| 154 | (I-18) |
| 155 | (I-18) |
| 156 | (I-18) |
| 157 | (I-18) |
| 158 | (I-18) |
| 159 | (I-18) |
| 160 | 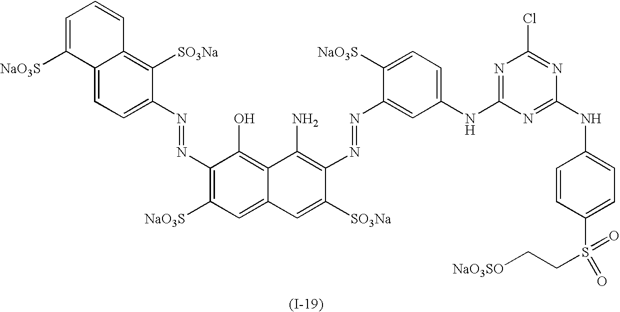 |
| 161 | (I-19) |
| 162 | (I-19) |
| 163 | (I-19) |
| 164 | (I-19) |
| 165 | (I-19) |
| 166 | (I-19) |
| 167 | (I-19) |
| 168 | 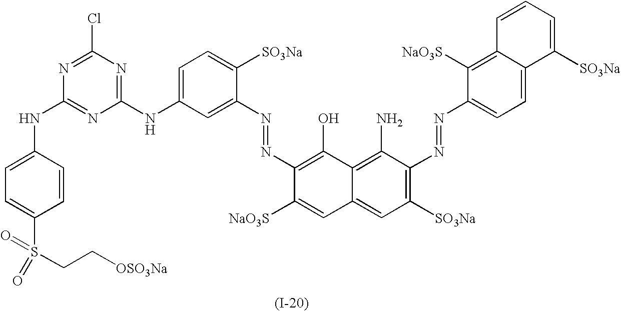 |
| 169 | (I-20) |
| 170 | (I-20) |
| 171 | (I-20) |
| 172 | (I-20) |
| 173 | (I-20) |
| 174 | (I-20) |
| 175 | (I-20) |
| 176 | (I-20) |
| 177 | 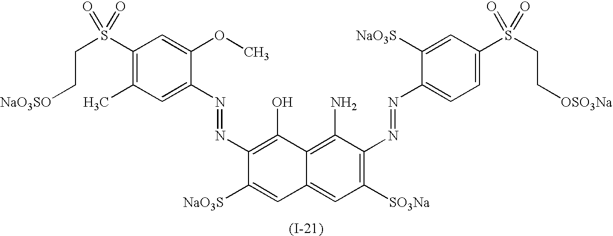 |
| 178 | (I-21) |
| 179 | (I-21) |
| 180 | (I-21) |
| 181 | (I-21) |
| 182 | (I-21) |
| 183 | (I-21) |
| 184 | (I-21) |

| Example | Dye of formula (II-x) |
|---|---|
| 17 | 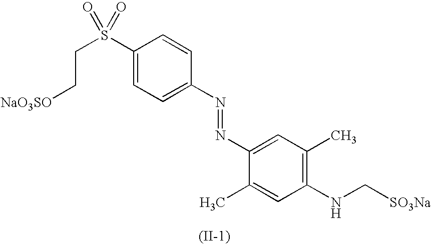 |
| 18 | (II-2) |
| 19 | 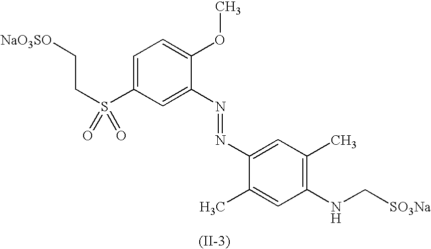 |
| 20 | 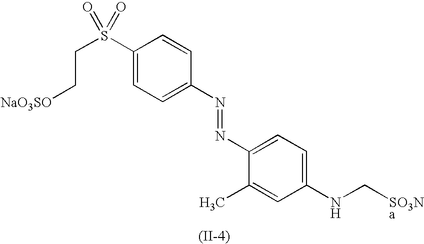 |
| 21 | (II-5) |
| 22 | 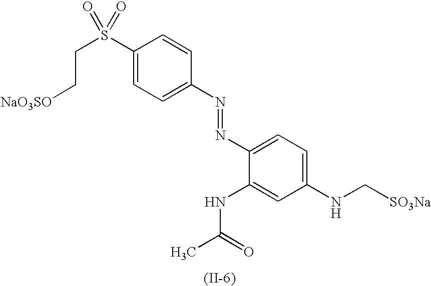 |
| 23 | (II-7) |
| 24 | 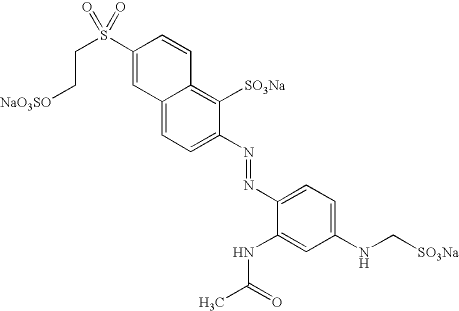 |
| 25 | 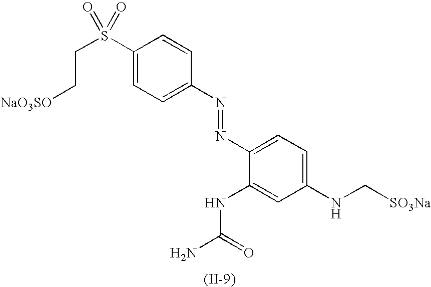 |
| 26 | (II-2) |
| 27 | (II-5) |
| 28 | 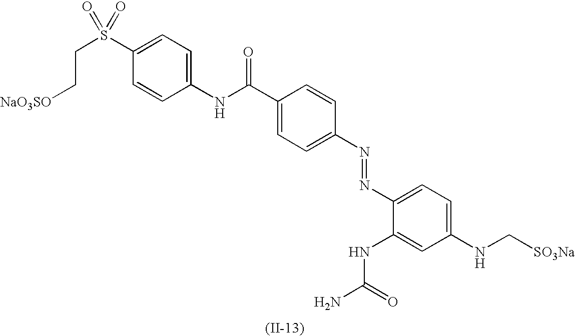 |
| 29 | (II-3) |
| 30 | (II-9) |
| 31 | (II-7) |
| 32 | (II-6) |
| 33 | 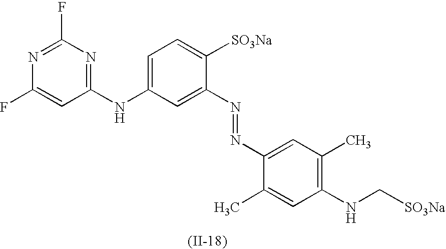 |
| 34 | 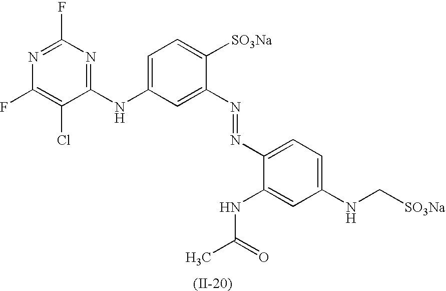 |
| 35 | (II-2) |
| 36 | 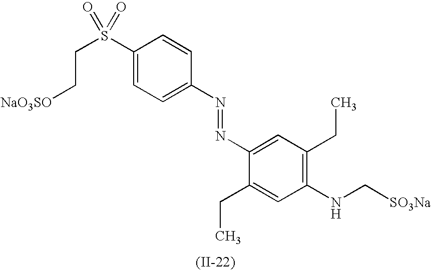 |
| 37 | 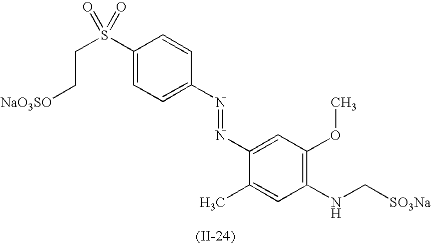 |
| 38 | 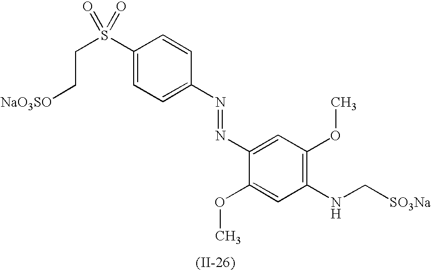 |
| 39 | (II-1) |
| 40 | (II-1) |
| 41 | (II-1) |
| 42 | (II-1) |
| 43 | (II-4) |
| 44 | (II-4) |
| 45 | (II-4) |
| 46 | (II-6) |
| 47 | (II-6) |
| 48 | (II-9) |
| 49 | (II-1) |
| 50 | (II-4) |
| 51 | (II-6) |
| 52 | (II-9) |
| 53 | (II-10) |
| 54 | (II-25) |
| 55 | (II-4) |
| 56 | (II-6) |
| 57 | (II-9) |
| 58 | (II-1) |
| 59 | (II-10) |
| 60 | (II-25) |
| 61 | (I-1) |
| 62 | (II-4) |
| 63 | (II-6) |
| 64 | (II-1) |
| 65 | (II-8) |
| 66 | (II-10) |
| 67 | (II-1) |
| 68 | (II-4) |
| 69 | (II-6) |
| 70 | (II-8) |
| 71 | (II-10) |
| 72 | (II-1) |
| 73 | (II-4) |
| 74 | (II-6) |
| 75 | (II-9) |
| 76 | (II-14) |
| 77 | (II-22) |
| 78 | (II-1) |
| 79 | (II-4) |
| 80 | (II-6) |
| 81 | (II-9) |
| 82 | (II-18) |
| 83 | (II-20) |
| 84 | (II-21) |
| 85 | (II-22) |
| 86 | (II-1) |
| 87 | (II-4) |
| 88 | (II-6) |
| 89 | (II-9) |
| 90 | (II-2) |
| 91 | (II-25) |
| 92 | (II-1) |
| 93 | (II-4) |
| 94 | (II-6) |
| 95 | (II-9) |
| 96 | (II-10) |
| 97 | (II-25) |
| 98 | (II-1) |
| 99 | (II-4) |
| 100 | (II-6) |
| 101 | (II-9) |
| 102 | (II-17) |
| 103 | (II-22) |
| 104 | (II-4) |
| 105 | (II-6) |
| 106 | (II-9) |
| 107 | (II-1) |
| 108 | (II-10) |
| 109 | (II-26) |
| 110 | (II-1) |
| 111 | (II-4) |
| 112 | (II-6) |
| 113 | (II-9) |
| 114 | (II-13) |
| 115 | (II-13) |
| 116 | (II-22) |
| 117 | (II-1) |
| 118 | (II-4) |
| 119 | (II-6) |
| 120 | (II-9) |
| 121 | (II-15) |
| 122 | (II-22) |
| 123 | (II-1) |
| 124 | (II-4) |
| 125 | (II-6) |
| 126 | (II-9) |
| 127 | (II-16) |
| 128 | (II-22) |
| 129 | (II-1) |
| 130 | (II-3) |
| 131 | (II-4) |
| 132 | (II-6) |
| 133 | (II-8) |
| 134 | (II-9) |
| 135 | (II-22) |
| 136 | (II-1) |
| 137 | (II-4) |
| 138 | (II-6) |
| 139 | (II-9) |
| 140 | (II-18) |
| 141 | (II-20) |
| 142 | (II-23) |
| 143 | (II-22) |
| 144 | (II-1) |
| 145 | (II-4) |
| 146 | (II-6) |
| 147 | (II-9) |
| 148 | (II-18) |
| 149 | (II-20) |
| 150 | (II-21) |
| 151 | (II-1) |
| 152 | (II-4) |
| 153 | (II-6) |
| 154 | (II-9) |
| 155 | (II-18) |
| 156 | (II-20) |
| 157 | (II-21) |
| 158 | (II-21) |
| 159 | (II-22) |
| 160 | (II-1) |
| 161 | (II-4) |
| 162 | (II-6) |
| 163 | (II-9) |
| 164 | (II-18) |
| 165 | (II-20) |
| 166 | (II-22) |
| 167 | (II-23) |
| 168 | (II-1) |
| 169 | (II-4) |
| 170 | (II-7) |
| 171 | (II-9) |
| 172 | (II-18) |
| 173 | (II-20) |
| 174 | (II-22) |
| 175 | (II-23) |
| 176 | (II-26) |
| 177 | (II-1) |
| 178 | (II-4) |
| 179 | (II-6) |
| 180 | (II-9) |
| 181 | (II-10) |
| 182 | (II-2) |
| 183 | (II-3) |
| 184 | (II-25) |

| | | Ratio |
|---|---|---|
| Example | Dye of formula (II-y) | (I):(II-x):(II-y) |
| 17 | 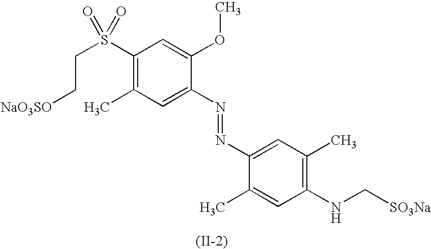 | 68:17:15 |
| 18 | — | 70:30 |
| 19 | — | 62:38 |
| 20 | 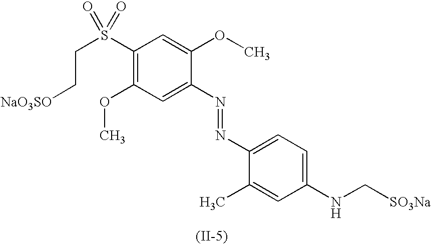 | 64:20:16 |
| 21 | — | 72:28 |
| 22 | 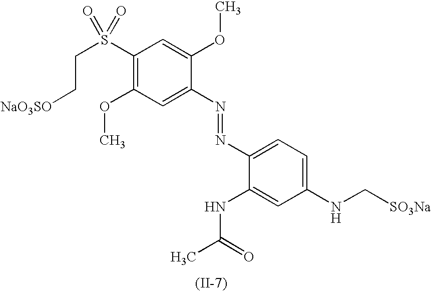 | 65:20:15 |
| 23 | — | 70:30 |
| 24 | — | 70:30 |
| 25 | 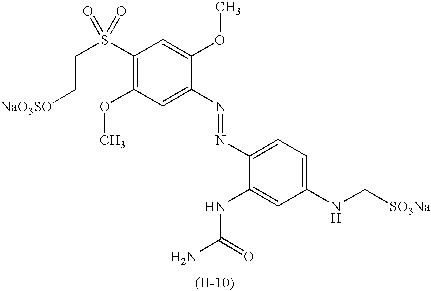 | 66:22:12 |
| 26 | 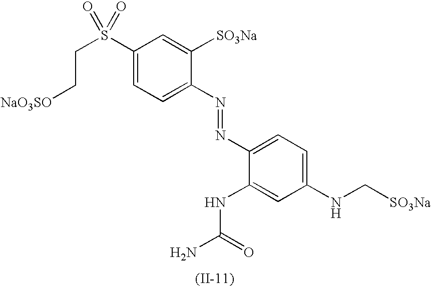 | 62:19:19 |
| 27 | 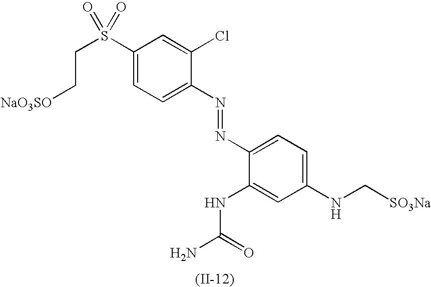 | 65:20:15 |
| 28 | — | 70:30 |
| 29 | 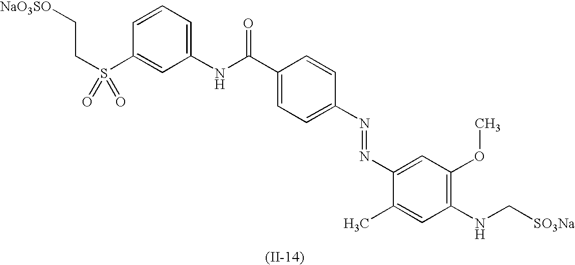 | 63:20:17 |
| 30 | 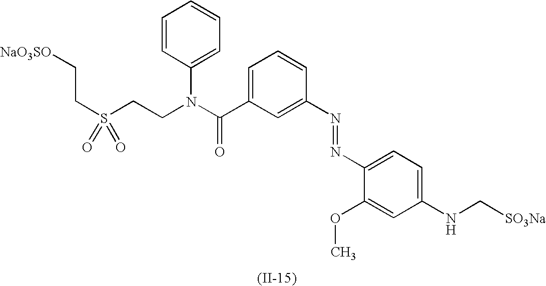 | 65:20:15 |
| 31 | 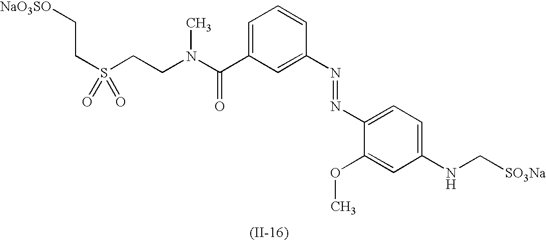 | 65:18:17 |
| 32 | 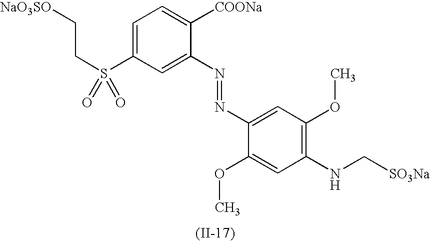 | 60:20:20 |
| 33 | 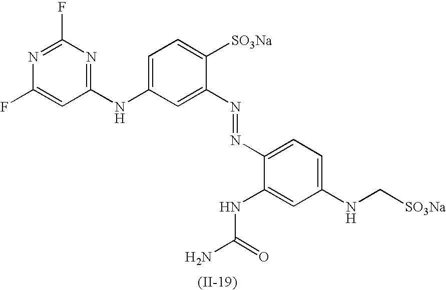 | 67:18:15 |
| 34 | — | 67:33 |
| 35 | 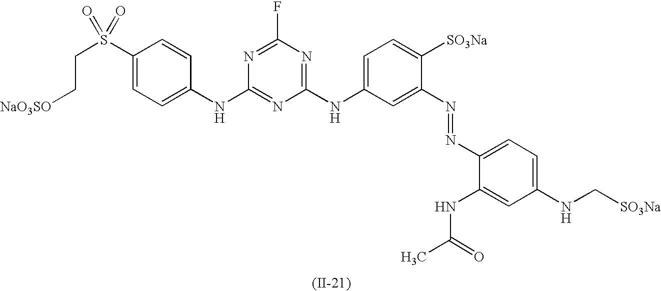 | 65:15:20 |
| 36 | 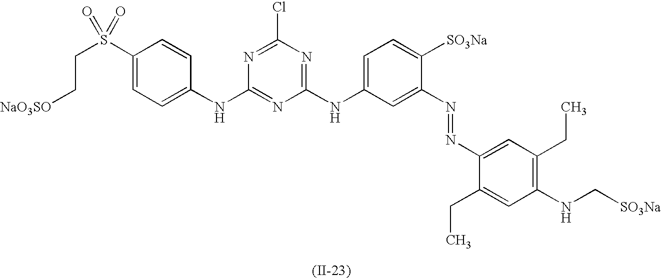 | 63:22:15 |
| 37 | 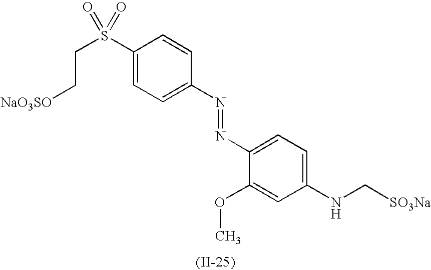 | 60:20:20 |
| 38 | — | 65:35 |
| 39 | (II-4) | 67:16:17 |
| 40 | (II-6) | 67:14:19 |
| 41 | (II-9) | 64:18:18 |
| 42 | (II-25) | 65:15:20 |
| 43 | (II-6) | 66:17:17 |
| 44 | (II-9) | 67:13:20 |
| 45 | (II-25) | 65:17:18 |
| 46 | (II-9) | 68:15:17 |
| 47 | (II-25) | 65:18:17 |
| 48 | (II-22) | 67:18:15 |
| 49 | (II-2) | 70:15:15 |
| 50 | (II-5) | 66:19:15 |
| 51 | (II-7) | 67:18:15 |
| 52 | (II-22) | 68:20:12 |
| 53 | — | 67:33 |
| 54 | — | 72:28 |
| 55 | (II-5) | 67:14:19 |
| 56 | (II-7) | 65:18:17 |
| 57 | (II-10) | 69:11:20 |
| 58 | (II-22) | 68:20:12 |
| 59 | — | 70:30 |
| 60 | — | 65:35 |
| 61 | (I-3) | 65:10:25 |
| 62 | (II-5) | 62:15:23 |
| 63 | (II-7) | 68:12:20 |
| 64 | (II-22) | 60:20:20 |
| 65 | — | 72:28 |
| 66 | — | 67:33 |
| 67 | (II-2) | 63:15:22 |
| 68 | (II-5) | 66:15:19 |
| 69 | (II-7) | 68:16:16 |
| 70 | — | 75:25 |
| 71 | — | 70:30 |
| 72 | (II-2) | 68:19:13 |
| 73 | (II-5) | 68:20:12 |
| 74 | (II-7) | 65:25:10 |
| 75 | (II-10) | 70:20:10 |
| 76 | +113 | 73:27 |
| 77 | (II-5) | 67:21:12 |
| 78 | (II-2) | 66:20:14 |
| 79 | (II-5) | 65:20:15 |
| 80 | (II-7) | 66:22:12 |
| 81 | (II-10) | 65:25:10 |
| 82 | (II-19) | 68:18:14 |
| 83 | — | 70:30 |
| 84 | (II-10) | 67:23:10 |
| 85 | (II-5) | 65:22:13 |
| 86 | (II-2) | 66:16:18 |
| 87 | (II-5) | 68:14:18 |
| 88 | (II-7) | 65:17:18 |
| 89 | (II-10) | 68:13:19 |
| 90 | — | 70:30 |
| 91 | — | 67:33 |
| 92 | (II-2) | 66:19:15 |
| 93 | (II-5) | 67:18:15 |
| 94 | (II-7) | 70:15:15 |
| 95 | (II-22) | 68:18:14 |
| 96 | — | 72:28 |
| 97 | — | 69:31 |
| 98 | (II-2) | 68:20:12 |
| 99 | (II-5) | 66:20:14 |
| 100 | (II-7) | 65:25:10 |
| 101 | (II-10) | 70:18:12 |
| 102 | — | 70:30 |
| 103 | (II-5) | 70:20:10 |
| 104 | (II-5) | 67:13:20 |
| 105 | (II-7) | 65:16:19 |
| 106 | (II-10) | 70:13:17 |
| 107 | (II-22) | 68:16:16 |
| 108 | — | 72:28 |
| 109 | — | 67:33 |
| 110 | (II-2) | 68:19:13 |
| 111 | (II-5) | 68:20:12 |
| 112 | (II-7) | 65:25:10 |
| 113 | (II-10) | 70:20:10 |
| 114 | — | 73:27 |
| 115 | — | 70:30 |
| 116 | (II-5) | 67:20:13 |
| 117 | (II-2) | 70:18:12 |
| 118 | (II-5) | 67:20:13 |
| 119 | (II-7) | 70:20:10 |
| 120 | (II-10) | 72:18:10 |
| 121 | — | 68:32 |
| 122 | (II-5) | 72:18:10 |
| 123 | (II-2) | 70:18:12 |
| 124 | (II-5) | 70:20:10 |
| 125 | (II-7) | 72:18:10 |
| 126 | (II-10) | 75:16:9 |
| 127 | — | 65:35 |
| 128 | (II-5) | 73:18:9 |
| 129 | (II-2) | 66:22:12 |
| 130 | — | 66:34 |
| 131 | (II-5) | 67:22:11 |
| 132 | (II-7) | 68:22:10 |
| 133 | — | 65:35 |
| 134 | (II-10) | 70:20:10 |
| 135 | (II-5) | 70:17:13 |
| 136 | (II-2) | 66:20:14 |
| 137 | (II-5) | 65:20:15 |
| 138 | (II-7) | 66:22:12 |
| 139 | (II-10) | 70:20:10 |
| 140 | (II-19) | 68:18:14 |
| 141 | — | 70:30 |
| 142 | (II-10) | 67:23:10 |
| 143 | (II-5) | 68:20:12 |
| 144 | (II-2) | 65:20:15 |
| 145 | (II-5) | 65:20:15 |
| 146 | (II-7) | 66:24:10 |
| 147 | (II-10) | 68:21:11 |
| 148 | (II-19) | 68:16:16 |
| 149 | — | 67:33 |
| 150 | (II-10) | 65:22:13 |
| 151 | (II-2) | 68:20:12 |
| 152 | (II-5) | 68:17:15 |
| 153 | (II-7) | 67:20:13 |
| 154 | (II-10) | 72:18:10 |
| 155 | (II-19) | 68:16:16 |
| 156 | — | 72:28 |
| 157 | (II-10) | 66:24:10 |
| 158 | (II-23) | 65:17:18 |
| 159 | (II-5) | 70:18:12 |
| 160 | (II-2) | 67:23:10 |
| 161 | (II-5) | 66:20:14 |
| 162 | (II-7) | 66:24:10 |
| 163 | (II-10) | 70:20:10 |
| 164 | (II-19) | 67:17:16 |
| 165 | — | 71:29 |
| 166 | (II-5) | 68:20:12 |
| 167 | (II-10) | 65:25:10 |
| 168 | (II-2) | 68:22:10 |
| 169 | (II-5) | 67:20:13 |
| 170 | — | 70:30 |
| 171 | (II-10) | 70:20:10 |
| 172 | (II-19) | 69:16:15 |
| 173 | — | 68:32 |
| 174 | (II-5) | 68:20:12 |
| 175 | (II-10) | 67:23:10 |
| 176 | — | 63:37 |
| 177 | (II-2) | 66:16:18 |
| 178 | (II-5) | 68:14:18 |
| 179 | (II-7) | 65:17:18 |
| 180 | (II-10) | 68:13:19 |
| 181 | (II-11) | 66:24:10 |
| 182 | — | 70:30 |
| 183 | — | 60:40 |
| 184 | — | 65:35 |

Dye mixtures according to example 3

| | Dye of | Dye of | | Ratio |
|---|---|---|---|---|
| Example | formula (I) | formula (II) | Dye of formula (III) | (I):(II):(III) |
| 185 | (I-1) | (II-1) | 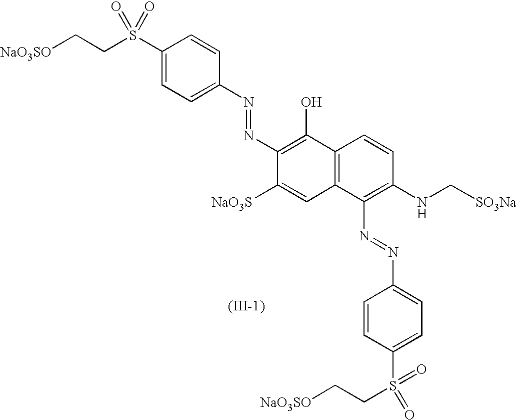 | 67:15:18 |
| 186 | (I-1) | (II-4) | 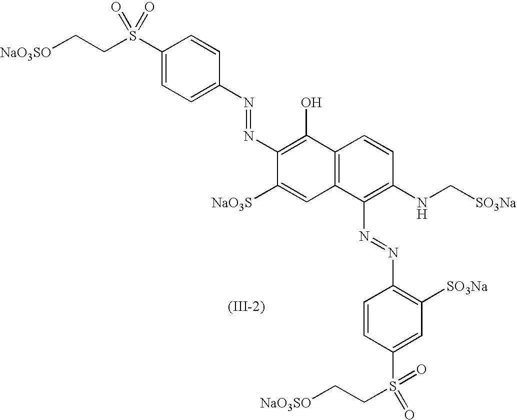 | 68:16:16 |
| 187 | (I-1) | (II-6) | 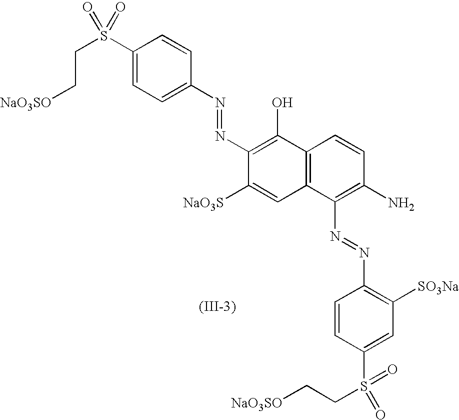 | 66:20:14 |
| 188 | (I-1) | (II-9) | 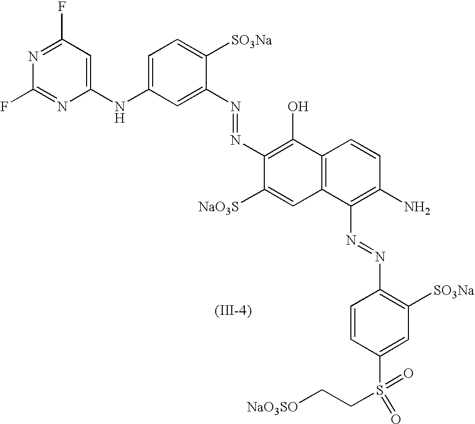 | 70:18:12 |
| 189 | (I-1) | (II-1) | 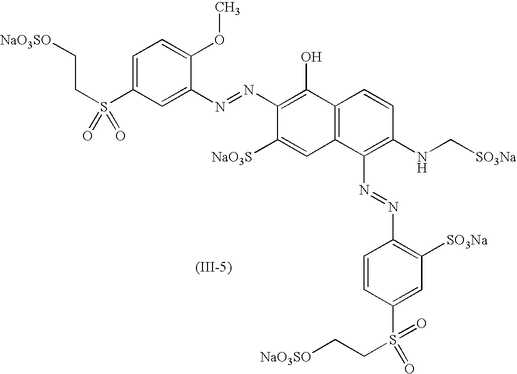 | 67:18:15 |
| 190 | (I-1) | (II-6) | 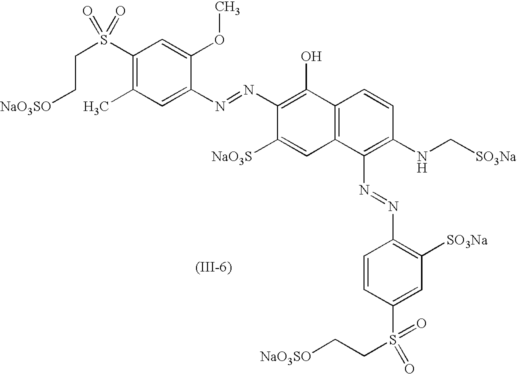 | 72:18:10 |
| 191 | (I-1) | (II-4) | 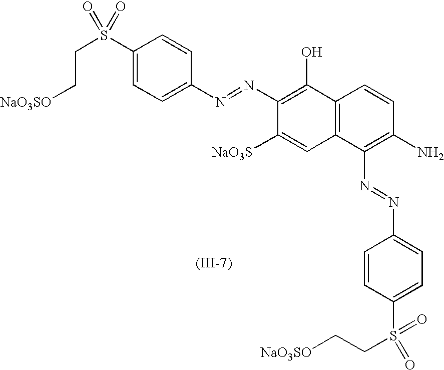 | 67:20:13 |
| 192 | (I-1) | (II-10) | 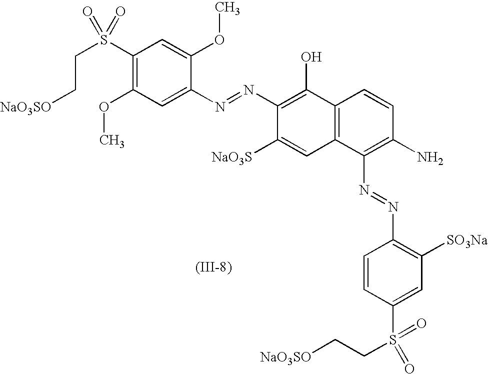 | 73:17:10 |
| 193 | (I-1) | (II-1) | 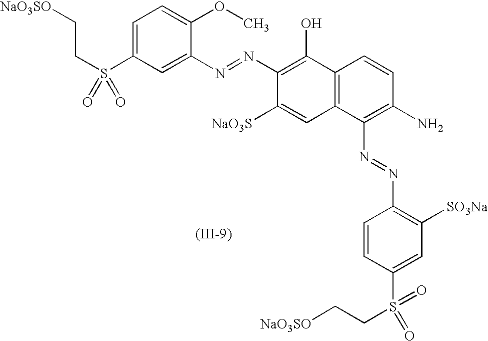 | 70:20:10 |
| 194 | (I-1) | (II-22) | 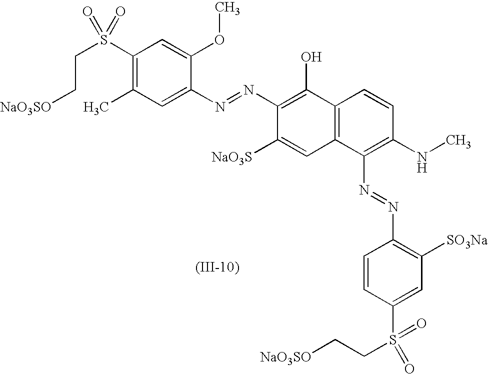 | 75:17:8 |
| 195 | (I-1) | (II-25) | 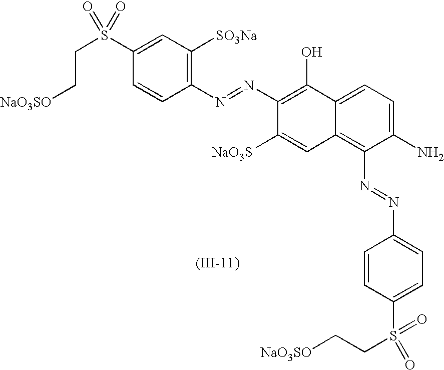 | 65:20:15 |
| 196 | (I-1) | (II-26) | 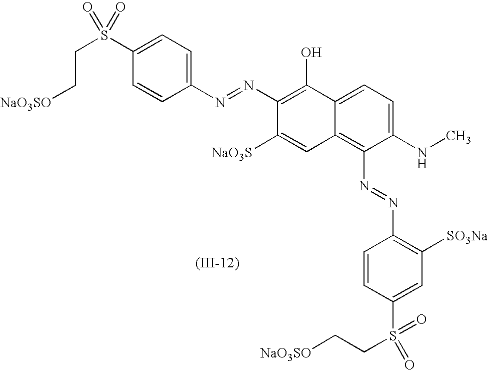 | 72:10:8 |
| 197 | (I-1) | (II-4) | 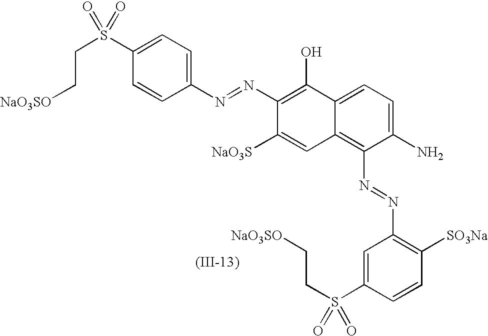 | 67:23:10 |
| 198 | (I-1) | (II-3) | 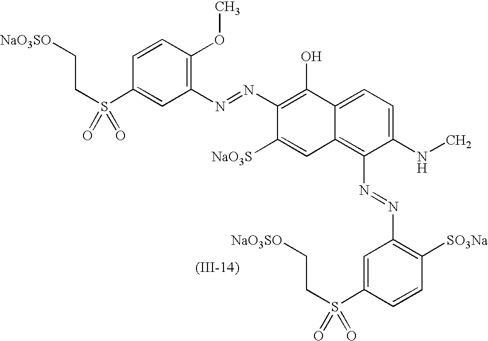 | 72:18:10 |
| 199 | (I-1) | (II-6) | 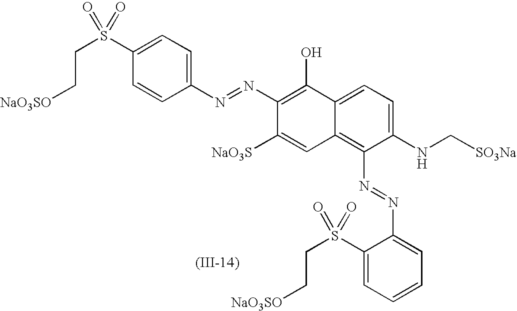 | 68:20:12 |
| 200 | (I-1) | (II-9) | 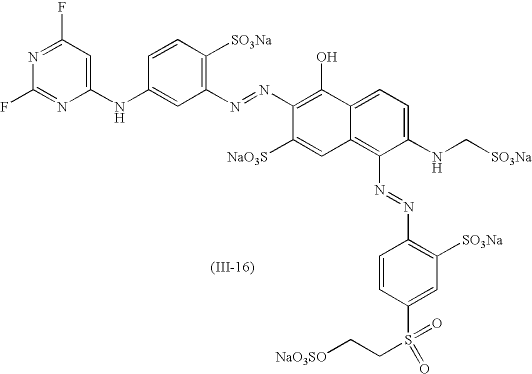 | 70:15:15 |
| 201 | (I-1) | (II-1) | 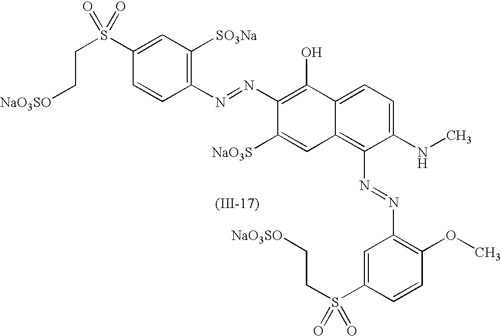 | 70:20:10 |
| 202 | (I-1) | (II-10) | 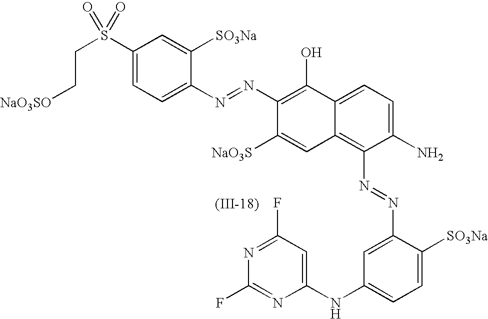 | 68:20:12 |
| 203 | (I-1) | (II-4) | 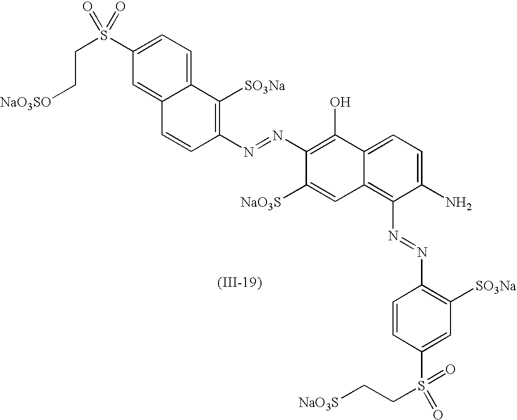 | 75:17:8 |
| 204 | (I-1) | (II-19) | 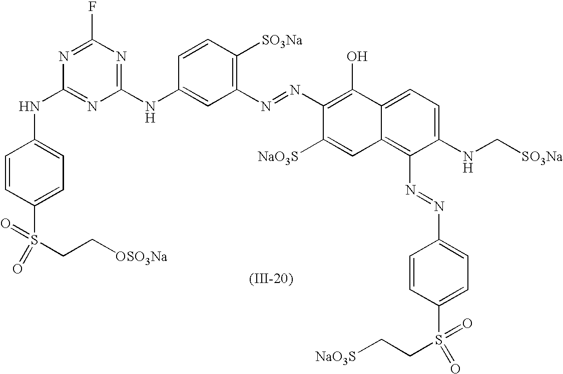 | 66:22:12 |
| 205 | (I-1) | (II-10) | 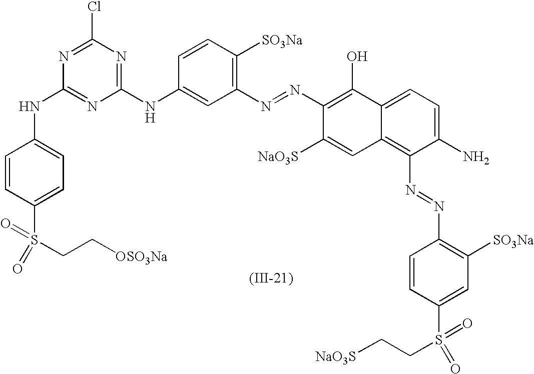 | 68:20:12 |
| 206 | (I-1) | (II-13) | 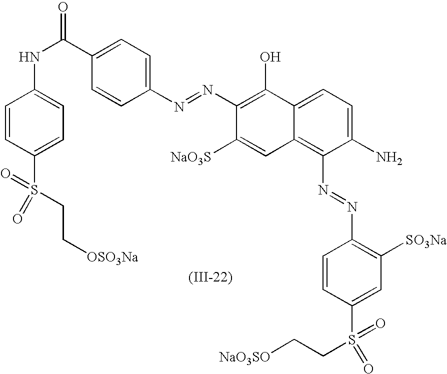 | 70:20:10 |
| 207 | (I-1) | (II-4) | 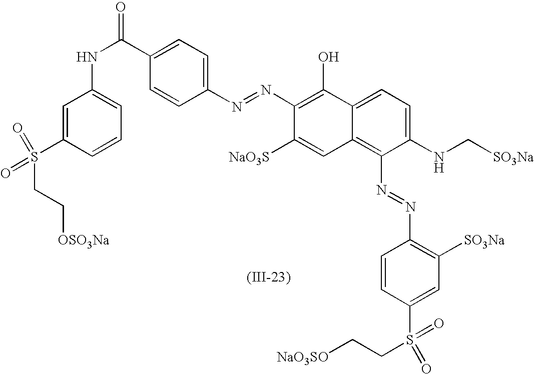 | 67:20:13 |
| 208 | (I-1) | (II-9) | 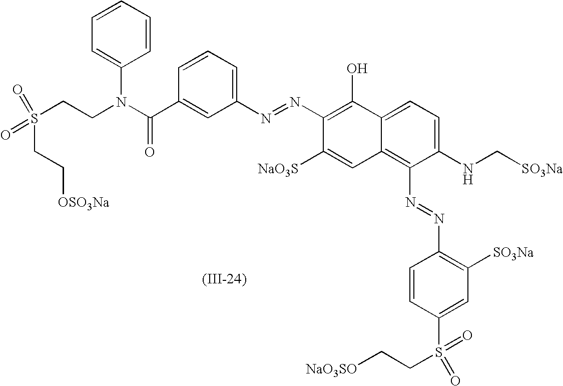 | 68:16:16 |
| 209 | (I-1) | (II-1) | 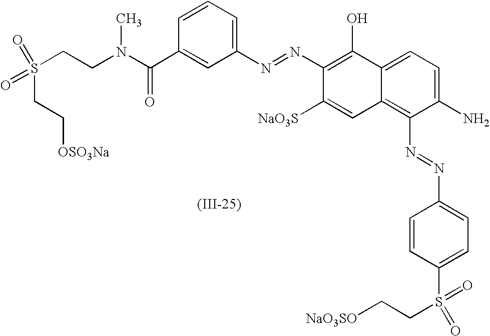 | 68:15:17 |
| 210 | (I-1) | (II-4) | 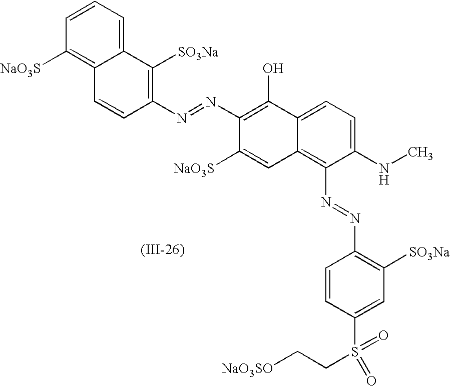 | 75:15:10 |
| 211 | (I-1) | (II-6) | 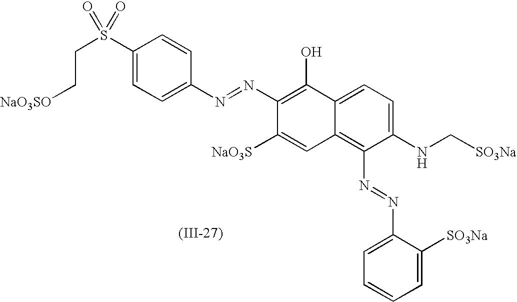 | 65:20:15 |
| 212 | (I-1) | (II-20) | 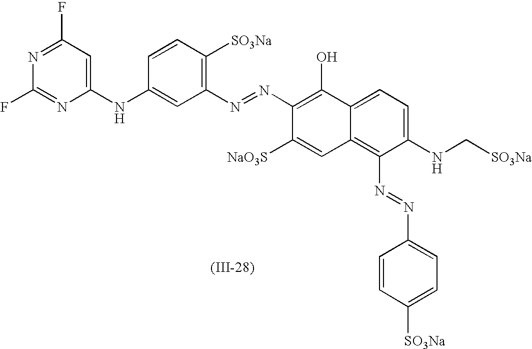 | 70:15:15 |
| 213 | (I-1) | (II-9) | 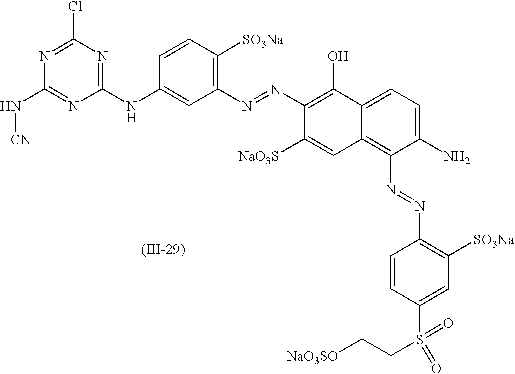 | 67:18:15 |
| 214 | (I-1) | (II-11) | 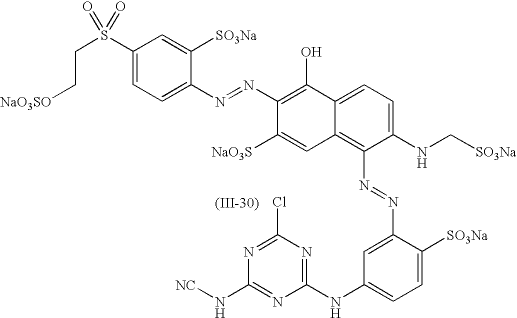 | 68:20:12 |
| 215 | (I-1) | (II-6) | 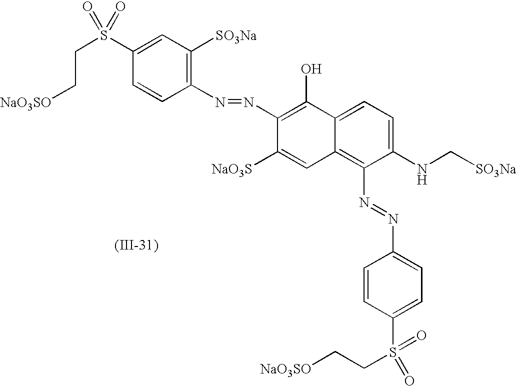 | 68:16:16 |
| 216 | (I-1) | (II-22) | 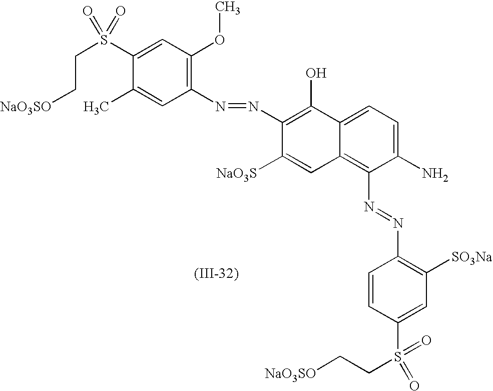 | 73:17:10 |
| 217 | (I-1) | (II-9) | 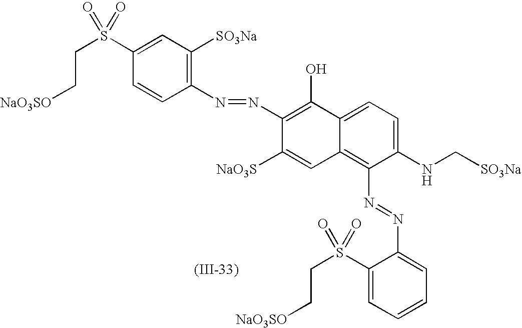 | 70:14:16 |
| 218 | (I-1) | (II-2) | 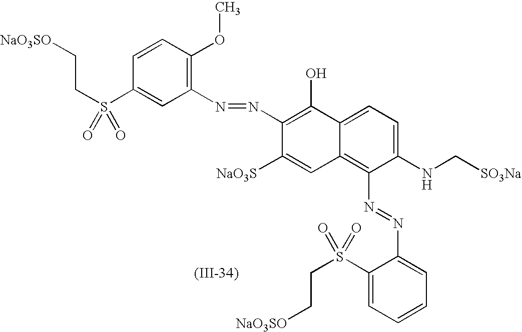 | 70:13:17 |
| 219 | (I-1) | (II-1) | 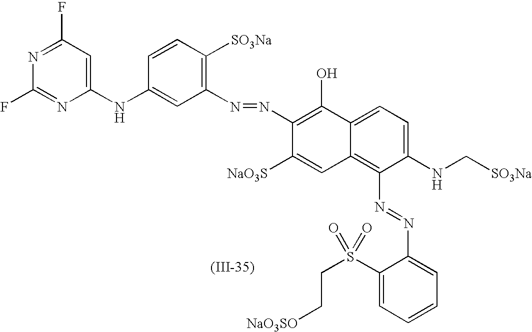 | 67:20:13 |
| 220 | (I-1) | (II-10) | 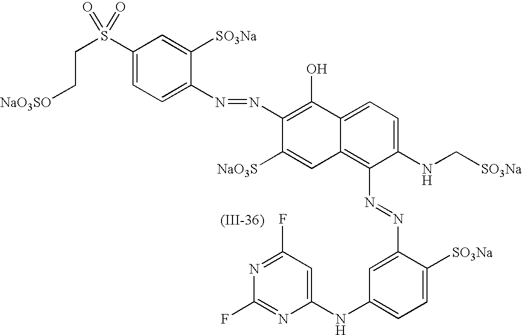 | 70:15:15 |
| 221 | (I-1) | (II-3) | 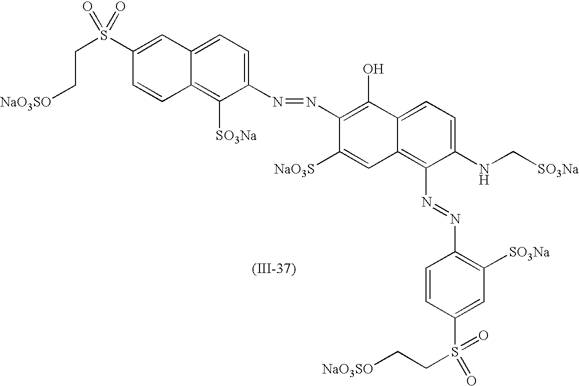 | 68:18:14 |
| 222 | (I-1) | (II-22) | 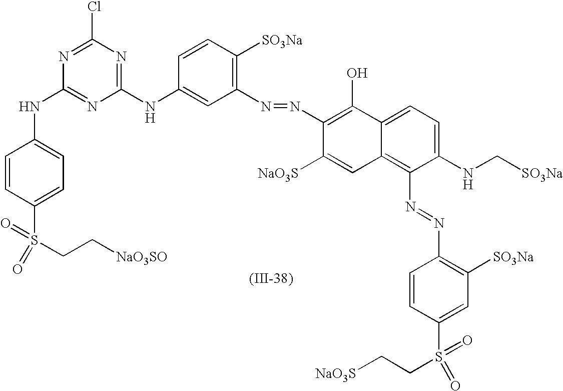 | 67:20:13 |
| 223 | (I-1) | (II-1) | 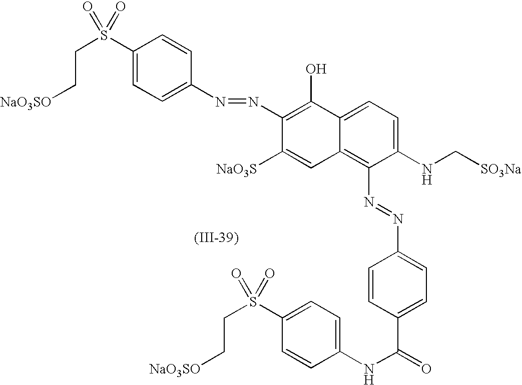 | 70:20:10 |
| 224 | (I-1) | (II-9) | 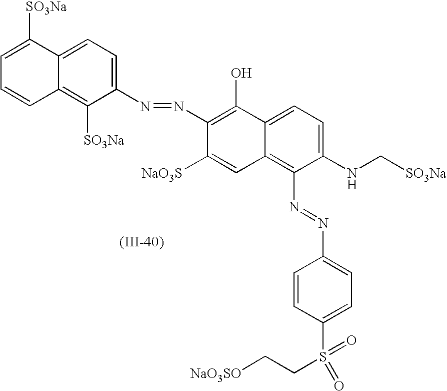 | 66:16:18 |
| 225 | (I-1) | (II-6) | 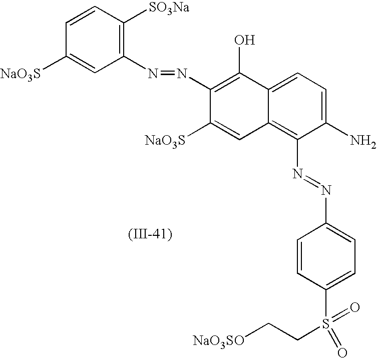 | 67:20:13 |
| 226 | (I-1) | (II-1) | 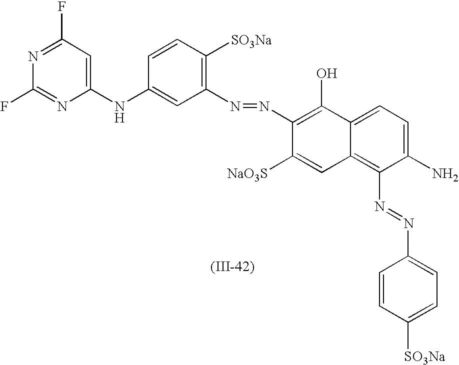 | 68:20:12 |
| 227 | (I-1) | (II-2) | 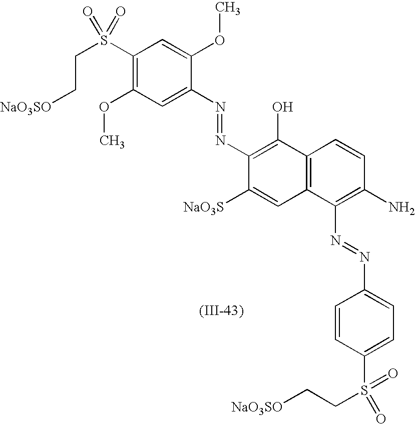 | 70:15:15 |

| | Dye of | Dye of | Dye of | Ratio |
|---|---|---|---|---|
| Example | formula (I) | formula (II) | formula (III) | (I):(II):(III) |
| 228 | (I-1) | (II-4) | (III-1) | 67:13:20 |
| 229 | (I-1) | (II-6) | (III-1) | 68:12:20 |
| 230 | (I-1) | (II-9) | (III-1) | 68:10:22 |
| 231 | (I-1) | (II-10) | (III-1) | 68:14:18 |
| 232 | (I-1) | (II-22) | (III-1) | 65:15:20 |
| 233 | (I-1) | (II-24) | (III-1) | 66:14:20 |
| 234 | (I-1) | (II-25) | (III-1) | 67:12:21 |
| 235 | (I-1) | (II-26) | (III-1) | 68:10:22 |
| 236 | (I-1) | (II-1) | (III-2) | 67:13:20 |
| 237 | (I-1) | (II-6) | (III-2) | 68:12:20 |
| 238 | (I-1) | (II-9) | (III-2) | 70:10:20 |
| 239 | (I-1) | (II-10) | (III-2) | 66:14:20 |
| 240 | (I-1) | (II-22) | (III-2) | 65:15:20 |
| 241 | (I-1) | (II-24) | (III-2) | 67:14:19 |
| 242 | (I-1) | (II-25) | (III-2) | 67:12:21 |
| 243 | (I-1) | (II-26) | (III-2) | 68:10:22 |
| 244 | (I-2) | (II-1) | (III-1) | 67:13:20 |
| 245 | (I-2) | (II-4) | (III-2) | 65:17:18 |
| 246 | (I-2) | (II-6) | (III-3) | 68:16:16 |
| 247 | (I-2) | (II-9) | (III-5) | 70:12:18 |
| 248 | (I-2) | (II-10) | (III-9) | 68:20:12 |
| 249 | (I-2) | (II-22) | (III-32) | 70:20:10 |
| 250 | (I-2) | (II-1) | (III-12) | 75:15:10 |
| 251 | (I-2) | (II-6) | (III-16) | 70:12:18 |
| 252 | (I-2) | (II-9) | (III-37) | 73:15:12 |
| 253 | (I-2) | (II-4) | (III-41) | 67:16:17 |
| 254 | (I-3) | (II-1) | (III-2) | 67:15:18 |
| 255 | (I-3) | (II-4) | (III-1) | 67:13:20 |
| 256 | (I-3) | (II-6) | (III-9) | 70:14:16 |
| 257 | (I-3) | (II-9) | (III-6) | 70:12:18 |
| 258 | (I-3) | (II-10) | (III-5) | 68:10:22 |
| 259 | (I-3) | (II-22) | (III-3) | 70:10:20 |
| 260 | (I-3) | (II-6) | (III-12) | 73:12:15 |
| 261 | (I-3) | (II-1) | (III-16) | 68:12:20 |
| 262 | (I-3) | (II-4) | (III-37) | 72:10:18 |
| 263 | (I-3) | (II-9) | (III-41) | 67:13:20 |
| 264 | (I-4) | (II-1) | (III-1) | 70:8:22 |
| 265 | (I-4) | (II-4) | (III-6) | 73:7:20 |
| 266 | (I-4) | (II-5) | (III-3) | 68:12:20 |
| 267 | (I-4) | (II-6) | (III-2) | 70:10:20 |
| 268 | (I-4) | (II-7) | (III-5) | 72:8:20 |
| 269 | (I-4) | (II-9) | (III-32) | 70:14:16 |
| 270 | (I-4) | (II-10) | (III-12) | 73:10:17 |
| 271 | (I-4) | (II-22) | (III-41) | 68:10:22 |
| 272 | (I-4) | (II-9) | (III-16) | 70:15:15 |
| 273 | (I-4) | (II-6) | (III-37) | 70:12:18 |
| 274 | (I-5) | (II-1) | (III-1) | 67:10:23 |
| 275 | (I-5) | (II-4) | (III-3) | 70:10:20 |
| 276 | (I-5) | (II-6) | (III-6) | 72:13:15 |
| 277 | (I-5) | (II-7) | (III-5) | 73:8:19 |
| 278 | (I-5) | (II-9) | (III-2) | 68:14:18 |
| 279 | (I-5) | (II-10) | (III-41) | 68:10:22 |
| 280 | (I-6) | (II-1) | (III-7) | 69:12:19 |
| 281 | (I-6) | (II-4) | (III-1) | 67:11:22 |
| 282 | (I-6) | (II-6) | (III-9) | 70:10:20 |
| 283 | (I-6) | (II-9) | (III-32) | 70:15:15 |
| 284 | (I-6) | (II-13) | (III-22) | 68:12:20 |
| 285 | (I-6) | (II-14) | (III-23) | 67:10:23 |
| 286 | (I-7) | (II-1) | (III-5) | 70:12:18 |
| 287 | (I-7) | (II-4) | (III-2) | 68:12:20 |
| 288 | (I-7) | (II-6) | (III-1) | 72:11:17 |
| 289 | (I-7) | (II-9) | (III-32) | 75:10:15 |
| 290 | (I-7) | (II-18) | (III-4) | 72:12:16 |
| 291 | (I-7) | (II-19) | (III-16) | 67:13:20 |
| 292 | (I-7) | (II-20) | (III-3) | 67:10:23 |
| 293 | (I-7) | (II-21) | (III-41) | 60:18:22 |
| 294 | (I-8) | (II-1) | (III-2) | 72:8:20 |
| 295 | (I-8) | (II-2) | (III-32) | 75:8:17 |
| 296 | (I-8) | (II-4) | (III-1) | 70:5:25 |
| 297 | (I-8) | (II-6) | (III-9) | 67:8:25 |
| 298 | (I-8) | (II-9) | (III-41) | 66:9:25 |
| 299 | (I-8) | (II-10) | (III-5) | 70:10:20 |
| 300 | (I-9) | (II-1) | (III-9) | 72:10:18 |
| 301 | (I-9) | (II-4) | (III-6) | 74:11:15 |
| 302 | (I-9) | (II-6) | (III-1) | 68:10:22 |
| 303 | (I-9) | (II-9) | (III-2) | 70:10:20 |
| 304 | (I-9) | (II-10) | (III-5) | 67:13:20 |
| 305 | (I-9) | (II-11) | (III-41) | 60:20:20 |
| 306 | (I-10) | (II-1) | (III-2) | 70:12:18 |
| 307 | (I-10) | (II-4) | (III-41) | 65:12:23 |
| 308 | (I-10) | (II-6) | (III-1) | 70:10:20 |
| 309 | (I-10) | (II-9) | (III-5) | 67:13:20 |
| 310 | (I-10) | (II-17) | (III-6) | 67:17:16 |
| 311 | (I-11) | (II-1) | (III-5) | 68:15:17 |
| 312 | (I-11) | (II-4) | (III-1) | 66:14:20 |
| 313 | (I-11) | (II-6) | (III-6) | 70:14:16 |
| 314 | (I-11) | (II-9) | (III-2) | 67:13:20 |
| 315 | (I-11) | (II-10) | (III-41) | 65:15:20 |
| 316 | (I-12) | (II-1) | (III-1) | 66:14:20 |
| 317 | (I-12) | (II-4) | (III-3) | 67:13:20 |
| 318 | (I-12) | (II-6) | (III-32) | 70:15:15 |
| 319 | (I-12) | (II-9) | (III-9) | 66:12:22 |
| 320 | (I-12) | (II-13) | (III-7) | 70:14:16 |
| 321 | (I-12) | (II-14) | (III-22) | 72:13:15 |
| 322 | (I-13) | (II-6) | (III-2) | 72:15:13 |
| 323 | (I-13) | (II-1) | (III-5) | 70:18:12 |
| 324 | (I-13) | (II-9) | (III-6) | 75:15:10 |
| 325 | (I-13) | (II-4) | (III-1) | 68:17:15 |
| 326 | (I-13) | (II-15) | (III-3) | 70:20:10 |
| 327 | (I-13) | (II-22) | (III-24) | 68:17:15 |
| 328 | (I-14) | (II-1) | (III-32) | 74:18:8 |
| 329 | (I-14) | (II-9) | (III-1) | 70:15:15 |
| 330 | (I-14) | (II-6) | (III-5) | 72:18:10 |
| 331 | (I-14) | (II-4) | (III-2) | 70:17:13 |
| 332 | (I-14) | (II-16) | (III-3) | 68:20:12 |
| 333 | (I-14) | (II-10) | (III-25) | 67:18:15 |
| 334 | (I-15) | (II-1) | (III-1) | 67:13:20 |
| 335 | (I-15) | (II-4) | (III-2) | 69:14:17 |
| 336 | (I-15) | (II-6) | (III-5) | 70:15:15 |
| 337 | (I-15) | (II-8) | (III-32) | 75:13:12 |
| 338 | (I-15) | (II-9) | (III-41) | 70:10:20 |
| 339 | (I-15) | (II-10) | (III-37) | 75:15:10 |
| 340 | (I-16) | (II-1) | (III-5) | 70:12:18 |
| 341 | (I-16) | (II-4) | (III-2) | 68:12:20 |
| 342 | (I-16) | (II-6) | (III-1) | 72:12:16 |
| 343 | (I-16) | (II-9) | (III-32) | 75:12:13 |
| 344 | (I-16) | (II-10) | (III-41) | 65:13:22 |
| 345 | (I-16) | (II-18) | (III-4) | 72:12:16 |
| 346 | (I-16) | (II-19) | (III-16) | 67:13:20 |
| 347 | (I-16) | (II-20) | (III-3) | 68:14:18 |
| 348 | (I-17) | (II-1) | (III-1) | 70:15:15 |
| 349 | (I-17) | (II-4) | (III-2) | 67:17:16 |
| 350 | (I-17) | (II-6) | (III-3) | 68:15:17 |
| 351 | (I-17) | (II-9) | (III-5) | 70:18:12 |
| 352 | (I-18) | (II-1) | (III-5) | 68:18:14 |
| 353 | (I-18) | (II-4) | (III-2) | 70:15:15 |
| 354 | (I-18) | (II-6) | (III-1) | 70:12:18 |
| 355 | (I-18) | (II-9) | (III-6) | 72:18:10 |
| 356 | (I-18) | (II-20) | (III-16) | 67:13:20 |
| 357 | (I-18) | (II-21) | (III-20) | 67:15:18 |
| 358 | (I-18) | (II-23) | (III-21) | 68:16:16 |
| 359 | (I-19) | (II-1) | (III-2) | 67:16:17 |
| 360 | (I-19) | (II-4) | (III-3) | 68:16:16 |
| 361 | (I-19) | (II-6) | (III-32) | 70:17:13 |
| 362 | (I-19) | (II-9) | (III-5) | 72:14:14 |
| 363 | (I-19) | (II-18) | (III-16) | 70:13:17 |
| 364 | (I-19) | (II-23) | (III-21) | 66:15:19 |
| 365 | (I-20) | (II-1) | (III-6) | 69:18:13 |
| 366 | (I-20) | (II-4) | (III-2) | 67:16:17 |
| 367 | (I-20) | (II-6) | (III-5) | 72:14:14 |
| 368 | (I-20) | (II-9) | (III-1) | 66:14:20 |
| 369 | (I-20) | (II-19) | (III-16) | 70:14:16 |
| 370 | (I-20) | (II-23) | (III-21) | 65:15:20 |
| 371 | (I-21) | (II-1) | (III-2) | 72:8:20 |
| 372 | (I-21) | (II-2) | (III-6) | 75:9:16 |
| 373 | (I-21) | (II-4) | (III-1) | 70:7:23 |
| 374 | (I-21) | (II-6) | (III-9) | 67:10:23 |
| 375 | (I-21) | (II-9) | (III-41) | 66:9:25 |
| 376 | (I-21) | (II-10) | (III-5) | 70:10:20 |

Dye mixtures according to example 4

| | Dye of | Dye of | | |
|---|---|---|---|---|
| Example | formula (I) | formula (II) | Dye of formula (IV) | Ratio (I):(II):(IV) |
| 377 | (I-1) | (II-6) | 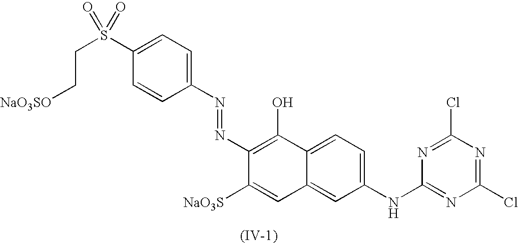 | 70:10:20 |
| 378 | (I-1) | (II-1) | 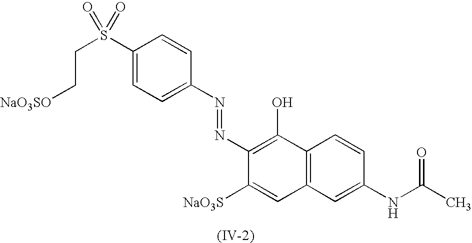 | 66:12:22 |
| 279 | (I-1) | (II-4) | 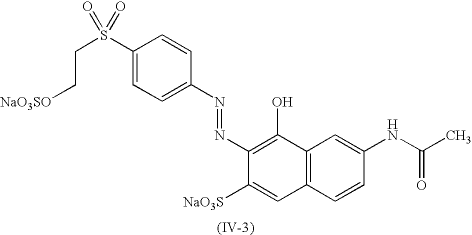 | 65:10:25 |
| 380 | (I-1) | (II-10) | 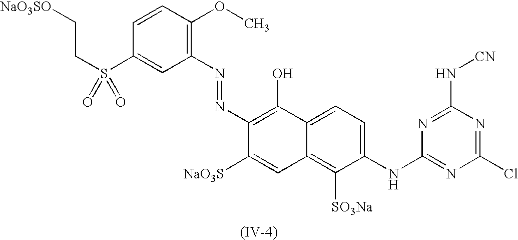 | 67:16:17 |
| 381 | (I-1) | (II-22) | 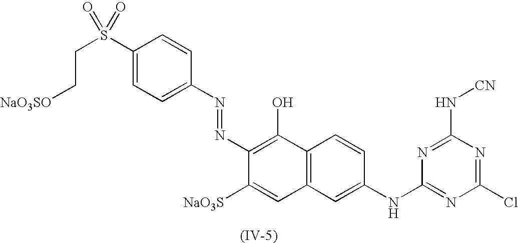 | 70:13:17 |
| 382 | (I-1) | (II-1) | 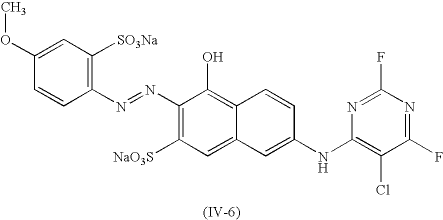 | 70:12:18 |
| 383 | (I-1) | (II-9) | 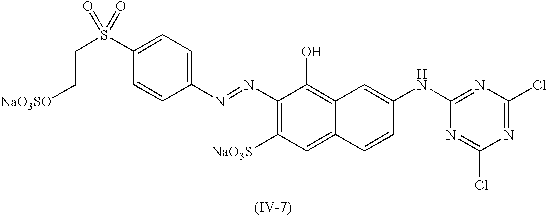 | 70:10:20 |
| 384 | (I-1) | (II-4) | 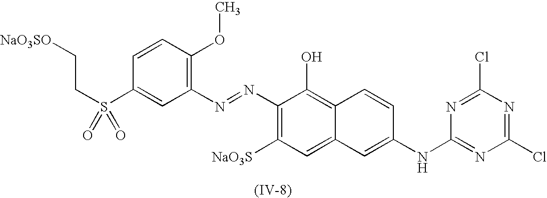 | 70:15:15 |
| 385 | (I-1) | (II-3) | 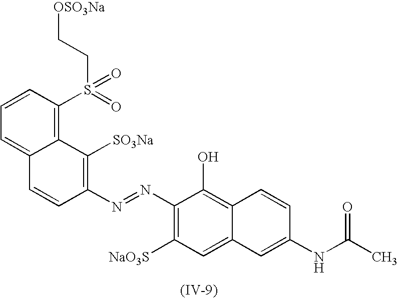 | 66:17:17 |
| 386 | (I-1) | (II-6) | 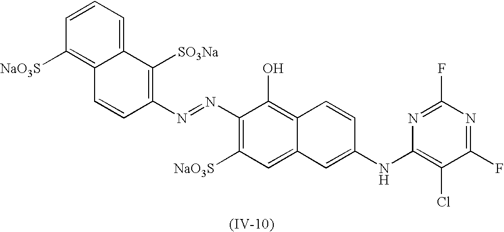 | 70:14:16 |
| 387 | (I-1) | (II-10) | 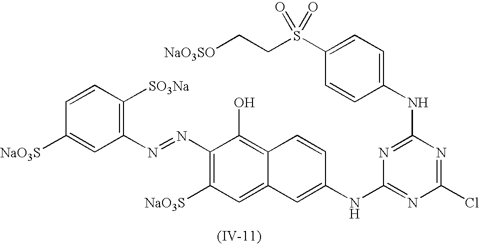 | 67:12:21 |
| 388 | (I-1) | (II-19) | 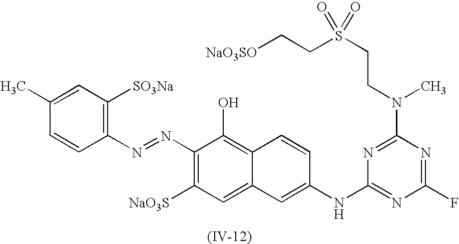 | 65:12:23 |
| 389 | (I-1) | (II-6) | 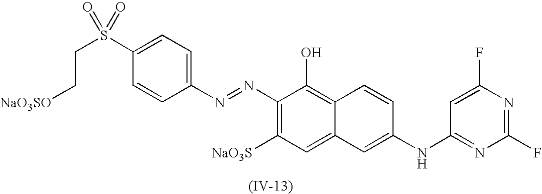 | 70:10:20 |
| 390 | (I-1) | (II-9) | 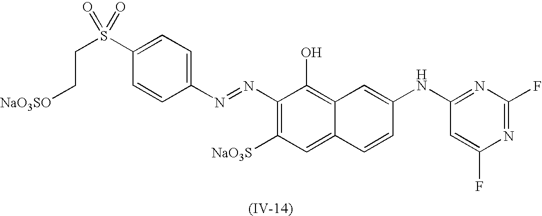 | 72:10:18 |
| 391 | (I-1) | (II-6) | 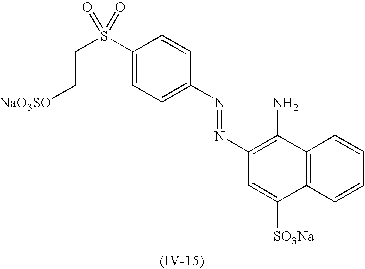 | 66:12:22 |
| 392 | (I-1) | (II-1) | 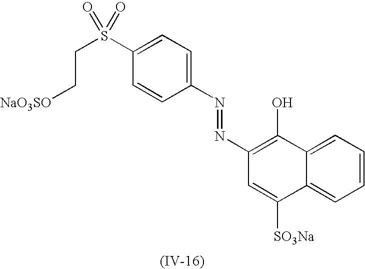 | 65:10:25 |
| 393 | (I-1) | (II-4) | 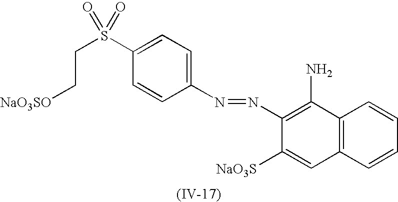 | 65:18:17 |
| 394 | (I-1) | (II-20) | 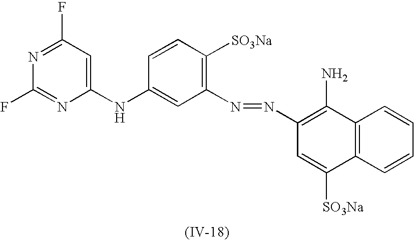 | 68:14:18 |
| 395 | (I-1) | (II-8) | 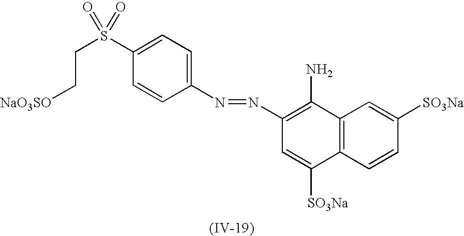 | 65:15:20 |
| 396 | (I-1) | (II-10) | 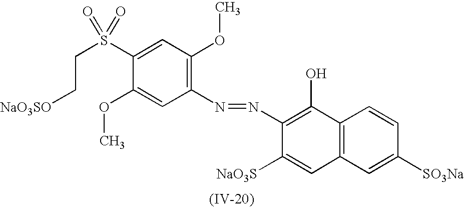 | 68:16:16 |
| 397 | (I-1) | (II-5) | 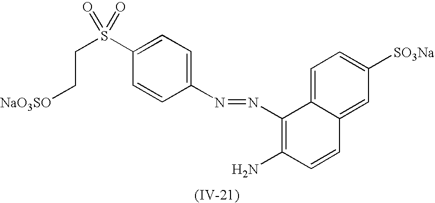 | 67:16:17 |
| 398 | (I-1) | (II-3) | 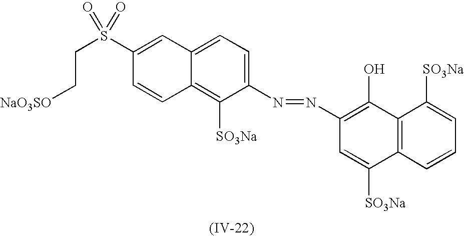 | 68:16:16 |
| 399 | (I-1) | (II-1) | 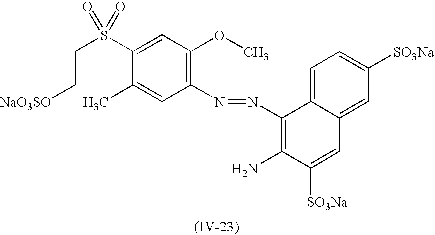 | 70:14:16 |
| 400 | (I-1) | (II-6) | 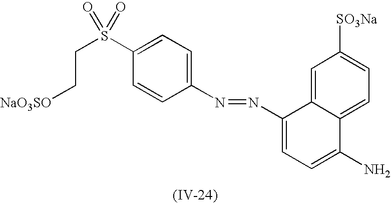 | 67:15:18 |
| 401 | (I-1) | (II-7) | 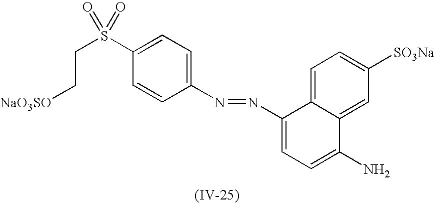 | 68:14:18 |
| 402 | (I-1) | (II-12) | 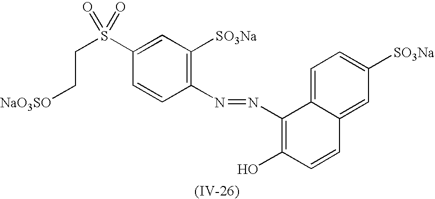 | 66:12:22 |
| 403 | (I-1) | (II-22) | 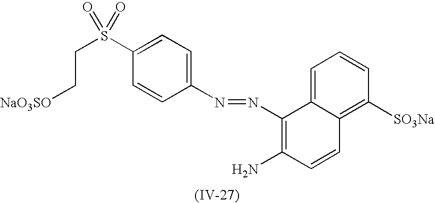 | 67:13:20 |
| 404 | (I-1) | (II-5) | 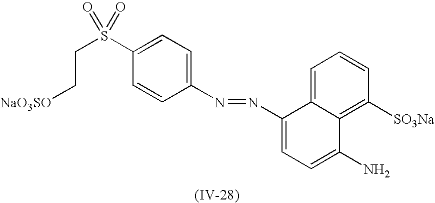 | 65:18:17 |
| 405 | (I-1) | (II-10) | 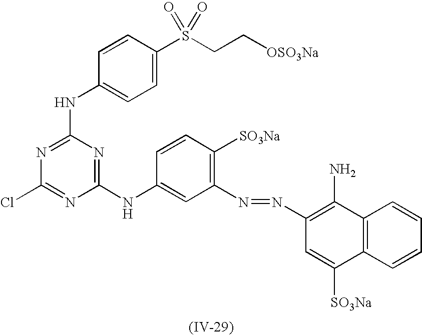 | 67:20:13 |
| 406 | (I-1) | (II-1) | (IV-1) | 72:10:18 |
| 407 | (I-1) | (II-4) | (IV-1) | 70:10:20 |
| 408 | (I-1) | (II-9) | (IV-1) | 74:10:16 |
| 409 | (I-1) | (II-4) | (IV-2) | 65:13:22 |
| 410 | (I-1) | (II-6) | (IV-2) | 67:10:23 |
| 411 | (I-1) | (II-9) | (IV-2) | 70:10:20 |
| 412 | (I-2) | (II-1) | (IV-1) | 67:13:20 |
| 413 | (I-2) | (II-3) | (IV-3) | 65:13:22 |
| 414 | (I-2) | (II-4) | (IV-2) | 65:17:18 |
| 415 | (I-2) | (II-6) | (IV-13) | 70:16:14 |
| 416 | (I-2) | (II-9) | (IV-15) | 70:12:18 |
| 417 | (I-2) | (II-10) | (IV-27) | 68:20:12 |
| 418 | (I-2) | (II-6) | (IV-4) | 68:16:16 |
| 419 | (I-2) | (II-9) | (IV-8) | 70:13:17 |
| 420 | (I-2) | (II-22) | (IV-7) | 67:10:23 |
| 421 | (I-3) | (II-1) | (IV-2) | 67:13:20 |
| 422 | (I-3) | (II-4) | (IV-1) | 67:13:18 |
| 423 | (I-3) | (II-6) | (IV-15) | 68:14:18 |
| 424 | (I-3) | (II-7) | (IV-13) | 70:15:15 |
| 425 | (I-3) | (II-9) | (IV-27) | 70:12:18 |
| 426 | (I-3) | (II-10) | (IV-3) | 68:10:22 |
| 427 | (I-4) | (II-1) | (IV-15) | 65:10:25 |
| 428 | (I-4) | (II-4) | (IV-3) | 68:10:22 |
| 429 | (I-4) | (II-5) | (IV-13) | 70:15:15 |
| 430 | (I-4) | (II-6) | (IV-2) | 68:12:20 |
| 431 | (I-4) | (II-7) | (IV-21) | 67:15:18 |
| 432 | (I-4) | (II-9) | (IV-1) | 70:12:18 |
| 433 | (I-4) | (II-10) | (IV-27) | 68:10:22 |
| 434 | (I-4) | (II-6) | (IV-7) | 65:12:23 |
| 435 | (I-4) | (II-22) | (IV-20) | 65:10:25 |
| 436 | (I-5) | (II-1) | (IV-3) | 66:10:24 |
| 437 | (I-5) | (II-2) | (IV-15) | 68:15:17 |
| 438 | (I-5) | (II-4) | (IV-2) | 70:10:20 |
| 439 | (I-5) | (II-6) | (IV-1) | 68:12:20 |
| 440 | (I-5) | (II-9) | (IV-21) | 65:10:25 |
| 441 | (I-5) | (II-10) | (IV-27) | 67:11:22 |
| 442 | (I-5) | (II-22) | (IV-23) | 65:15:20 |
| 443 | (I-6) | (II-1) | (IV-21) | 68:10:22 |
| 444 | (I-6) | (II-4) | (IV-2) | 68:12:20 |
| 445 | (I-6) | (II-6) | (IV-15) | 66:12:22 |
| 446 | (I-6) | (II-9) | (IV-1) | 70:14:16 |
| 447 | (I-6) | (II-10) | (IV-27) | 67:10:23 |
| 448 | (I-6) | (II-13) | (IV-13) | 67:15:18 |
| 449 | (I-6) | (II-14) | (IV-7) | 68:14:18 |
| 450 | (I-7) | (II-1) | (IV-1) | 67:13:20 |
| 451 | (I-7) | (II-4) | (IV-2) | 70:10:20 |
| 452 | (I-7) | (II-6) | (IV-15) | 68:12:20 |
| 453 | (I-7) | (II-9) | (IV-27) | 65:10:25 |
| 454 | (I-7) | (II-10) | (IV-1) | 67:18:15 |
| 455 | (I-7) | (II-18) | (IV-18) | 67:15:18 |
| 456 | (I-7) | (II-20) | (IV-29) | 65:15:20 |
| 457 | (I-8) | (II-1) | (IV-3) | 67:13:20 |
| 458 | (I-8) | (II-2) | (IV-13) | 70:15:15 |
| 459 | (I-8) | (II-4) | (IV-15) | 66:14:20 |
| 460 | (I-8) | (II-6) | (IV-1) | 70:13:17 |
| 461 | (I-8) | (II-9) | (IV-27) | 65:13:22 |
| 462 | (I-8) | (II-10) | (IV-2) | 68:12:20 |
| 463 | (I-9) | (II-1) | (IV-2) | 68:11:21 |
| 464 | (I-9) | (II-4) | (IV-15) | 70:10:20 |
| 465 | (I-9) | (II-6) | (IV-27) | 68:12:20 |
| 466 | (I-9) | (II-9) | (IV-1) | 70:12:18 |
| 467 | (I-9) | (II-10) | (IV-3) | 67:11:22 |
| 468 | (I-9) | (II-11) | (IV-13) | 67:18:15 |
| 469 | (I-10) | (II-1) | (IV-15) | 66:12:22 |
| 470 | (I-10) | (II-4) | (IV-27) | 68:12:20 |
| 471 | (I-10) | (II-6) | (IV-1) | 68:15:17 |
| 472 | (I-10) | (II-9) | (IV-2) | 70:12:18 |
| 473 | (I-10) | (II-17) | (IV-7) | 66:18:16 |
| 474 | (I-11) | (II-1) | (IV-21) | 68:12:20 |
| 475 | (I-11) | (II-4) | (IV-3) | 67:14:19 |
| 476 | (I-11) | (II-5) | (IV-13) | 70:15:15 |
| 477 | (I-11) | (II-6) | (IV-1) | 70:13:17 |
| 478 | (I-11) | (II-7) | (IV-27) | 67:15:18 |
| 479 | (I-11) | (II-9) | (IV-15) | 68:12:20 |
| 480 | (I-11) | (II-10) | (IV-2) | 70:10:20 |
| 481 | (I-12) | (II-1) | (IV-27) | 68:10:22 |
| 482 | (I-12) | (II-4) | (IV-3) | 66:12:22 |
| 483 | (I-12) | (II-6) | (IV-1) | 68:12:20 |
| 484 | (I-12) | (II-9) | (IV-15) | 68:14:18 |
| 485 | (I-12) | (II-10) | (IV-21) | 67:10:23 |
| 486 | (I-12) | (II-13) | (IV-7) | 67:15:18 |
| 487 | (I-12) | (II-14) | (IV-13) | 68:14:18 |
| 488 | (I-13) | (II-1) | (IV-2) | 68:12:20 |
| 489 | (I-13) | (II-4) | (IV-1) | 70:16:14 |
| 490 | (I-13) | (II-6) | (IV-27) | 68:12:20 |
| 491 | (I-13) | (II-9) | (IV-7) | 67:14:19 |
| 492 | (I-13) | (II-10) | (IV-15) | 68:10:22 |
| 493 | (I-13) | (II-15) | (IV-29) | 67:16:17 |
| 494 | (I-14) | (II-1) | (IV-27) | 70:10:20 |
| 495 | (I-14) | (II-4) | (IV-2) | 70:15:15 |
| 496 | (I-14) | (II-6) | (IV-7) | 72:12:16 |
| 497 | (I-14) | (II-9) | (IV-15) | 66:14:20 |
| 498 | (I-14) | (II-10) | (IV-1) | 73:12:15 |
| 499 | (I-14) | (II-16) | (IV-3) | 68:17:15 |
| 500 | (I-15) | (II-1) | (IV-7) | 68:14:18 |
| 501 | (I-15) | (II-4) | (IV-15) | 68:10:22 |
| 502 | (I-15) | (II-6) | (IV-2) | 68:12:20 |
| 503 | (I-15) | (II-8) | (IV-9) | 72:14:14 |
| 504 | (I-15) | (II-9) | (IV-1) | 70:16:14 |
| 505 | (I-15) | (II-10) | (IV-27) | 70:10:20 |
| 506 | (I-16) | (II-1) | (IV-1) | 71:14:15 |
| 507 | (I-16) | (II-4) | (IV-2) | 70:10:20 |
| 508 | (I-16) | (II-6) | (IV-15) | 68:12:20 |
| 509 | (I-16) | (II-9) | (IV-27) | 67:10:23 |
| 510 | (I-16) | (II-10) | (IV-7) | 68:17:15 |
| 511 | (I-16) | (II-19) | (IV-18) | 67:15:18 |
| 512 | (I-16) | (II-20) | (IV-13) | 70:15:15 |
| 513 | (I-17) | (II-1) | (IV-1) | 70:13:17 |
| 514 | (I-17) | (II-4) | (IV-2) | 68:12:20 |
| 515 | (I-17) | (II-6) | (IV-15) | 66:12:22 |
| 516 | (I-17) | (II-9) | (IV-8) | 72:11:17 |
| 517 | (I-17) | (II-10) | (IV-7) | 70:12:18 |
| 518 | (I-17) | (II-19) | (IV-13) | 69:15:16 |
| 519 | (I-17) | (II-20) | (IV-14) | 67:14:19 |
| 520 | (I-18) | (II-1) | (IV-2) | 67:13:20 |
| 521 | (I-18) | (II-4) | (IV-1) | 72:12:16 |
| 522 | (I-18) | (II-6) | (IV-27) | 68:12:20 |
| 523 | (I-18) | (II-9) | (IV-15) | 68:10:22 |
| 524 | (I-18) | (II-10) | (IV-7) | 68:13:19 |
| 525 | (I-18) | (II-20) | (IV-18) | 67:15:18 |
| 526 | (I-18) | (II-21) | (IV-13) | 69:17:14 |
| 527 | (I-19) | (II-1) | (IV-15) | 68:14:18 |
| 528 | (I-19) | (II-4) | (IV-2) | 70:10:20 |
| 529 | (I-19) | (II-6) | (IV-1) | 70:14:16 |
| 530 | (I-19) | (II-9) | (IV-27) | 67:11:22 |
| 531 | (I-19) | (II-10) | (IV-21) | 65:16:19 |
| 532 | (I-19) | (II-23) | (IV-7) | 67:18:15 |
| 533 | (I-20) | (II-1) | (IV-21) | 66:13:21 |
| 534 | (I-20) | (II-4) | (IV-1) | 75:10:15 |
| 535 | (I-20) | (II-6) | (IV-15) | 67:14:19 |
| 536 | (I-20) | (II-9) | (IV-2) | 69:11:20 |
| 537 | (I-20) | (II-10) | (IV-7) | 68:16:16 |
| 538 | (I-20) | (II-23) | (IV-27) | 65:17:18 |
| 539 | (I-21) | (II-1) | (IV-2) | 67:13:20 |
| 540 | (I-21) | (II-2) | (IV-1) | 71:14:15 |
| 541 | (I-21) | (II-4) | (IV-15) | 67:13:20 |
| 542 | (I-21) | (II-6) | (IV-7) | 68:14:18 |
| 543 | (I-21) | (II-9) | (IV-27) | 68:12:20 |
| 544 | (I-21) | (II-10) | (IV-3) | 70:10:20 |

Dye mixtures according to example 5

| | Dye of | Dye of | Dye of | Dye of | Ratio |
|---|---|---|---|---|---|
| Example | formula (I) | formula (II) | formula (III) | formula (IV) | (I):(II):(III):(IV) |
| 545 | (I-1) | (II-6) | (III-6) | (IV-1) | 68:10:12:10 |
| 546 | (I-1) | (II-9) | (III-2) | (IV-2) | 65:10:13:12 |
| 547 | (I-1) | (II-4) | (III-3) | (IV-3) | 66:11:12:11 |
| 548 | (I-1) | (II-1) | (III-5) | (IV-15) | 64:11:12:13 |
| 549 | (I-1) | (II-10) | (III-7) | (IV-4) | 68:15:12:5 |
| 550 | (I-1) | (II-9) | (III-1) | (IV-7) | 66:11:13:10 |
| 551 | (I-1) | (II-22) | (III-9) | (IV-8) | 67:12:13:8 |
| 552 | (I-1) | (II-1) | (III-12) | (IV-13) | 67:11:10:12 |
| 553 | (I-1) | (II-6) | (III-16) | (IV-5) | 65:10:13:12 |
| 554 | (I-1) | (II-4) | (III-32) | (IV-27) | 66:10:12:12 |
| 555 | (I-1) | (II-6) | (III-37) | (IV-16) | 66:11:13:10 |
| 556 | (I-1) | (II-9) | (III-41) | (IV-21) | 62:8:15:15 |
| 557 | (I-2) | (II-6) | (III-2) | (IV-1) | 67:10:15:8 |
| 558 | (I-3) | (II-1) | (III-5) | (IV-2) | 66:10:14:10 |
| 559 | (I-4) | (II-9) | (III-9) | (IV-1) | 67:10:14:9 |
| 560 | (I-8) | (II-2) | (III-32) | (IV-15) | 68:10:12:10 |
| 561 | (I-9) | (II-4) | (III-2) | (IV-1) | 67:10:15:8 |
| 562 | (I-21) | (II-9) | (III-3) | (IV-2) | 65:10:14:11 |

| | Dye of | Dye of | Dye | Ratio |
|---|---|---|---|---|
| Example | formula (I) | formula (II) | of formula (III) | (I):(II):(III) |
| 563 | (I-1) | (II-1) | (III-1) | 69:13:18 |
| 564 | (I-1) | (II-4) | (III-1) | 65:15:20 |
| 565 | (I-1) | (II-9) | (III-1) | 70:12:18 |
| 566 | (I-1) | (II-22) | (III-1) | 64:18:18 |
| 567 | (I-1) | (II-24) | (III-1) | 69:14:17 |
| 568 | (I-1) | (II-25) | (III-1) | 65:16:19 |
| 569 | (I-1) | (II-26) | (III-1) | 66:14:20 |

| | Dye of | Dye | Dye | Ratio |
|---|---|---|---|---|
| Example | formula (I) | of formula (II) | of formula (III) | (I):(II):(III) |
| 570 | (I-1) | (II-4) | (III-2) | 67:15:18 |
| 571 | (I-1) | (II-6) | (III-2) | 66:14:20 |
| 572 | (I-1) | (II-9) | (III-2) | 68:12:20 |
| 573 | (I-1) | (II-1) | (III-3) | 66:15:19 |
| 574 | (I-1) | (II-4) | (III-3) | 65:15:20 |
| 575 | (I-1) | (II-6) | (III-3) | 68:12:20 |
| 576 | (I-1) | (II-9) | (III-3) | 67:15:18 |
| 577 | (I-1) | (II-1) | (III-12) | 70:15:15 |
| 578 | (I-1) | (II-4) | (III-13) | 67:13:20 |
| 579 | (I-1) | (II-6) | (III-15) | 68:14:18 |
| 580 | (I-1) | (II-9) | (III-27) | 66:17:17 |
| 581 | (I-1) | (II-22) | (III-39) | 66:16:18 |
| 582 | (I-1) | (II-24) | (III-15) | 65:15:20 |
| 583 | (I-1) | (II-25) | (III-2) | 67:14:19 |
| 584 | (I-1) | (II-26) | (III-3) | 68:15:17 |
| 585 | (I-4) | (II-5) | (III-8) | 72:11:17 |
| 586 | (I-4) | (II-7) | (III-8) | 70:12:18 |
| 587 | (I-4) | (II-10) | (III-8) | 73:12:15 |
| 588 | (I-4) | (II-5) | (III-43) | 72:12:16 |
| 589 | (I-4) | (II-7) | (III-43) | 71:12:17 |
| 590 | (I-4) | (II-10) | (III-43) | 72:13:15 |

Dye mixtures according to example 8

| | Dye of | Dye | Dye | Ratio |
|---|---|---|---|---|
| Example | formula (I) | of formula (II) | of formula (IV) | (I):(II):(IV) |
| 591 | (I-1) | (II-1) | (IV-7) | 66:16:18 |
| 592 | (I-1) | (II-4) | (IV-15) | 66:12:22 |
| 593 | (I-1) | (II-6) | (IV-2) | 67:13:20 |
| 594 | (I-1) | (II-9) | (IV-1) | 72:13:15 |
| 595 | (I-1) | (II-22) | (IV-13) | 71:15:14 |
| 596 | (I-1) | (II-24) | (IV-27) | 66:14:20 |
| 597 | (I-1) | (II-25) | (IV-3) | 67:12:21 |
| 598 | (I-1) | (II-26) | (IV-14) | 70:15:15 |
| 599 | (I-1) | (II-1) | (IV-5) | 71:14:15 |
| 600 | (I-1) | (II-4) | (IV-16) | 65:15:20 |
| 601 | (I-1) | (II-6) | (IV-17) | 67:11:22 |
| 602 | (I-1) | (II-9) | (IV-21) | 67:13:20 |
| 603 | (I-1) | (II-22) | (IV-19) | 66:16:18 |
| 604 | (I-1) | (II-24) | (IV-24) | 66:12:22 |
| 605 | (I-1) | (II-25) | (IV-25) | 67:13:20 |
| 606 | (I-1) | (II-26) | (IV-28) | 65:15:20 |
| 607 | (I-1) | (II-1) | (IV-1) | 67:15:18 |
| 608 | (I-1) | (II-6) | (IV-1) | 70:13:17 |
| 609 | (I-1) | (II-9) | (IV-1) | 71:11:18 |
| 610 | (I-1) | (II-4) | (IV-2) | 65:15:20 |
| 611 | (I-1) | (II-6) | (IV-2) | 66:12:22 |
| 612 | (I-1) | (II-1) | (IV-15) | 65:13:22 |
| 613 | (I-1) | (II-6) | (IV-15) | 66:14:20 |
| 614 | (I-1) | (II-9) | (IV-15) | 68:13:19 |
| 615 | (I-4) | (II-5) | (IV-20) | 68:13:19 |
| 616 | (I-4) | (II-7) | (IV-20) | 70:12:18 |
| 617 | (I-4) | (II-10) | (IV-20) | 70:15:15 |

Dye mixtures according to example 9

| | Dye of | Dye of | |
|---|---|---|---|
| Example | formula (I) | formula (II) | Ratio (I):(II) |
| 618 | (I-1) | (II-1) | 68:32 |
| 619 | (I-1) | (II-6) | 70:30 |
| 620 | (I-1) | (II-9) | 73:27 |
| 621 | (I-1) | (II-22) | 67:33 |
| 622 | (I-1) | (II-24) | 69:31 |
| 623 | (I-1) | (II-25) | 65:35 |
| 624 | (I-1) | (II-26) | 66:34 |
| 625 | (I-4) | (II-5) | 69:31 |
| 626 | (I-4) | (II-7) | 67:33 |
| 627 | (I-4) | (II-10) | 70:30 |

Dye mixtures according to example 10

| | Dye of | | | |
|---|---|---|---|---|
| | formula | Dye of | Dye of | Ratio |
| Example | (I) | formula (II-x) | formula (II-y) | (I):(II-x):(II-y) |
| 628 | (I-1) | (II-1) | (II-4) | 66:18:16 |
| 629 | (I-1) | (II-1) | (II-6) | 68:15:17 |
| 630 | (I-1) | (II-1) | (II-22) | 65:20:15 |
| 631 | (I-1) | (II-1) | (II-26) | 66:17:17 |
| 632 | (I-1) | (II-4) | (II-6) | 67:14:19 |
| 633 | (I-1) | (II-4) | (II-9) | 68:12:20 |
| 634 | (I-1) | (II-4) | (II-22) | 65:19:16 |
| 635 | (I-1) | (II-4) | (II-24) | 66:24:10 |
| 636 | (I-1) | (II-6) | (II-9) | 70:15:15 |
| 637 | (I-1) | (II-6) | (II-22) | 66:20:14 |
| 638 | (I-1) | (II-6) | (II-25) | 68:18:14 |
| 639 | (I-1) | (II-9) | (II-22) | 68:20:12 |
| 640 | (I-1) | (II-9) | (II-26) | 67:18:15 |
| 641 | (I-1) | (II-22) | (II-25) | 66:17:17 |
| 642 | (I-1) | (II-25) | (II-26) | 65:15:20 |
| 643 | (I-4) | (II-5) | (II-7) | 68:16:16 |
| 644 | (I-4) | (II-5) | (II-10) | 66:14:20 |
| 645 | (I-4) | (II-7) | (II-10) | 68:14:18 |

Dye mixtures according to example 11

| | Dye of | Dye of | |
|---|---|---|---|
| Example | formula (I) | formula (II) | Ratio (I):(II) |
| 646 | (I-3) | (II-5) | 68:32 |
| 647 | (I-3) | (II-7) | 70:30 |
| 648 | (I-3) | (II-10) | 73:27 |
| 649 | (I-6) | (II-14) | 67:33 |
| 650 | (I-7) | (II-18) | 68:32 |
| 651 | (I-7) | (II-19) | 70:30 |
| 652 | (I-8) | (II-2) | 66:34 |
| 653 | (I-9) | (II-11) | 65:35 |
| 654 | (I-10) | (II-17) | 63:37 |
| 655 | (I-12) | (II-13) | 67:33 |
| 656 | (I-13) | (II-15) | 68:32 |
| 657 | (I-14) | (II-16) | 62:38 |
| 658 | (I-15) | (II-8) | 69:31 |
| 659 | (I-16) | (II-20) | 66:34 |
| 660 | (I-18) | (II-21) | 65:35 |

Dye mixtures according to example 12

| | Dye of | | | |
|---|---|---|---|---|
| | formula | Dye of | Dye of | Ratio |
| Example | (I) | formula (II-x) | formula (II-y) | (I):(II-x):(II-y) |
| 661 | (I-1) | (II-1) | (II-2) | 66:18:16 |
| 662 | (I-1) | (II-1) | (II-18) | 66:22:12 |
| 663 | (I-1) | (II-2) | (II-3) | 70:20:10 |
| 664 | (I-1) | (II-4) | (II-5) | 66:17:17 |
| 665 | (I-1) | (II-6) | (II-7) | 68:15:17 |
| 666 | (I-1) | (II-6) | (II-8) | 68:17:15 |
| 667 | (I-1) | (II-6) | (II-20) | 67:20:13 |
| 668 | (I-1) | (II-6) | (II-21) | 66:19:15 |
| 669 | (I-1) | (II-7) | (II-8) | 68:16:16 |
| 670 | (I-1) | (II-7) | (II-20) | 67:18:15 |
| 671 | (I-1) | (II-9) | (II-10) | 68:14:18 |
| 672 | (I-1) | (II-9) | (II-11) | 68:20:12 |
| 673 | (I-1) | (II-9) | (II-12) | 67:20:13 |
| 674 | (I-1) | (II-9) | (II-19) | 68:22:10 |
| 675 | (I-1) | (II-10) | (II-11) | 68:17:15 |
| 676 | (I-1) | (II-10) | (II-12) | 66:20:14 |
| 677 | (I-1) | (II-10) | (II-19) | 67:19:14 |
| 678 | (I-1) | (II-11) | (II-12) | 68:16:16 |
| 679 | (I-1) | (II-13) | (II-9) | 66:17:17 |
| 680 | (I-1) | (II-13) | (II-10) | 70:16:14 |
| 681 | (I-1) | (II-13) | (II-12) | 72:16:12 |
| 682 | (I-1) | (II-13) | (II-19) | 70:20:10 |
| 683 | (I-1) | (II-14) | (II-24) | 68:12:20 |
| 684 | (I-1) | (II-15) | (II-16) | 64:22:14 |
| 685 | (I-1) | (II-15) | (II-25) | 67:13:20 |
| 686 | (I-1) | (II-16) | (II-25) | 68:12:20 |
| 687 | (I-1) | (II-17) | (II-26) | 66:14:20 |
| 688 | (I-1) | (II-22) | (II-23) | 60:20:20 |

Dye mixtures according to example 13

| | Dye of | Dye | Dye | Ratio |
|---|---|---|---|---|
| Example | formula (I) | of formula (II) | of formula (III) | (I):(II):(III) |
| 689 | (I-3) | (II-7) | (III-43) | 70:15:15 |
| 690 | (I-3) | (II-10) | (III-43) | 70:18:12 |
| 691 | (I-9) | (II-11) | (III-11) | 68:12:20 |
| 692 | (I-9) | (II-11) | (III-31) | 67:15:18 |
| 693 | (I-14) | (II-16) | (III-25) | 68:15:17 |
| 694 | (I-18) | (II-21) | (III-20) | 70:12:18 |
| 695 | (I-21) | (II-2) | (III-6) | 68:15:17 |
| 696 | (I-21) | (II-2) | (III-10) | 73:15:12 |
| 697 | (I-21) | (II-2) | (III-32) | 70:15:15 |

Dye mixtures according to example 14

| | Dye of | Dye of | Dye of | Dye of | Ratio |
|---|---|---|---|---|---|
| Example | formula (I-x) | formula (I-y) | formula (II) | formula (III) | (I-x):(I-y):(II):(III) |
| 698 | (I-1) | (I-2) | (II-9) | (III-2) | 45:25:12:18 |
| 699 | (I-1) | (I-3) | (II-4) | (III-5) | 50:20:14:16 |
| 700 | (I-1) | (I-4) | (II-6) | (III-6) | 47:24:14:15 |
| 701 | (I-1) | (I-5) | (II-1) | (III-1) | 50:15:15:20 |
| 702 | (I-1) | (I-6) | (II-14) | (III-7) | 25:45:13:17 |
| 703 | (I-1) | (I-7) | (II-4) | (III-16) | 40:27:16:17 |
| 704 | (I-1) | (I-8) | (II-9) | (III-3) | 42:28:12:18 |
| 705 | (I-1) | (I-9) | (II-6) | (III-2) | 44:24:12:20 |
| 706 | (I-1) | (I-10) | (II-22) | (III-41) | 44:20:14:22 |
| 707 | (I-1) | (I-11) | (II-10) | (III-9) | 45:25:12:18 |
| 708 | (I-1) | (I-12) | (II-13) | (III-1) | 23:45:12:20 |
| 709 | (I-1) | (I-13) | (II-1) | (III-3) | 45:22:15:18 |
| 710 | (I-1) | (I-14) | (II-4) | (III-5) | 45:25:14:16 |
| 711 | (I-1) | (I-15) | (II-9) | (III-32) | 50:20:15:15 |
| 712 | (I-1) | (I-16) | (II-20) | (III-2) | 43:25:14:18 |
| 713 | (I-1) | (I-17) | (II-18) | (III-4) | 55:12:13:20 |
| 714 | (I-1) | (I-18) | (II-7) | (III-9) | 48:20:12:20 |
| 715 | (I-1) | (I-19) | (II-22) | (III-41) | 35:30:15:20 |
| 716 | (I-1) | (I-20) | (II-9) | (III-2) | 31:36:14:19 |
| 717 | (I-1) | (I-21) | (II-6) | (III-6) | 35:35:15:15 |
| 718 | (I-2) | (I-3) | (II-1) | (III-5) | 45:25:10:20 |
| 719 | (I-2) | (I-4) | (II-9) | (III-2) | 50:20:10:20 |
| 720 | (I-3) | (I-4) | (II-10) | (III-32) | 45:27:10:18 |
| 721 | (I-3) | (I-11) | (II-4) | (III-9) | 50:20:11:19 |
| 722 | (I-4) | (I-11) | (II-7) | (III-3) | 46:22:12:20 |

Dye mixtures according to example 15

| | Dye of | Dye | Dye | Ratio |
|---|---|---|---|---|
| Example | formula (I) | of formula (II) | of formula (III) | (I):(II):(III) |
| 723 | (I-2) | (II-1) | (III-1) | 67:15:18 |
| 724 | (I-3) | (II-4) | (III-1) | 68:16:16 |
| 725 | (I-4) | (II-6) | (III-1) | 70:13:17 |
| 726 | (I-9) | (II-9) | (III-1) | 68:14:18 |
| 727 | (I-8) | (II-22) | (III-1) | 67:15:18 |
| 728 | (I-7) | (II-24) | (III-1) | 68:15:17 |
| 729 | (I-5) | (II-25) | (III-1) | 70:12:18 |
| 730 | (I-11) | (II-26) | (III-1) | 68:15:17 |
| 731 | (I-6) | (II-4) | (III-7) | 67:13:20 |
| 732 | (I-12) | (II-6) | (III-7) | 68:12:20 |
| 733 | (I-16) | (II-9) | (III-7) | 66:14:20 |
| 734 | (I-13) | (II-22) | (III-7) | 67:18:15 |
| 735 | (I-14) | (II-24) | (III-7) | 68:17:15 |
| 736 | (I-15) | (II-25) | (III-7) | 70:15:15 |
| 737 | (I-10) | (II-26) | (III-7) | 68:15:17 |
| 738 | (I-17) | (II-1) | (III-1) | 70:14:16 |
| 739 | (I-18) | (II-4) | (III-1) | 66:18:16 |
| 740 | (I-19) | (II-6) | (III-1) | 70:13:17 |
| 741 | (I-20) | (II-9) | (III-1) | 68:16:16 |
| 742 | (I-21) | (II-6) | (III-1) | 70:12:18 |

Dye mixtures according to example 16

| | Dye of | Dye of | Dye of | |
|---|---|---|---|---|
| Example | formula (I) | formula (II) | formula (IV) | Ratio (I):(II):(IV) |
| 743 | (I-2) | (II-6) | (IV-1) | 68:15:17 |
| 744 | (I-3) | (II-9) | (IV-2) | 67:13:20 |
| 745 | (I-4) | (II-1) | (IV-3) | 70:10:20 |
| 746 | (I-5) | (II-3) | (IV-4) | 68:14:18 |
| 747 | (I-6) | (II-22) | (IV-5) | 69:13:18 |
| 748 | (I-8) | (II-4) | (IV-7) | 70:12:18 |
| 749 | (I-16) | (II-3) | (IV-8) | 67:15:18 |
| 750 | (I-21) | (II-6) | (IV-13) | 72:15:13 |
| 751 | (I-11) | (II-1) | (IV-14) | 70:15:15 |
| 752 | (I-2) | (II-9) | (IV-15) | 65:15:20 |
| 753 | (I-10) | (II-24) | (IV-16) | 70:16:14 |
| 754 | (I-14) | (II-25) | (IV-17) | 68:12:20 |
| 755 | (I-7) | (II-18) | (IV-18) | 67:15:18 |
| 756 | (I-18) | (II-26) | (IV-19) | 68:15:17 |
| 757 | (I-3) | (II-5) | (IV-20) | 70:12:18 |
| 758 | (I-4) | (II-7) | (IV-20) | 70:12:18 |
| 759 | (I-2) | (II-10) | (IV-20) | 67:14:19 |
| 760 | (I-4) | (II-6) | (IV-21) | 66:14:20 |
| 761 | (I-15) | (II-8) | (IV-22) | 70:12:18 |
| 762 | (I-2) | (II-2) | (IV-23) | 70:15:15 |
| 763 | (I-12) | (II-1) | (IV-24) | 66:14:20 |
| 764 | (I-19) | (II-4) | (IV-25) | 67:16:17 |
| 765 | (I-13) | (II-11) | (IV-26) | 70:12:18 |
| 766 | (I-9) | (II-9) | (IV-27) | 67:15:18 |
| 767 | (I-17) | (II-22) | (IV-28) | 66:15:19 |
| 768 | (I-20) | (II-23) | (IV-29) | 70:12:18 |

### USE EXAMPLE 1

2 parts of a dye mixture obtained as per example 1-16 and 50 parts of sodium chloride are dissolved in 999 parts of water and 5 parts of sodium carbonate, 0.7 part of sodium hydroxide (in the form of a 32.5% strength aqueous solution) and, where appropriate, 1 part of a wetting agent are added. This dye bath is entered with 100 g of a woven cotton fabric. The temperature of the dye bath is initially maintained at 25° C. for 10 minutes, then raised to the final temperature (40-80° C.) over 30 minutes and maintained at this temperature for a further 60-90 minutes. Thereafter the dyed fabric is initially rinsed with tap water for 2 minutes and then with deionized water for 5 minutes. The dyed fabric is neutralized at 40° C. in 1000 parts of an aqueous solution containing 1 part of 50% strength acetic acid for 10 minutes. It is rinsed again with deionized water at 70° C. and then soaped off at the boil with a laundry detergent for 15 minutes, rinsed once more and dried. This gives a strong navy to gray dyeing having very good fastness properties.

### USE EXAMPLE 2

6 parts of a dye mixture obtained as per example 1-16 and 50 parts of sodium chloride are dissolved in 998 parts of water and 7 parts of sodium carbonate, 2 parts of sodium hydroxide (in the form of a 32.5% strength aqueous solution) and, where appropriate, 1 part of a wetting agent are added. This dye bath is entered with 100 g of a woven cotton fabric. Subsequent processing takes place as reported in use example 1. This gives a deep-black dyeing having very good fastness properties.

### USE EXAMPLE 3

2 parts of a dye mixture obtained as per example 15, 76, 114, 115, 284, 285, 320, 321, 448, 449, 486, 487, 649, 655, 731, 732 or 747 are dissolved in 999 parts of water and 5 parts of sodium carbonate, 0.7 part of sodium hydroxide (in the form of a 32.5% strength aqueous solution) and, where appropriate, 1 part of a wetting agent are added. This dye bath is entered with 100 g of a woven cotton fabric. Subsequent processing takes place as reported in use example 1. This gives a strong navy to gray dyeing having very good fastness properties.

### USE EXAMPLE 4

4 parts of a dye mixture obtained as per example 15, 76, 114, 115, 284, 285, 320, 321, 448, 449, 486, 487, 649, 655, 731, 732 or 747 and 5 parts of sodium chloride are dissolved in 999 parts of water, 7 parts of sodium carbonate, 0.7 part of sodium hydroxide (in the form of a 32.5% strength aqueous solution) and, where appropriate, 1 part of a wetting agent are added. This dye bath is entered with 100 g of a woven cotton fabric. Subsequent processing takes place as reported in use example 1. This gives a strong gray-blue to black dyeing having very good fastness properties.

### USE EXAMPLE 5

8 parts of a dye mixture obtained as per example 15, 76, 114, 115, 284, 285, 320, 321, 448, 449, 486, 487, 649, 655, 731, 732 or 747 and 10 parts of sodium chloride are dissolved in 997 parts of water, 10 parts of sodium carbonate, 1.3 parts of sodium hydroxide (in the form of a 32.5% strength aqueous solution) and, where appropriate, 1 part of a wetting agent are added. This dye bath is entered with 100 g of a woven cotton fabric. Subsequent processing takes place as reported in use example 1. This gives a deep-black dyeing having very good fastness properties.

### USE EXAMPLE 6

A textile fabric consisting of mercerized cotton is padded with a liquor containing 35 g/l of calcined sodium carbonate, 100 g/l of urea and 150 g/l of a low-viscosity sodium alginate solution (6%) and then dried. The liquor pickup is 70%.

The textile thus pretreated is printed with an aqueous ink containing

2% of the dye of one of examples 1 to 16

20% of sulfolane

0.01% of Mergal K9N and

77.99% of water

using a drop-on-demand (bubble jet) ink jet print head. The print is fully dried. It is fixed by means of saturated steam at 102° C. for 8 minutes. Subsequently the print is rinsed warm, subjected to a fastness wash with hot water at 95° C., rinsed warm and then dried. This gives a gray print having outstanding service fastness properties.

### USE EXAMPLE 7

A textile fabric consisting of mercerized cotton is padded with a liquor containing 35 g/l of cabined sodium carbonate, 50 g/l of urea and 150 g/l of a low-viscosity sodium alginate solution (6%) and then dried. The liquor pickup is 70%. The textile thus pretreated is printed with an aqueous ink containing

8% of the dye of one of examples 1 to 16

20% of 1,2-propanediol

0.01% of Mergal K9N and

71.99% of water

using a drop-on-demand (bubble jet) ink jet print head. The print is fully dried. It is fixed by means of saturated steam at 102° C. for 8 minutes. Subsequently the print is rinsed warm, subjected to a fastness wash with hot water at 95° C. rinsed warm and then dried. This gives a black print having outstanding service fastness properties.

### USE EXAMPLE 8

A textile fabric consisting of mercerized cotton is padded with a liquor containing 35 g/l of calcined sodium carbonate, 100 g/l of urea and 150 g/l of a low-viscosity sodium alginate solution (6%) and then dried. The liquor pickup is 70%. The textile thus pretreated is printed with an aqueous ink containing

8% of the dye of one of examples 1 to 16

15% of N-methylpyrrolidone

0.01% of Mergal K9N and

76.99% of water

using a drop-on-demand (bubble jet) ink jet print head. The print is fully dried. It is fixed by means of saturated steam at 102° C. for 8 minutes. Subsequently the print is rinsed warm, subjected to a fastness wash with hot water at 95° C., rinsed warm and then dried. This gives a black print having outstanding service fastness properties.

1-23. (canceled)

24. A dye mixture which comprises one or more dyes of the formula (I), 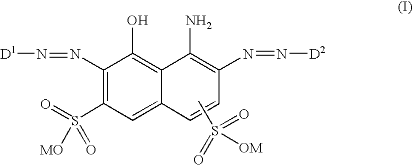
one or more dyes of the formula (II) 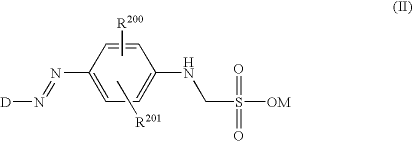
and optionally one or more dyes of the formula (III) 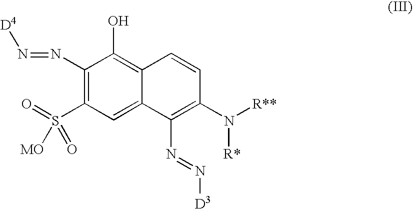
and optionally one or more dyes of the formula (IV) 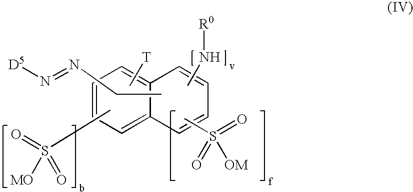
in which:
D, D¹, D², D³, D⁴ and D⁵ are independently of one another a group of the formula (1) 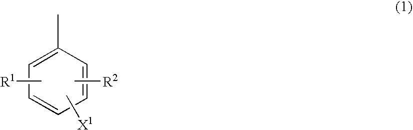
in which
R¹ and R² independently of one another are hydrogen, (C₁-C₄)-alkyl, (C₁-C₄)-alkoxy, hydroxyl, sulfo, carboxyl, cyano, nitro, amido, ureido or halogen, and
X¹ is hydrogen or a group of the formula —SO₂-Z,
where
Z is —CH=CH₂, —CH₂CH₂Z¹ or hydroxyl,
in which
Z¹ is hydroxyl or a group which can be eliminated under the action of alkali, or
D, D¹, D², D³, D⁴ and D⁵ are independently of one another a naphthyl group of the formula (2) 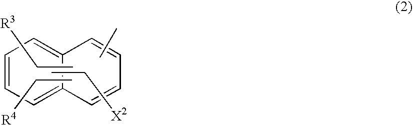
in which
R³ and R⁴ independently of one another are hydrogen, (C₁-C₄)-alkyl, (C₁-C₄)-alkoxy, hydroxyl, sulfo, carboxyl, cyano, nitro, amido, ureido or halogen; and
X² has one of the definitions of X¹; or
D, D¹, D², D³, D⁴ and D⁵ are independently of one another a group of the formula (3) 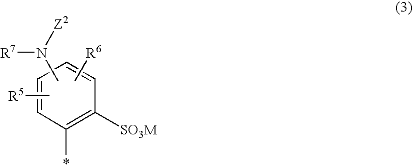
in which
R⁵ and R⁶ independently of one another have one of the definitions of R¹ and R²,
R⁷ is hydrogen, (C₁-C₄)-alkyl, or phenyl which is unsubstituted or substituted by (C₁-C₄)-alkyl, (C₁-C₄)-alkoxy, sulfo, halogen or carboxyl, and
Z² is a group of the formula (4) or (5) or (6) 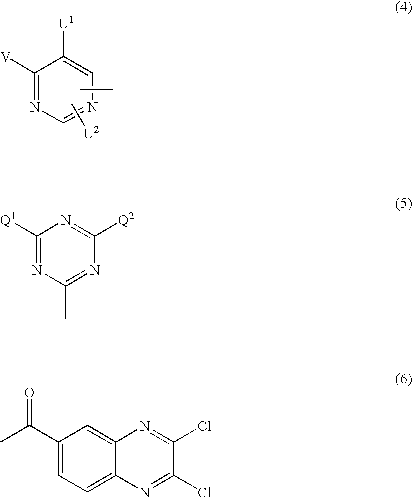
in which
V is fluorine or chlorine,
U¹ and U² independently of one another are fluorine, chlorine or hydrogen, and
Q¹ and Q² independently of one another are chlorine, fluorine, cyanamide, hydroxyl, (C₁-C₆)-alkoxy, phenoxy, sulfophenoxy, mercapto, (C₁ -C₆)-alkylmercapto, pyridino, carboxypyridino, carbamoylpyridino or a group of the formula (7) or (8) 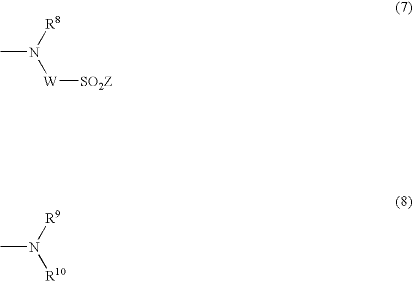
in which
R⁸ is hydrogen or (C₁-C₆)-alkyl, sulfo-(C₁-C₆)-alkyl or phenyl which is unsubstituted or substituted by (C₁-C₄)-alkyl, (C₁-C₄)-alkoxy, sulfo, halogen, carboxyl, acetamido or ureido;
R⁹ and R¹⁰ have independently of one another one of the definitions of R⁸, or form a cyclic ring system of the formula —(CH₂)ⱼ— where j is 4 or 5, or alternatively
—(CH₂)₂-E-(CH₂)₂—, where E is oxygen, sulfur, sulfonyl or —NR¹¹ with R¹¹ ═(C₁-C₆)-alkyl;
W is phenylene which is unsubstituted or substituted by 1 or 2 substituents, such as (C₁-C₄)-alkyl, (C₁-C₄)-alkoxy, carboxyl, sulfo, chlorine or bromine, or is (C₁-C₄)-alkylene-arylene or (C₂-C₆)-alkylene which may be interrupted by oxygen, sulfur, sulfonyl, amino, carbonyl or carboxamido, or is phenylene-CONH-phenylene which is unsubstituted or substituted by (C₁-C₄)-alkyl, (C₁-C₄)-alkoxy, hydroxyl, sulfo, carboxyl, amido, ureido or halogen, or is naphthylene which is unsubstituted or substituted by one or two sulfo groups; and
Z is as defined above; or
D, D¹, D², D³, D⁴ and D⁵ are independently of one another a group of the formula (9) 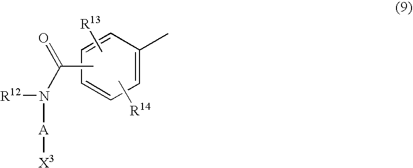
in which
R¹² is hydrogen, (C₁-C₄)-alkyl, aryl or a substituted aryl radical;
R¹³ and R ⁴ independently of one another are hydrogen, (C₁-C₄)-alkyl, (C₁-C₄)-alkoxy, hydroxyl, sulfo, carboxyl, cyano, nitro, amido, ureido or halogen; and
A is a phenylene group of the formula (10) 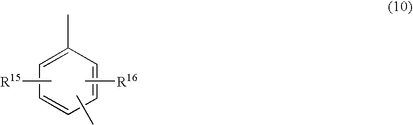
in which
R¹⁵ and R¹⁶ independently of one another are hydrogen, (C₁-C₄)-alkyl, (C₁-C₄)-alkoxy, hydroxyl, sulfo, carboxyl, cyano, nitro, amido, ureido or halogen; or
A is a naphthylene group of the formula (11) 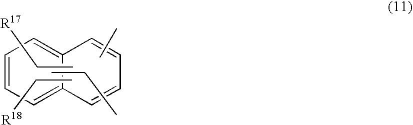
in which
R¹⁷ and R¹⁸ independently of one another are hydrogen, (C₁-C₄)-alkyl, (C₁-C₄)-alkoxy, hydroxyl, sulfo, carboxyl, cyano, nitro, amido, ureido or halogen; or
A is a polymethylene group of the formula (12)
—(CR¹⁹R²⁰)k- (12)
in which
k is an integer greater than 1 and
R¹⁹ and R²⁰ independently of one another are hydrogen, (C₁-C₄)-alkyl, (C₁-C₄)-alkoxy, hydroxyl, cyano, amido, halogen or aryl; and
X³ has one of the definitions of X¹; and
R⁰ is a group of the formula (4) or (5) or is a group of the formula (13) 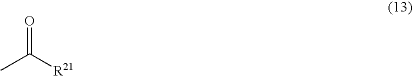
in which
R²¹ is (C₁-C₆)-alkyl, sulfo-(C₁-C₆)-alkyl, carboxy-(C₁-C₆)-alkyl or phenyl which is unsubstituted or substituted by (C₁-C₄)-alkyl, (C₁-C₄)-alkoxy, sulfo, halogen, carboxyl, acetamido or ureido; and
R²⁰⁰ and R²⁰¹ independently of one another are hydrogen, (C₁-C₄)-alkyl, (C₁-C₄)-alkoxy, —NH—COR^{a}, —NH—CONH₂, —SO₃H, —COOH, —COOR^{b}, where
R^{a} and R^{b} are (C₁-C₄)-alkyl or unsubstituted or substituted aryl; and
R* and R* * independently of one another are hydrogen, (C₁-C₄)-alkyl or a group of the formula (14)
—CH₂—SO₃M (14),
b, f and v independently of one another are 0 or 1;
and
T is hydroxyl or NH₂, and if T is NH₂ V is 0;
and
M is hydrogen, an alkali metal or one equivalent of an alkaline earth metal, the dyes of the formulae (I)-(IV) containing at least one fiber-reactive group of the formula —SO₂-Z or -Z².

25. The reactive dye mixture as claimed in claim 24, which consists of one or more dyes of the formula (I) and one or more dyes of the formula (II).

26. The reactive dye mixture as claimed in claim 24, comprising one or more dyes of the formula (I), one or more dyes of the formula (II) and one or more dyes of the formula (III).

27. The reactive dye mixture as claimed in claim 24, comprising one or more dyes of the formula (I), one or more dyes of the formula (II) and one or more dyes of the formula (IV).

28. The reactive dye mixture as claimed in claim 24, comprising one or more dyes of the formula (I), one or more dyes of the formula (II), one or more dyes of the formula (III) and one or more dyes of the formula (IV).

29. The reactive dye mixture as claimed in claim 24, comprising one or more dyes of the formula (I), one or more dyes of the formula (II) and one or more dyes of the formula (III-a) 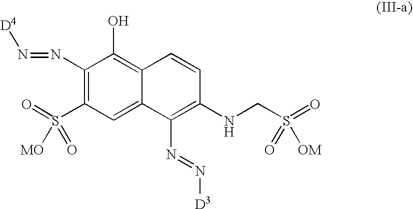
in which
D³, D⁴ and M are as defined in claim 24.

30. The reactive dye mixture as claimed in claim 24, comprising one or more dyes of the formula (I), one or more dyes of the formula (II) and one or more dyes of the formula (IV-a), 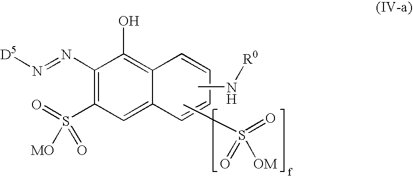
in which D⁵, R⁰, f and M are as defined in claim 24.

31. The reactive dye mixture as claimed in claim 24, comprising one or more dyes of the formula (I-b) 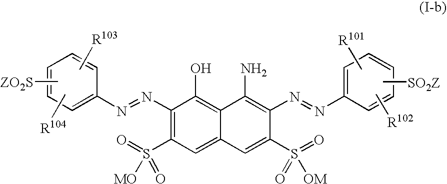
and at least one dye of the formula (II-a) 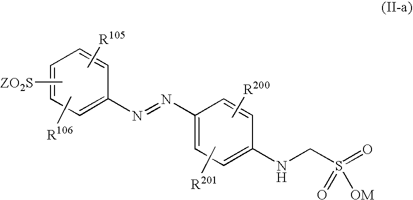
where
R¹⁰¹ to R¹⁰⁶ independently of one another are hydrogen, C₁-C₄ alkyl, C₁-C₄ alkoxy, sulfo, carboxyl or halogen,
R²⁰⁰ and R²⁰¹ independently of one another have one of the definitions stated in claim 24,
M is hydrogen, an alkali metal or one equivalent of an alkaline earth metal, and
Z is vinyl or β-sulfatoethyl.

32. The reactive dye mixture as claimed in claim 24, comprising at least one dye of the formula (I-b), 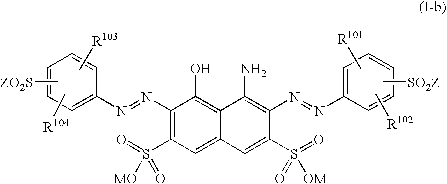
at least one dye of the formula (II-a) 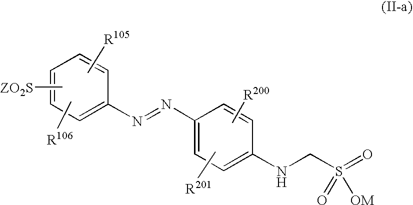
and at least one dye of the formula (III-b) 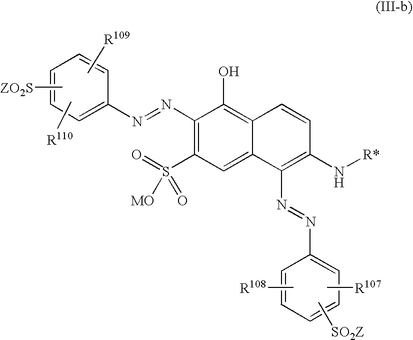
in which M, Z, R²⁰⁰, R²⁰¹ and R* are as defined in claim 24 and R¹⁰¹ to R¹¹⁰ independently of one another are hydrogen, methyl, methoxy or sulfo.

33. The reactive dye mixture as claimed in claim 24, comprising at least one dye of the formula (I-b) 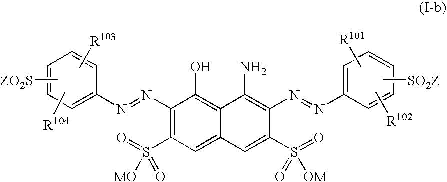
at least one dye of the formula (II-a) 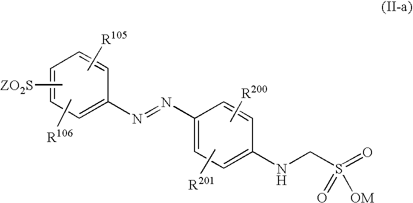
(II-a)
and one or more dyes of the formula (III-c) 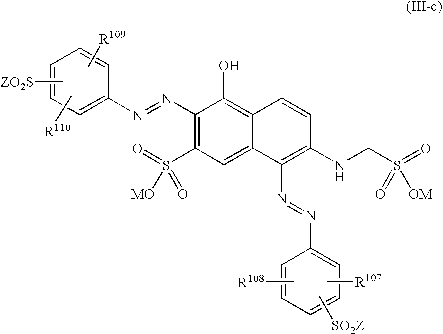
in which
R²⁰⁰, R²⁰¹ M and Z are as defined in claim 24 and
R¹⁰¹ to R¹¹⁰ independently of one another are hydrogen, C₁-C₄ alkyl, C₁-C₄ alkoxy, sulfo, carboxyl or halogen and Z is vinyl or β-sulfatoethyl,

34. The reactive dye mixture as claimed in claim 24, comprising at least one dye of the formula (I-b), 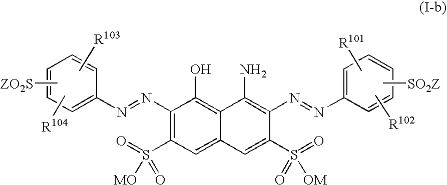
at least one dye of the formula (II-a) 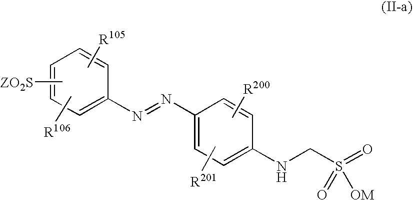
and at least one dye of the formula (IV-b) 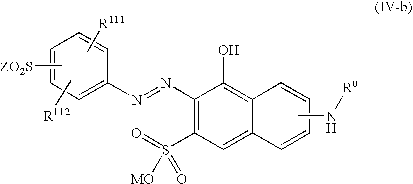
in which
M, Z, R²⁰⁰, R²⁰¹ and R⁰ are as defined in claim 24 and
R¹⁰¹ to R¹⁰⁶ and R¹¹¹ and R¹¹² independently of one another are hydrogen, methyl, methoxy or sulfo.

35. The reactive dye mixture as claimed in claim 24, comprising at least one dye of the formula (I-b), 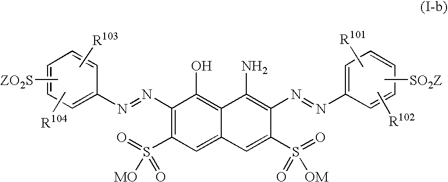
at least one dye of the formula (II-a) 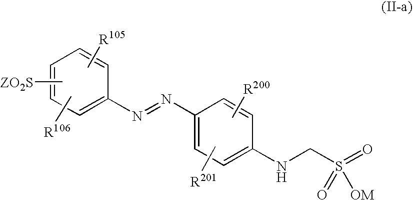
and at least one dye of the formula (IV-c), 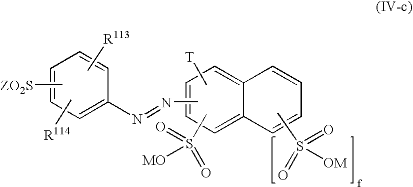
in which
M, Z, R²⁰⁰, R²⁰¹, T and f are as defined in claim 24 and
R¹⁰¹ to R¹⁰⁶ and R¹¹³ and R¹¹⁴ independently of one another are hydrogen, methyl, methoxy or sulfo.

36. The reactive dye mixture as claimed in claim 24, which further comprises one or more monoazo dyes of the formula (15) and/or one or more monoazo dyes of the formula (16) each at 0.5% to 6% by weight, 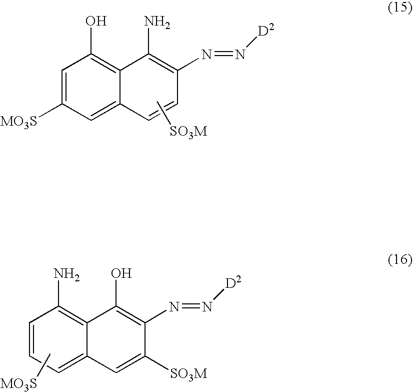
where D² and M possess the definitions stated in claim 24.

37. The reactive dye mixture as claimed in claim 24, which further comprises one or more monoazo dyes of the formula (17) and/or one or more monoazo dyes of the formula (I 8), each in an amount of 0-10% by weight, 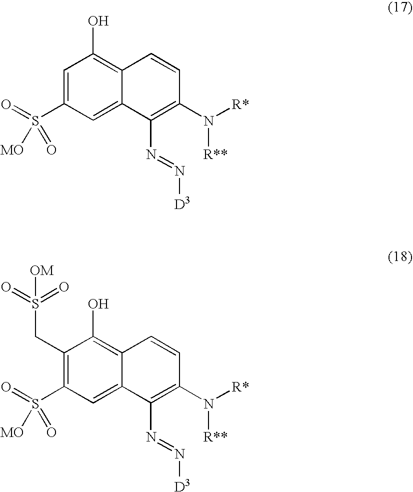
where M, R*, R** and D³ possess the definitions stated in claim 24 and with the proviso that at least one or more monoazo dyes of the formula (17) and/or (18) is present,

38. The reactive dye mixture as claimed in claim 24, comprising one or more dyes of the formula (l) in a fraction of 25% to 99% by weight and one or more dyes of the formula (II) in a fraction of 1% to 75% by weight.

39. The reactive dye mixture as claimed in claim 24, comprising one or more dyes of the formula (I) in a fraction of 30% to 95% by weight and one or more dyes of the formulae (II) and (III) and/or (IV) independently of one another each in a fraction of 1% to 70% by weight.

40. The reactive dye mixture as claimed in claim 24, comprising one or more dyes of the formula (I) in a fraction of 50% to 90% by weight and one or more dyes of the formulae (II) and (III) and/or (IV) independently of one another each in a fraction of 5% to 50% by weight.

41. A process for preparing a dye mixture as claimed in claim 24, which comprises mixing the individual dyes of the formulas (I), (II) and, optionally (III) and/or (IV) either with one another mechanically in solid form, or in the form of the aqueous solutions, 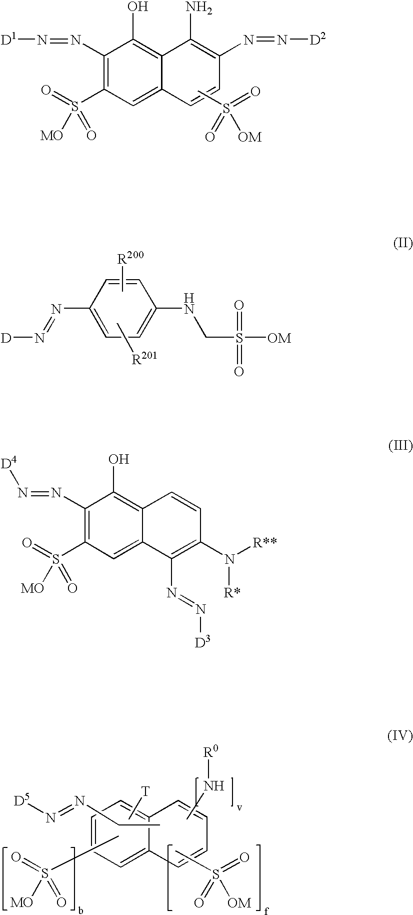
in which:
D, D¹, D², D³, D⁴ and D⁵ are independently of one another a group of the formula (I) 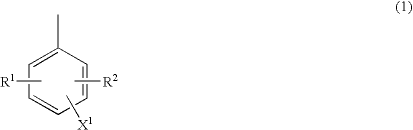
in which
R¹ and R² independently of one another are hydrogen, (C₁-C₄)-alkyl, (C₁-C₄)-alkoxy, hydroxyl, sulfo, carboxyl, cyano, nitro, amido, ureido or halogen, and
X¹ is hydrogen or a group of the formula —SO₂-Z,
where
Z is —CH═CH₂, —CH₂CH₂Z¹ or hydroxyl,
in which
Z¹ is hydroxyl or a group which can be eliminated under the action of alkali, or
D, D¹, D², D³, D⁴ and D⁵ are independently of one another a naphthyl group of the formula (2) 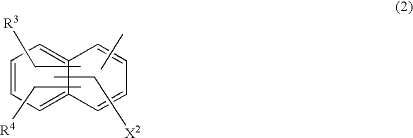
in which
R³ and R⁴ independently of one another are hydrogen, (C₁-C₄)-alkyl, (C₁-C₄)-alkoxy, hydroxyl, sulfo, carboxyl, cyano, nitro, amido, ureido or halogen; and
X² has one of the definitions of X¹; or
D, D¹, D², D³, D⁴ and D⁵ are independently of one another a group of the formula (3) 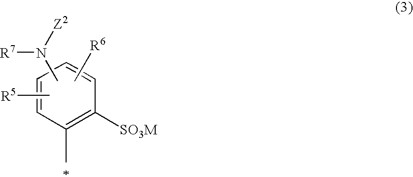
in which
R⁵ and R⁶ independently of one another have one of the definitions of R¹ and R²,
R⁷ is hydrogen, (C₁-C₄)-alkyl, or phenyl which is unsubstituted or substituted by (C₁-C₄)-alkyl, (C₁-C₄)-alkoxy, sulfo, halogen or carboxyl, and
Z² is a group of the formula (4) or (5) or (6) 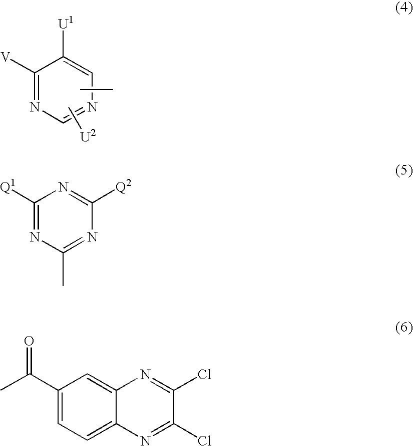
in which
V is fluorine or chlorine,
U¹ and U² independently of one another are fluorine, chlorine or hydrogen, and
Q¹ and Q² independently of one another are chlorine, fluorine, cyanamido, hydroxyl, (C₁-C₆)-alkoxy, phenoxy, sulfophenoxy, mercapto, (C₁-C₆)-alkylmercapto, pyridino, carboxypyridino, carbamoylpyridino or a group of the formula (7) or (8) 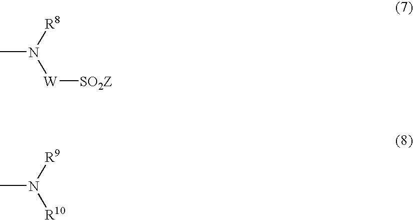
in which
R⁸ is hydrogen or (C₁-C₆)-alkyl, sulfo-(C₁-C₆)-alkyl or phenyl which is unsubstituted or substituted by (C₁-C₄)-alkyl, (C₁-C₄)-alkoxy, sulfo, halogen, carboxyl, acetamido or ureido;
R⁹ and R¹⁰ have independently of one another one of the definitions of R⁸, or form a cyclic ring system of the formula —(CH₂)ⱼ— where j is 4 or 5, or alternatively
—(CH₂)₂-E-(CH₂)₂—, where E is oxygen, sulfur, sulfonyl or —NR¹¹ with R¹¹═(C₁-C₆)-alkyl;
W is phenylene which is unsubstituted or substituted by 1 or 2 substituents, such as (C₁-C₄)-alkyl, (C₁-C₄)-alkoxy, carboxyl, sulfo, chlorine or bromine, or is (C₁-C₄)-alkylene-arylene or (C₂-C₆)-alkylene which may be interrupted by oxygen, sulfur, sulfonyl, amino, carbonyl or carboxamido, or is phenylene-CONH-phenylene which is unsubstituted or substituted by (C₁-C₄)-alkyl, (C₁-C₄)-alkoxy, hydroxyl, sulfo, carboxyl, amido, ureido or halogen, or is naphthylene which is unsubstituted or substituted by one or two sulfo groups; and
Z is as defined above; or
D, D¹, D², D³, D⁴ and D⁵ are independently of one another a group of the formula (9) 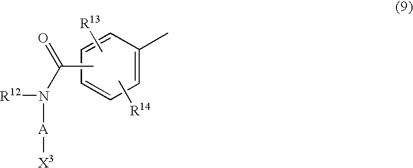
in which
R¹² is hydrogen, (C₁-C₄)-alkyl, aryl or a substituted aryl radical;
R¹³ and R¹⁴ independently of one another are hydrogen, (C₁-C₄)-alkyl, (C₁-C₄)-alkoxy, hydroxyl, sulfo, carboxyl, cyano, nitro, amido, ureido or halogen; and
A is a phenylene group of the formula (10) 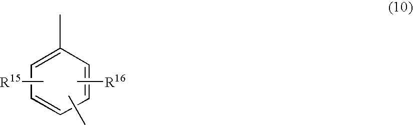
in which
R¹⁵ and R¹⁶ independently of one another are hydrogen, (C₁-C₄)-alkyl, (C₁-C₄)-alkoxy, hydroxyl, sulfo, carboxyl, cyano, nitro, amido, ureido or halogen; or
A is a naphthylene group of the formula (11) 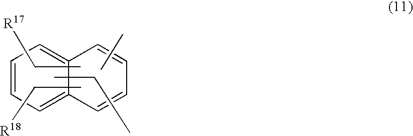
in which
R¹⁷ and R¹⁸ independently of one another are hydrogen, (C₁-C₄)-alkyl, (C₁-C₄)-alkoxy, hydroxyl, sulfo, carboxyl, cyano, nitro, amido, ureido or halogen; or
A is a polymethylene group of the formula (12)
—(CR¹⁹R²⁰)k- (12)
in which
k is an integer greater than 1 and
R¹⁹ and R²⁰ independently of one another are hydrogen, (C₁-C₄)-alkyl, (C₁-C₄)-alkoxy, hydroxyl, cyano, amido, halogen or aryl; and
X³ has one of the definitions of X¹; and
R⁰ is a group of the formula (4) or (5) or is a group of the formula (13) 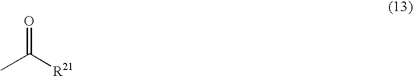
in which
R²¹ is (C₁-C₆)-alkyl, sulfo-(C₁-C₆)-alkyl, carboxy-(C₁-C₆)-alkyl or phenyl which is unsubstituted or substituted by (C₁-C₄)-alkyl, (C₁-C₄)-alkoxy, sulfo, halogen, carboxyl, acetamido or ureido; and
R²⁰⁰ and R²⁰¹ independently of one another are hydrogen, (C₁-C₄)-alkyl, (C₁-C₄)-alkoxy, —NH—COR^{a}, —NH—CONH₂, —SO₃H, —COOH, —COOR^{b}, where R^{a} and R^{b} are (C₁-C₄)-alkyl or unsubstituted or substituted aryl; and
R* and R** independently of one another are hydrogen, (C₁-C₄)-alkyl or a group of the formula (14)
—C₂—SO₃M (14),
b, f and v independently of one another are 0 or 1;
and
T is hydroxyl or NH₂, and if T is NH₂ v is 0;
and
M is hydrogen, an alkali metal or one equivalent of an alkaline earth metal, the dyes of the formulae (I)-(IV) containing at least one fiber-reactive group of the formula —SO₂-Z or -Z².

42. A process for preparing a dye mixture as claimed in claim 24 which comprises diazotizing and coupling mixtures of diazo components and coupling components.

43. A process for preparing a dye mixture as claimed in claim 24 for diazo components containing the groups D¹, D⁴, D⁵ and D according to formulas (I) and (II) and optionally formulas (III) and/or (IV) which comprises diazotizing an amine of the formula (19)
D¹-NH₂ (19),
in which D¹ is defined as indicated in claim 24 to form a resultant diazonium compound and then reacting the resultant diazonium compound with an aqueous solution or suspension of a mixture in a monoazo dye of the formula (15) and a coupling component of the formula (24), 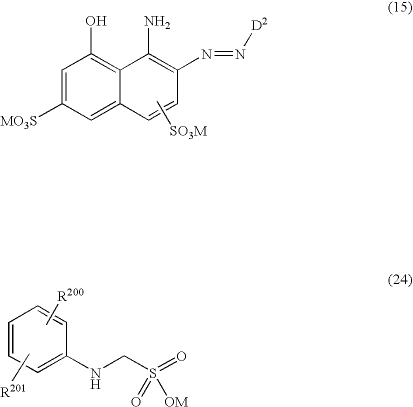
in which R²⁰⁰, R²⁰¹ and M are defined as indicated in claim 24 and optionally with a monoazo dye of the formula (17) and/or a coupling component of the formula (20), 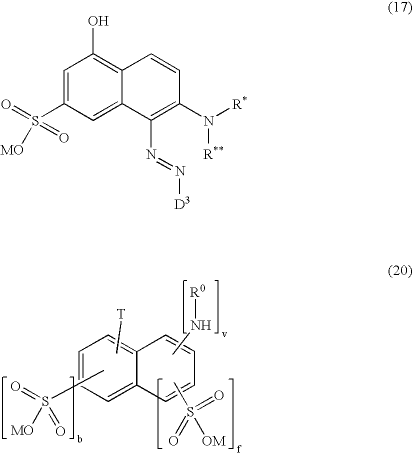
in which T, R⁰, M, b, f and v are defined as indicated in claim 24.

44. A process for dyeing or printing hydroxyl- and/or carboxamido-containing fiber material which comprises contacting the material with the reactive dye mixture as claimed in claim 24.

45. An aqueous liquid preparation comprising the dye mixture as claimed in claim 24 having a total dye content of 5-50% by weight for dyeing or printing hydroxyl- and/or carboxamido-containing fiber material.

46. An aqueous liquid preparation comprising the dye mixture as claimed in claim 24 having a total dye content of 0.1-50% by weight for printing hydroxyl- and/or carboxamido-containing fiber material by the ink jet process.
